(19) United States
(12) Patent Application Publication
(10) Pub. No.: US 2026/0136121 A1
(43) Pub. Date: May 14, 2026

(54) ACOUSTIC COMPONENTS AND ARRANGEMENTS FOR HELMETS

(71) Applicant: Cardo Systems, Ltd., Ra’anana (IL)

(72) Inventor: Genaro Woelfl, Salching (DE)

(73) Assignee: Cardo Systems, Ltd., Ra’anana (IL)

(21) Appl. No.: 19/371,375

(22) Filed: Oct. 28, 2025

Related U.S. Application Data
(60) Provisional application No. 63/712,957, filed on Oct. 28, 2024.

(51) Int. Cl. H04R 1/10; A42B 3/30; H04R 1/02; H04R 1/04; H04R 1/28; H04R 5/033

(52) U.S. Cl. CPC H04R 1/1008; A42B 3/306; H04R 1/025; H04R 1/04; H04R 1/2803; H04R 1/288; H04R 1/2896; H04R 5/033; H04R 2420/07

(57) ABSTRACT

A baffle comprising an outer edge defining its perimeter and a loudspeaker receiving region within the perimeter. The loudspeaker receiving region comprises at least one opening between an interior facing side and an exterior facing side of the baffle. A plurality of surface sections on the exterior facing side of the baffle are arranged to provide free intermediate space between the baffle and a surface to which it is mounted, e.g., a protective layer within a helmet. The free intermediate space forms at least one rear sound propagation path from at least one close position near to the loudspeaker receiving region to at least one remote position near to the perimeter of the baffle when a loudspeaker is positioned within the loudspeaker receiving region. The loudspeaker receiving region may be bounded by an inner edge or rim of the baffle, which provides press-fit acoustic sealing against the loudspeaker.

### CROSS-REFERENCE TO RELATED APPLICATIONS

This application claims priority to U.S. Provisional Patent Application No. 63/712,957, filed on Oct. 28, 2024, and entitled “ACOUSTIC COMPONENTS AND ARRANGEMENTS FOR HELMETS,” the entirety of which is hereby incorporated by reference herein.

### TECHNICAL FIELD

This disclosure generally relates to acoustic components, transducer arrangements, systems and methods for control or modification of sound fields within helmets. Sound fields generated in helmets by loudspeakers may be shaped to achieve desirable acoustic properties for further sound field modifications including audio playback and active noise cancellation.

### BACKGROUND

Many types of helmets, such as motorcycle helmets, ATV helmets, and other helmets such as sports or safety helmets, e.g., skiing helmets or fire brigade helmets, may include loudspeakers, for example such loudspeakers as those configured for use in headphones of the on-ear, over-ear or around-ear type. The loudspeakers, in combination with other hardware and/or software components, may be used to perform a variety of functions including active noise cancellation to attenuate the volume of external noises such as wind noise, as well as to provide for communications and music playback to the wearer. In-helmet loudspeaker systems may be integrated into helmets by the helmet manufacturer or may be sold as aftermarket products to be installed by or for the helmet wearer.

Traditional loudspeaker designs, such as those often incorporated into helmets, comprise a sound generating element such as a moving and/or bending diaphragm or membrane that functions as an acoustic dipole. While at least parts of the sound generating element are moving, acoustic waves with inverse relative polarity (180 degree out of phase) radiate from two opposing sides of the sound generating element. A loudspeaker may comprise additional components that drive the motion of the sound generating element, for example a magnet system or structure and electrical conductors like voice coils. Usually, a loudspeaker basket or mechanical frame serves as a support structure for various components of a loudspeaker, for example a magnet system and a sound generating element of the loudspeaker. Any additional component of the loudspeaker may alter the sound field radiated from the sound generating element as the radiation path can be partly or completely obstructed. Loudspeakers used in helmets often comprise a side that is intended to face the ear of a listener and has less acoustically obstructive elements in the vicinity of the sound generating element. This side is often referred to as front side or front face. Within the context of this specification, the front side or front face of a loudspeaker refers to the side of the loudspeaker facing the ear or head of a wearer of a helmet comprising the loudspeaker and the rear side faces away from the wearer. In this sense, front and rear side or face designators respectively have no implications for the relative arrangement of the components of the loudspeaker. These designators merely reference the general alignment of the respective side or face of the loudspeaker relative to the head. Unless one of the two aforementioned opposing sides of the sound generating element is completely enclosed or sound from both sides is mixed within the loudspeaker structure before it is radiated to an outside, the loudspeaker will radiate sound with inverse polarity from the respective sides of the sound generating element. Typically, loudspeakers, as used in helmets, radiate sound from a front side or face, oriented towards the head or ear of a wearer of the helmet. Often one of the sound radiating sides of the sound generating element is basically aligned in parallel with the front face and largely unobstructed at this side of the loudspeaker. For example, a grille may provide mechanical protection for the sound generating element, which may, for example, be a diaphragm, while allowing for largely unimpeded sound transfer. Typically, a rear side or face of the loudspeaker faces away from the head or ear of a wearer of the helmet. On this side the sound generating element is often obstructed by additional components of the loudspeaker. In such a typical case, rear side radiation may be through ventilation holes or openings in a loudspeaker basket and/or magnet structure. Acoustic waves radiate outwards from the front face of the loudspeaker and inverse acoustic waves, approximately 180 degrees out of phase, radiate outwards form the rear face of the loudspeaker. Sound waves with inverse polarity will cancel mutually when they are superimposed. Depending on the relative sound pressure level of the inverse sound waves, one or both waves may be cancelled partly or completely. If the loudspeaker is located in free air without any boundary elements around it, there will typically be two main lobes of high radiated sound pressure for radiated frequencies with an acoustic wavelength far above the dimensions of the loudspeaker (e.g. bass frequencies). One main lobe from the front and one from the rear side of the loudspeaker with inverse acoustic phase. Such a sound generating device is often referred to as acoustic dipole. Sound from the front and the rear sides is superimposed at any position around the loudspeaker with different relative sound pressure level. At front and rear side of the loudspeaker, especially close to the centers of these sides, the sound pressure from the respective side of the sound generating element by far exceeds the sound pressure from the other side of the sound generating element. As a result, there is negligible cancellation of sound generated by the respective side of the sound generating element and therefore high sound pressure level. In a region on an outer edge or outer perimeter of the loudspeaker, approximately midway between the front and rear side through free air around the loudspeaker, sound pressure level from both respective sides of the sound generating elements will be similar or equal and therefore mutual cancellation of the inverse sound waves will be high, resulting in low sound pressure. This region will typically extend around the outer edge of the loudspeaker between the front and rear face and is referred to as dipole null within the context of this specification. If such a dipole loudspeaker is placed right next to an ear with the center of the front side close to the ear canal entry, the latter will receive high sound pressure for a given signal played over the loudspeaker. As the loudspeaker playing the same signal is moved in a direction parallel to the front face of the loudspeaker, the ear canal entry will get closer to the outer edge of the loudspeaker and the sound pressure level received at the ear canal entry will become lower. Therefore, it is generally required to position the center of the front side of the bare loudspeaker close to the ear canal entry in order to receive high sound pressure level. Another effect is related to the distance of the loudspeaker from the ear. As the distance from the loudspeaker increases, differences in path length to or from the respective sides of the loudspeaker become small compared to total path length and therefore sound pressure levels from both sides also converge. As a result, mutual cancellation increases, leading to decreasing sound pressure level. In helmet audio applications, often neither relative location of the center and outer perimeter of the loudspeaker to the ear nor the distance to the ear can be controlled reliably. This will often cause unreliable or variable frequency response of the same loudspeaker in different helmets and for different users. The exact position and shape of the dipole null or generally an area of low radiated sound pressure of a loudspeaker, depends on the geometry of the loudspeaker as well as the positions of sound emitting openings in the loudspeaker. Such sound emitting openings may, for example, be openings in a grille on a front side of a loudspeaker and ventilation holes on a rear side of a loudspeaker. The position and shape of the dipole null may also vary for different frequencies as effects of loudspeaker geometry, acoustic filters like acoustically resistive mesh covering ventilation holes and cavity resonance on front and/or rear side of the sound generating element as well as distance from the sound generating element may have different effects on different frequencies. Within the context of this specification, a loudspeaker which emits sound with inverse polarity from two respective sides will be referred to as dipole loudspeaker, irrespective of the exact shape of radiation lobes and dipole null. If a loudspeaker is assembled within a helmet, a multitude of boundary elements around the loudspeaker will additionally alter the acoustic radiation. Acoustic arrangements and assemblies within helmets may adapt the sound field radiated from the loudspeaker such that desirable acoustic properties are achieved within a range of possible ear positions. The more the sound pressure level of superimposed sound waves with inverse polarity differs, the higher the sound pressure level of the remaining sound wave with respect to the original level. In the close vicinity of a sound generating element, like at potential ear position within a helmet with a loudspeaker nearby comprising the sound generating element, acoustic phase of the sound from each respective side of the sound generating element will be almost constant, especially for low frequencies, while sound pressure may vary drastically depending on the acoustic environment of the loudspeaker. In order to reduce acoustic cancellation, acoustic integration of a loudspeaker in a helmet may maximize the difference between respective sound pressure level at the ear position from the two aforementioned opposing sides of the sound generating element.

Prior art of loudspeaker integration within helmets includes placement of a dipole loudspeaker on an inner layer of the helmet, often within a recess in the inner layer material. Both sides of the dipole loudspeaker can radiate towards the ear of a person wearing the helmet. While the front side of the loudspeaker can radiate directly towards the ear, rear sound is guided and/or reflected towards the ear by surfaces of the inner layer material surrounding the loudspeaker. Loss in acoustic energy during reflection or guidance of rear sound is low, resulting in potentially high level of rear sound at the ear position. Relative level of rear sound versus front sound at the ear position depends on the exact position of the ear. As helmet loudspeakers are usually quite small, for example circular speakers with 32 to 45 mm in diameter, a distance between the center of the circular shape and the outer perimeter is also small. Therefore, minor changes in helmet orientation on the head of a user as well as ear position on the head of the user can cause large variations in low frequency sound pressure level at the ear position as an offset between the loudspeaker center and the ear is created. Rear sound is effectively guided to the outer perimeter of a loudspeaker if the loudspeaker is placed inside a recess or pocket within an inner layer of a helmet. As the rear sound expands into a small space before it exits the recess, there will be low loss in sound pressure between the rear sound right at the loudspeaker sound outlet (e.g., rear ventilation holes) and at the perimeter of the loudspeaker. Therefore, rear sound becomes relatively high compared to frontal sound within a typical loudspeaker to ear distance (e.g., 1-4 cm) even if the center of the loudspeaker is aligned with the ear canal entry. This means that even in rare cases where the loudspeaker is well aligned with the ear canal entry, rear sound causes substantial loss in sound pressure level at the ear.

Other conceptional decisions amongst prior art in-helmet loudspeaker systems may similarly degrade audio performance. For instance, closed rear chambers, wherein the rear of the loudspeaker emits sound that reflects back towards the loudspeaker and causes dynamic air pressure changes within the closed chamber, may drastically increase distortion from the loudspeaker due to nonlinear air stiffness. Furthermore, sensitivity and efficiency of a loudspeaker with a closed rear chamber are often much lower than for loudspeakers without enclosure at least directly in front of the loudspeaker (typical ear-position). Small rear chambers, often required due to size constraints within helmets, can cause severe limitation of maximum sound pressure provided by a loudspeaker within thermal or power limits of the loudspeaker with regard to an electrical driving signal. Generally, sealing of a rear loudspeaker chamber is prone to leakage, caused for example by production tolerances, altering material qualities and errors in manual assembly, potentially by an end user.

Undefined sealing of the rear chamber can cause large variations of the loudspeaker frequency response at the ear. Besides unpleasant sound coloration this may also cause left to right sound pressure mismatch causing great annoyance to listeners. Undefined sealing of the rear chamber renders the complete transducer assembly unusable for static feedback (FB) and feedforward (FF) active noise cancellation (ANC) techniques. Static ANC with a fixed filter set for FF or FB ANC relies on a known transfer function from the loudspeaker to the ear or at least to the FB microphone. Undefined sealing of the rear chamber will cause large variations in these transfer functions. Such variations can drastically reduce ANC, cause actual noise boost instead of cancellation or even feedback instability. The latter may result in feedback loop oscillation generating loud whistling or rumbling noises. These can cause a shock or fear reaction of a wearer of a helmet equipped with such an ANC system. As a result, accidents can happen, for example in traffic situations. Therefore, it is vital for transducer arrangements in ANC systems to provide stable acoustic transfer functions.

For aftermarket loudspeaker systems, it may also be problematic to achieve sealing due to inappropriate construction with regard to the possibility for sealing of the helmet to which the aftermarket system is installed. Rear loudspeaker enclosures with undefined sealing or leakage result in undefined transfer functions between the loudspeaker and the ear, modifying audio quality of the loudspeaker in an uncontrolled manner. Especially the low frequency acoustic transfer function from the loudspeaker to the ear may vary drastically with the degree of sealing or leakage. Air entering into and out of a leaky enclosure encompassing the loudspeaker may also cause air noise that can further degrade audio performance. Some in-helmet loudspeaker systems may develop through-hole implementations to overcome one or more of the above issues. Such through-holes may reach from a rear chamber through an inner layer of a helmet either towards a region between the inner layer and an outer layer of the helmet or towards an outside of the helmet in order to avoid sound from the rear side of the loudspeaker to radiate towards the ear. However, through-hole implementations have additional drawbacks such as susceptibility to external elements, including wind, humidity and salt spray entering the in-helmet loudspeaker system through the through-hole.

Space constraints within a helmet can be a substantial impediment to optimizing the performance of an in-helmet loudspeaker system. Loudspeaker systems, whether integrated by the helmet manufacturer or aftermarket additions, must be sufficiently small to fit within the helmet and not cause discomfort for the wearer. The protective layer of the helmet, typically an expanded polystyrene (EPS) padding layer, may in some cases be shaped to accommodate a loudspeaker in a position adjacent to the wearer's ear. For example, a portion of the protective layer may comprise a recess to form a rear chamber or speaker pocket in which the loudspeaker may be placed. However, a recess reducing the remaining protective layer too much will reduce the effectiveness of the helmet. There is usually no space for a rear chamber that includes sufficient free air volume for a closed rear chamber with low detrimental effect such as those described above. Typically, speaker pockets provided within helmets merely provide space for a small loudspeaker. No additional air volume. Adding thickness to the protective layer to accommodate larger loudspeaker systems increases helmet width, which is not preferred by the wearers due to ergonomic reasons and increased air drag. Therefore, integrated and aftermarket loudspeaker systems have limited space for adding sound improvement components for the loudspeaker. Moreover, a helmet wearer will have limited means to adjust the placement of the loudspeaker internal to the helmet if the acoustic quality is diminished due to a dipole null or generally rear sound from the loudspeaker interfering with frontal sound. Because of the limited space inside the helmet, a solution is needed to improve the acoustics of loudspeakers mounted or integrated internal to helmets that avoids drawbacks of prior art loudspeaker integration as described above.

### SUMMARY

In some embodiments, the disclosed baffle is defined by several geometric features including an outer edge defining a perimeter of the baffle and a loudspeaker receiving region within the perimeter of the baffle. The loudspeaker receiving region comprises at least one opening between an interior facing side and an exterior facing side of the baffle. A plurality of surface sections on the exterior facing side of the baffle are arranged to provide free intermediate space between the plurality of surface sections. The free intermediate space forms at least one rear sound propagation path from at least one close position near to the loudspeaker receiving region to at least one remote position near to the perimeter of the baffle.

The plurality of surface sections on the exterior facing side of the baffle can form one or more separators. The separators can provide for one or more sound guides in the surface of the exterior facing side of the baffle between an abutting layer of a helmet for acoustic waves to travel within when output by a connected loudspeaker. In some cases, the baffle can form multiple separators that provide a multitude of at least partially separate sound guides in the surface of the exterior facing side of the baffle.

The loudspeaker receiving region may be further defined by an area on the exterior facing side of the baffle covered with an adhesive film for attachment to and sealing against the loudspeaker. The loudspeaker receiving region may include mechanical features arranged and constructed to receive at least a cylindrical part of a loudspeaker. The loudspeaker receiving region is bounded by an inner edge or inner rim of the baffle, which may encircle at least part of a loudspeaker. The inner edge or inner rim of the baffle provides acoustic sealing against the loudspeaker by means of press-fit assembly on the loudspeaker. The loudspeaker receiving region may be formed as open sleeve arranged and constructed to partly enclose a loudspeaker and thereby attach it to the baffle.

Similar concepts may be applied to a transducer arrangement for helmets. An exemplary transducer arrangement includes a baffle with an outer edge defining a perimeter of the baffle. A loudspeaker receiving region is within the perimeter of the baffle. The loudspeaker receiving region comprises at least one opening between an interior facing side and an exterior facing side of the baffle. A plurality of surface sections on the exterior facing side of the baffle are arranged to provide free intermediate space between the plurality of surface sections. A loudspeaker is provided within the loudspeaker receiving region of the baffle. The free intermediate space forms at least one rear sound propagation path from at least one close position near to the loudspeaker receiving region to at least one remote position near to the perimeter of the baffle.

In some embodiments the transducer arrangement can further comprise a microphone arranged on an interior facing side of the loudspeaker and attached to the baffle and/or the loudspeaker. The transducer arrangement can further comprise a sensor on the baffle and/or the loudspeaker to provide information related to an assembly status of the baffle on the loudspeaker. Additionally or alternatively, the transducer arrangement can comprise information storage means such as a memory device, electronic component, and/or machine readable code. One or more parameters may be retrieved from the information storage means relating to information about the loudspeaker, baffle, and/or a helmet attached to the transducer arrangement.

Further, similar concepts may be applied to a helmet with a transducer arrangement. The helmet includes a protective layer mounted within the helmet. A baffle having an exterior facing side and an interior facing side is provided within the helmet with the exterior facing side mounted to the protective layer of the helmet. The baffle has an outer edge defining a perimeter of the baffle and a loudspeaker receiving region within the perimeter of the baffle. The loudspeaker receiving region comprises at least one opening between the interior facing side and the exterior facing side of the baffle. A plurality of surface sections on the exterior facing side of the baffle are arranged to provide free intermediate space between the baffle and the protective layer. A loudspeaker provided within the loudspeaker receiving region of the baffle. The free intermediate space forms at least one rear sound propagation path from at least one close position near to the loudspeaker receiving region to at least one remote position near to the perimeter of the baffle.

### BRIEF DESCRIPTION OF THE DRAWINGS

Features, embodiments, and advantages of the present disclosure are better understood when the following Detailed Description is read with reference to the accompanying drawings.

FIGS. 1A-1C show various examples of a helmet and its inner protective layer.

FIG. 2 shows an example of a protective layer cheek piece for placement adjacent the right side of the helmet wearer's head according to certain embodiments of the disclosure.

FIGS. 3A-3B show an example of recessed impressions forming sound guides in a protective layer cheek piece according to certain embodiments of the disclosure.

FIGS. 4A-4B, 5A-5B, and 6A-6B show additional examples of sound guides formed in a protective layer cheek piece according to certain embodiments of the disclosure.

FIG. 7 shows a generic baffle on top of a protective layer cheek piece according to certain embodiments of the disclosure.

FIGS. 8A-8D show different perspective views of a generic baffle according to certain embodiments of the disclosure.

FIGS. 9A-9C show additional perspective views of a baffle with a loudspeaker attached according to certain embodiments of the disclosure.

FIGS. 10A-10C show cross-sectional views of baffles abutting a protective layer, with a loudspeaker attached according to certain embodiments of the disclosure.

FIGS. 11A-11C show cross-sectional views of baffles with a loudspeaker cover according to certain embodiments of the disclosure.

FIG. 12 shows a custom baffle on top of a protective layer cheek piece according to certain embodiments of the disclosure.

FIG. 13 shows a cushion layer on top of a custom baffle according to certain embodiments of the disclosure.

FIGS. 14A-14C show different perspective views of a custom baffle according to certain embodiments of the disclosure.

FIGS. 15A-15B, 16A-16B, 17A-17B, 18A-18B, and 19A-19B show additional examples of custom baffles with different sound guide configurations according to certain embodiments of the disclosure.

FIGS. 20A-20B show examples of a custom baffle comprising a cushion carrier on top of a protective layer cheek piece according to certain embodiments of the disclosure.

FIG. 21 shows a top-down perspective view of a baffle shaped to house multiple loudspeakers according to certain embodiments of the disclosure.

FIGS. 22A-22B show cross-sectional views of a baffle shaped to house multiple loudspeakers according to certain embodiments of the disclosure.

FIGS. 23A-23B show cross-sectional views of transducer arrangements including a microphone according to certain embodiments of the disclosure.

FIG. 23C shows a cross-sectional view of a transducer arrangement including a microphone and sensor according to certain embodiments of the disclosure.

FIG. 24 shows an example arrangement of various components making up an in-helmet audio system according to certain embodiments of the disclosure.

FIGS. 25A-25B show experimental test results of certain acoustic characteristics of an exemplary loudspeaker baffle according to certain embodiments of the disclosure.

### DETAILED DESCRIPTION

Embodiments of the invention described herein provide loudspeaker baffles designed to shift the dipole null of a loudspeaker in a space efficient manner to improve the acoustic capabilities of helmet loudspeaker systems. Improving acoustic quality includes adjusting the frequency response of at least one loudspeaker mounted internal to the helmet. For instance, effective amplification of lower frequency bands such as bass boosting by acoustical methods are discussed herein. Furthermore, a general reduction of the variability of loudspeaker to ear transfer functions over a range of ear positions within helmets is one of the advantages of the invention.

The loudspeaker baffles and acoustic assemblies including a baffle and at least one loudspeaker as described herein, are used to configure and shift a dipole null of a dipole loudspeaker away from the loudspeaker instead of converting the loudspeaker to a monopole with a rear enclosure. This is generally achieved by guiding rear sound of the loudspeaker away from the loudspeaker by a sound guide. In some embodiments the sound guide may comprise sound canals, the canals are formed on a surface of a baffle and in other embodiments the canals are formed within a protective layer of the helmet or a combination of both. In yet other embodiments the rear sound guide may not comprise distinct canals but may comprise free space in various shapes that provides at least one sound propagation path through free air for rear sound of the loudspeaker. The rear sound guide is designed to redirect the acoustic waves as they radiate outwards from the rear side (facing away from a wearer's ear) of the loudspeaker. Thereby, a region where frontal sound and rear sound of the loudspeaker are superimposed for the first time, after radiation from a sound generating element of the loudspeaker, is shifted away from the loudspeaker. A time-span or sound propagation time that passes until frontal sound and rear sound of the loudspeaker are superimposed for the first time, after radiation from the sound generating element of the loudspeaker, is also increased. The same applies to the sound propagation time of rear sound from the loudspeaker to the ear of a user or to the frontal side of the loudspeaker, for example to a microphone on the frontal side of the loudspeaker. At the same time, a region where frontal sound and rear sound are superimposed and exhibit similar sound pressure level is shifted away from the loudspeaker. As an effect a region of low sound pressure level due to mutual cancellation of frontal sound and rear sound of the loudspeaker, referred to as dipole null, is shifted away from the loudspeaker. By shifting the dipole null, the negative effects of the dipole null on audio quality and frequency specific attenuation of the sound pressure level both at the center of the loudspeaker and extending from the loudspeaker, can be mitigated, thereby improving the acoustic quality of a loudspeaker across a wide frequency range and particularly at a lower frequency range. The acoustic quality may be improved by providing equalized sound field distribution in the region of a helmet wearer's ears, in addition to increased sound pressure levels output from the loudspeaker to the wearer's ears.

In some embodiments, loudspeaker baffles described herein are standalone components that can be attached to at least one loudspeaker and/or an inner layer of the helmet, e.g., a protective layer, functional layer or cushion layer of the helmet. The loudspeaker baffle is an acoustically effective component or acoustic component that improves sound output from the loudspeaker. The loudspeaker baffle may be added to a loudspeaker system integrated into the helmet or provided for integration by the helmet manufacturer or may be provided as an aftermarket product to be added by or for the helmet wearer. Other embodiments described herein relate to transducer arrangements including at least one dipole loudspeaker and a loudspeaker baffle for manipulation of the dipole null. In yet other embodiments, integral elements of helmets provide beneficial acoustic effects by means of acoustic dipole manipulation. Such embodiments provide further ability to meet helmet design and spacing constraints.

Reference made throughout the specification to protective layers may refer to any material for placement in a helmet capable of dampening mechanical impacts. For instance, a protective layer of a helmet may comprise one or more layer of expanded polystyrene (“EPS”) or layer(s) of similar materials which may perform the same function, such as recycled foam, or other polystyrene based foams. The term functional layer generally refers to a layer of the helmet that may also add to the protective effects of the helmet but primarily provides additional features that may not be possible with protective layer(s) alone. Such features may include integrated mechanical fasteners like, for example, clip fastener inserts, cable guides and/or alignment features for positioning of a cushion layer. The functional layer may also provide mechanical protection for an EPS or similar layer, for example at the feed-through of a chin strap. Functional layer(s) can, for example, be made from thin (e.g., 0.3-2 mm) plastic material that may be at least partly glued or otherwise, for example mechanically, fixed to a protective layer. The term cushion layer refers to an at least partly soft and elastic layer that provides additional impact damping, potentially helmet size adaptation and generally improved wearing comfort. Cushion layers typically comprise some kind of soft foam often covered by another layer, for example a fabric layer. In some cases, cushion layers also comprise a cushion carrier, which may be a layer of, for example, thin plastic material, that carries the foam material to provide shaping of the cushion layer an/or mechanical fixation to another layer, like a protective layer. It may be understood that the terms protective layer, functional layer and cushion layer are not meant to limit the functions or effects that such layers may provide or exhibit within a helmet or in the context of the invention. They are meant to foster understanding of the technical features and functions of specific layers that may be present in certain helmets. As described in the following embodiments of the invention, such layers may relate to additional acoustic components like a baffle or be utilized or adapted to provide acoustic and/or mechanic features with or for transducer arrangements. As far as such layers are referenced throughout the specification in combination with or as integral part of embodiments of the invention, such layers may primarily be understood to provide the features necessary for the respective embodiment of the invention. The specific term used for the layer shall support an understanding as to how such layer may be arranged within a helmet and for which purpose the layer may serve besides any contribution to embodiments of the invention. Specific terms used for helmet layers shall not limit the scope of the invention beyond the extent to which specific properties of such layers are described as a prerequisite for use in certain embodiments of the invention. Helmets may generally comprise only part of these layers or additional layers or other kinds of layers with respect to their primary function within the helmet. Such layers may still fulfill the same functions with respect to embodiments of the invention as described with respect to the layer references introduced above.

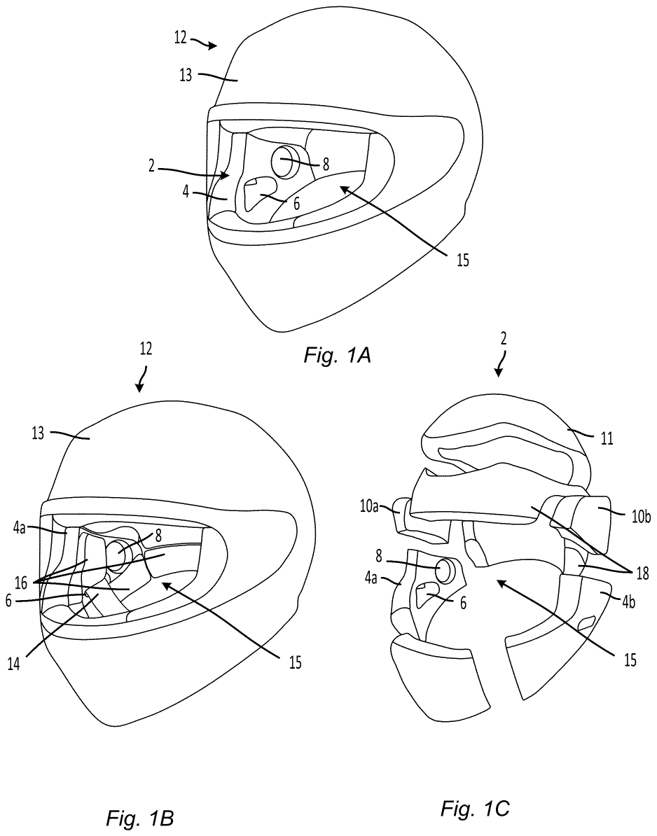

Referring now to the drawings, FIGS. 1A-1C show various examples of a helmet 12 and its inner protective and cushion layers. In particular, FIG. 1A provides a view of a protective layer 2 and its various components internal to a helmet 12. FIG. 1B shows components of a cushion layer 16 placed over the components of the protective layer 2 indicating a more fully assembled helmet system. FIG. 1C provides an exploded view of various exemplary components of the protective layer 2.

The helmet 12 shown in FIG. 1A comprises an outer shell 13 and the protective layer 2 mounted internal to the helmet 12. The helmet 12 may be any variety of helmet capable of accommodating an internal protective layer 2. As general illustrative examples, the helmet 12 may for instance be a motorcycle helmet, bike helmet, racing helmet, or firefighter helmet. An interior space 15 of the helmet is shown adjacent the interior facing side of the protective layer 2. Helmets such as helmet 12 often comprise at least one protective layer 2 configured for mechanical impulse damping in the case of an accident. Frequently, such protective layers are comprised of an EPS (Expanded Polystyrene) foam layer. Although the document often refers to the protective layer as being comprised of EPS, those skilled in the art will appreciate that different materials may be utilized instead without deviating from the basic idea of the invention. In FIG. 1A, a cheek piece 4 of the protective layer 2 can be seen. A chinstrap channel 6 and a loudspeaker pocket 8 are formed in the protective layer cheek piece 4.

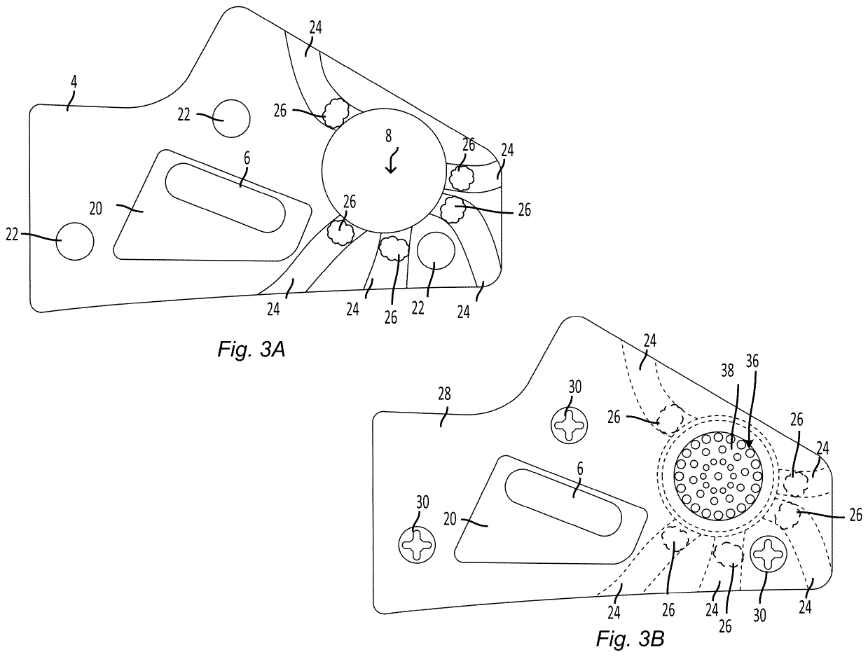

FIG. 1B shows a view of the helmet 12 with a cushion layer 16 placed over the protective layer 2. The cushion layer 16 may be provided mainly for comfortable resting against the face of a user and may be made of a soft, compressible foam or other elastic material covered with at least one of a soft fabric, an acoustically permeable material, a fabric covered with an air-tight layer, a fabric coated with an air-tight layer, or an air-tight layer. The cushion layer 16 may be attached to the protective layer, or to an intermediate functional layer by means of attachment components such as clip fasteners (see for example FIG. 3B). The assembled helmet 12 of FIG. 1B further shows a chinstrap 14 extending through the chinstrap channel 6 and the cushion layer 16. Acoustically, the interior space 15 of the helmet 12 may be understood to include the cushion layer 16, especially if cushion layer 16 comprises an acoustically permeable material like, for example, open-pore foam.

In the exploded view of the protective layer 2 of FIG. 1C, the protective layer 2 is shown divided into separate protective layer pieces including two protective layer cheek pieces 4a&b, two protective layer temple pieces 10a&b, protective layer top piece 11 and protective layer rear piece 18. The protective layer rear piece 18 in this example is a single piece that covers the back of the wearer's head and the forehead. While the protective layer 2 is shown in this example as being separated into multiple specific pieces, it is to be appreciated that the overall protective layer 2 may be formed using any number of pieces that may be used in forming the overall protective layer. For instance, the protective layer cheek piece 4 and temple piece 10 may be combined to form one continuous protective layer piece. Thus, in the described examples, references made to the protective layer cheek piece 4 should be taken to include examples where the protective layer cheek piece 4 is connected to or aligned with other protective layer components such as the protective layer temple piece 10.

The protective layer cheek piece 4a is shown including the loudspeaker pocket 8. In this example, the loudspeaker pocket 8 comprises a recess within the protective layer cheek piece 4a&b and potentially any functional layer that may be covering the protective layer. As shown by the two protective layer cheek pieces 4a&b, the loudspeaker pocket 8 may not extend fully through the thickness of the protective layer 2. In particular, the loudspeaker pocket 8 is visible on the interior facing surface of protective layer cheek piece 4a, but is not visible on the exterior facing surface of protective layer cheek piece 4b.

On top of the protective layer 2, helmets 12 may comprise at least one functional layer (not shown in the drawing). This layer is in many cases made from thin (e.g., 0.5-1 mm) plastic material that is often at least partly glued or otherwise fixed to the protective layer 2. The functional layer provides additional features that may not be possible with the protective layer 2 alone. Such features may include integrated clip fastener inserts, cable guides and/or alignment features for positioning of a cushion layer 16. The functional layer may also provide mechanical protection for the protective layer 2, for example adding reinforcement or other wear protection at the chin strap channel 6.

Besides functional layers as described above, haptic and/or visual layers may be applied to the protective layer and/or any intermediate functional layer. Haptic layers may include cloth, fabric, (faux) leather, silicone or similar that make the surface of the protective layer more comfortable for the skin. Visual layers are meant to improve the visual appearance and may generally include similar materials as haptic layers.

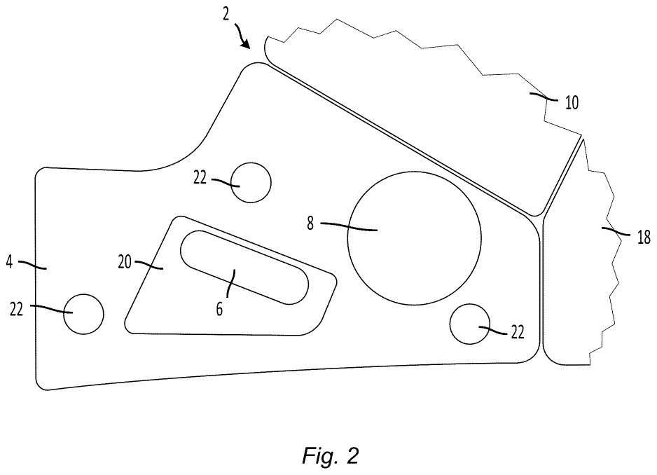

FIG. 2 shows a schematic drawing of a protective layer cheek piece 4 similar to protective layer cheek piece 4a of FIGS. 1B-1C for placement adjacent the right side of the head. Protective layer temple piece 10 and protective layer rear piece 18 are shown adjacent the protective layer cheek piece 4. The protective layer cheek piece 4 is shown including a chinstrap channel 6 similar to that of FIG. 1. In this example, a chinstrap channel recess 20 is formed around the chinstrap channel 6. Further recesses such as clip fastener recesses 22 for receiving clip fasteners (e.g., shown in FIG. 3B) are also shown formed in the protective layer cheek piece 4. At least part of the helmet components shown in FIGS. 1 and 2 and/or described above, may be present in various similar forms within helmets to which the embodiments of the invention described in detail in the following sections may relate.

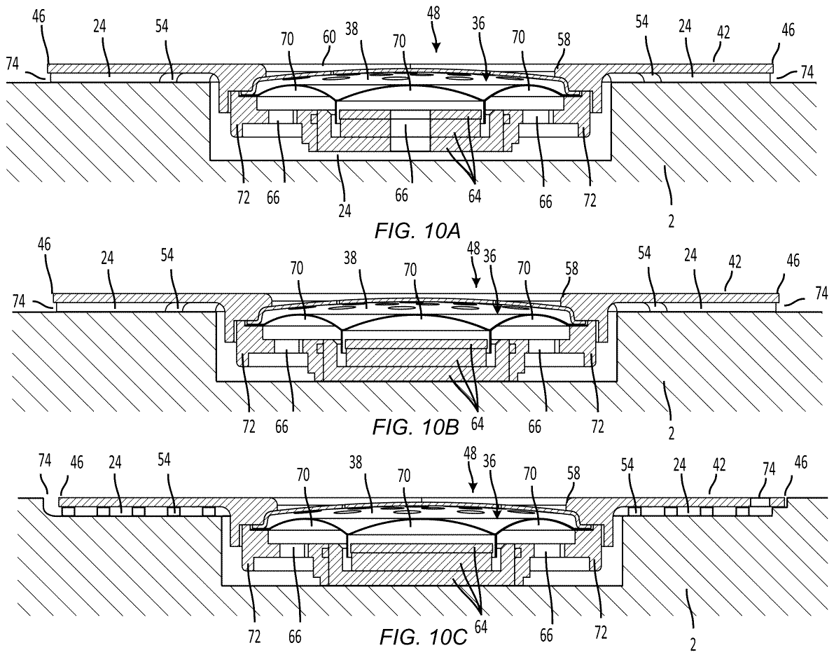

FIGS. 3A-3B show exemplary details of an embodiment of the invention in a schematic drawing of a protective layer cheek piece 4, similar to protective layer cheek piece 4a of FIGS. 1B-1C. Protective layer cheek piece 4 may be part of a larger protective layer arrangement within a helmet, for example as shown in FIG. 1B. In the example of FIGS. 3A-3B, sound guides 24 formed in the interior facing side of the protective layer cheek piece 4 are covered by a functional layer 28. The functional layer 28 thereby providing the function of a baffle for a loudspeaker 36, shown in FIG. 3B, by locally separating rear sound from frontal sound of the loudspeaker 36. Therefore, frontal sound my enter an interior space 15 (not shown, see FIG. 1) of the helmet directly as it is emitted by the loudspeaker 36, while rear sound may be released towards the interior space 15 at different positions as provided by sound guides 24. A loudspeaker pocket 8 is formed in the protective layer cheek piece 4, which may be sized to receive at least a portion of the loudspeaker 36. The loudspeaker pocket 8 may be designed to receive the loudspeaker 36 in a manner that provides an air gap between the rear face of the loudspeaker 36 and the protective layer cheek piece 4 in order to release rear sound of the loudspeaker 36 towards sound guides 24. In another case, the loudspeaker 36 may comprise rear ventilation holes next to sound guides 24 that allow for direct acoustic coupling between the rear side of a sound generating element (e.g., a membrane or diaphragm like 70 in FIG. 10) within the loudspeaker 36 and sound guides 24.

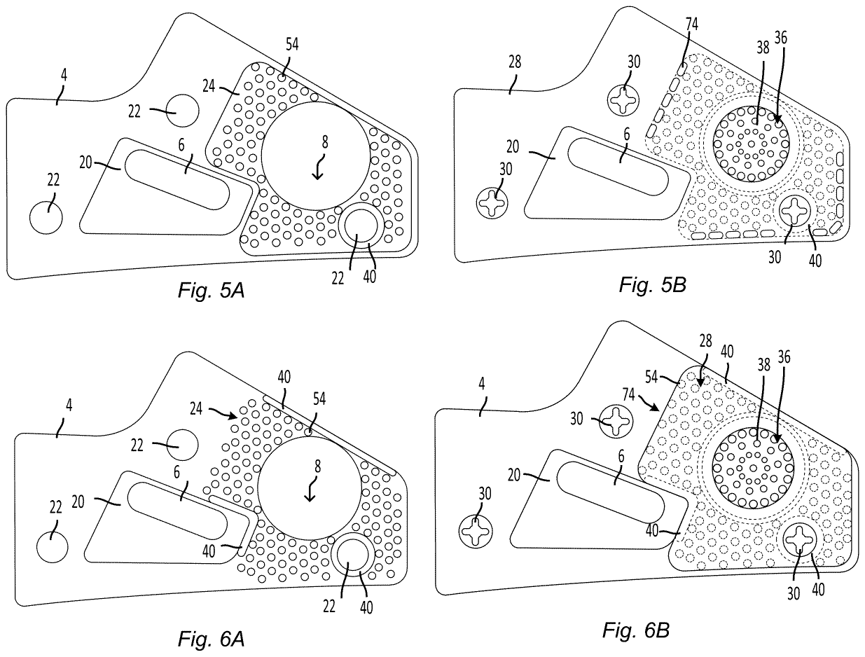

The sound guides 24 formed in the protective layer cheek piece 4 can be of any variety of shape and number. In some examples, the sound guides 24 begin at an edge of the loudspeaker pocket 8 and end at a location that is away from the edge of the loudspeaker pocket 8. Generally, sound guides 24 may have a length of roughly 30-50 mm in 5 mm increments, but other variations on lengths of each sound guide 24 may be formed in the protective layer. Sound guides 24 may comprise a variety of shapes. In some examples such as in FIGS. 3A-3B, the sound guides 24 resemble canals and thus may be referred to as canals as a more specific form of sound guide. In other examples (e.g., as in FIGS. 5 and 6) the sound guides 24 may have other configurations. A multitude of distinct canals or generally any arbitrarily shaped free intermediate space providing at least one sound propagation path, may be referred as sound guide(s) 24 both in the singular and in the plural. It may be appreciated, that sound guide(s) 24 for rear sound of a loudspeaker 36 may be coupled to a single air volume at one side of the sound generating element (e.g., diaphragm) of the loudspeaker 36. This may create a coherent air volume over various potential shapes of free intermediate space forming a sound guide 24. When used in the plural, the term sound guides 24 may emphasize individual elements that jointly provide the function of what can also be understood as single sound guide 24.

The sound guides 24 of FIGS. 3A-3B, are recessed impressions in the protective layer cheek piece 4, wherein free intermediate space between opposing surface sections of these impressions forms sound propagations paths for rear ventilation of the loudspeaker 36 when functional layer 28, is attached, mounted, or otherwise abuts the protective layer cheek piece 4. Like a loudspeaker baffle, the functional layer 28 may be configured to provide an acoustic barrier between the front side and the rear side of the loudspeaker 36 when the loudspeaker 36 is positioned within the loudspeaker pocket 8. In some configurations, the largest dimension of the sound guides 24 extends approximately in parallel to the functional layer 28. Thus, as shown in FIG. 3B, the integration of the protective layer cheek piece 4 and the functional layer 28 can form tubular structures by covering sound guides 24. The sound guides 24 can be of different lengths and shapes to provide for different tube resonance frequencies. Thus, the superposition of multiple resonances with shifted frequencies may result in reduced resonant peaks.

In some examples, the sound guides 24 may include an acoustically resistive material 26 or sound absorbing material such as open pore foam. The acoustically resistive material 26 may be used for damping acoustic resonances developing within the sound guides 24 or generally certain frequencies of sound traversing the sound guides 24. The acoustically resistive material 26 may be applied internal to the sound guides 24 to further modify the acoustic characteristics of acoustic waves emitting from the rear face of the loudspeaker 36. For instance, acoustically resistive material 26 may have acoustic properties so as to predominantly dampen a target frequency range, such as a higher frequency range including unwanted resonant frequencies. The damping material may be acoustically less resistant to lower frequencies. Thus, the shape of the sound guides 24 may be used in combination with acoustically resistive material 26 to target and dampen specific frequencies, while allowing other frequencies to transmit through the sound guides 24 with low attenuation.

FIG. 3B shows a functional layer 28 covering the protective layer cheek piece 4. Specifically, the sound guides 24 are shown as dotted lines to indicate the functional layer 28 is in front of the sound guides 24. The functional layer 28 may separate acoustic waves emitted from a front face of a loudspeaker 36 from the acoustic waves emitted from a rear face of the loudspeaker 36 such that these acoustic waves are superimposed for the first time at or close to the ends of the sound guides 24. Recesses, notches, or cut-outs may be provided in the neighboring protective layer(s) or component(s) (for example protective layer temple piece 10 or protective layer rear piece 18, not shown) to provide free outlets for the rear acoustic waves to exit the sound guides 24 at their respective ends.

The functional layer 28 can be formed of any variety of material providing sufficient acoustic isolation, including for example a thin plastic. The functional layer 28 can extend across the full shape of the protective layer cheek piece 4 or only a portion of the protective layer cheek piece 4 (as discussed with respect to FIG. 5B). Thus, the functional layer 28 may cover at least one sound guide 24. The functional layer 28 may further include one or more opening that aligns with the loudspeaker pocket 8 and/or the loudspeaker grille 38 or other components of the loudspeaker 36, so as to acoustically isolate sound emitted from the rear of the loudspeaker 36 from sound emitted from the front of the loudspeaker 36. The functional layer 28 may be attached to the protective layer cheek piece 4 by any appropriate means, including by way of an adhesive material, such as glue or tape as well as any suitable mechanical connection. The functional layer 28 can include clip fastener receptacles 30 used for attaching a cushion layer 16. The cushion layer 16 can thus be attached to the functional layer 28 by way of clips that mate with the clip fastener receptacles 30. The cushion layer 16 can alternatively be attached to the functional layer 28 by way of any other of a variety of fastening or securing mechanisms such as snaps, bolts, hook and loop fasteners, tape or glue.

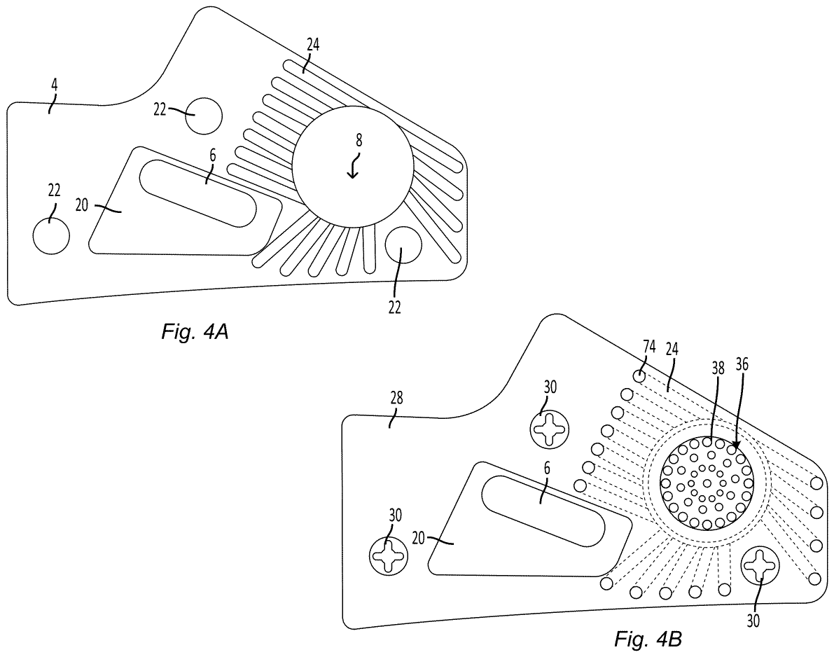

While FIG. 3B shows the loudspeaker 36 partly positioned below the functional layer 28, a loudspeaker 36 may also be positioned within an opening in a functional layer 28 or on top of a functional layer 28. As long as frontal sound and rear sound of the loudspeaker 36 are emitted at or towards two opposing sides of the functional layer 28 and thereby separated by the functional layer 28, the functional layer 28 functions as a baffle for the loudspeaker 36 as intended by the invention. The loudspeaker 36 may further be sealed against the functional layer 28 in any suitable way including but not limited to tight fitting, intermediate seals of, for example, rubber or foam, and a glued connection. As discussed with respect to FIGS. 3A-3B any variety and number of sound guides 24 may be formed within the protective layer cheek piece 4. FIGS. 4A-4B, 5A-5B, 6A-6B provide further examples of sound guides that may be formed within the protective layer cheek piece 4. FIGS. 4A, 5A, and 6A, illustrate an example protective layer cheek piece 4 design, while FIGS. 4B, 5B, and 6B illustrate a functional layer 28 abutting the protective layer cheek piece 4, covering sound guides 24.

In the example of FIG. 4A, the sound guides 24 formed in the protective layer cheek piece 4 are shaped and arranged such that each of the sound guides 24 extends substantially linearly away from the edge of the loudspeaker pocket 8. The sound guides 24 are also shown terminating prior to the outer edge of the protective layer cheek piece 4.

FIG. 4B shows a functional layer 28 covering the sound guides 24. The functional layer 28 includes sound outlets 74 in form of holes that align with corresponding terminal ends of the sound guides 24. Alternatively, sound guides 24 may extend in at least two directions when viewed from sound outlets 74 instead of sound outlets 74 being located at the end of the sound guides 24. Thus, in the example of FIG. 4B, acoustic waves (rear sound) exit the rear face of the loudspeaker 36 and travel the path of each sound guide 24 before exiting through the sound outlets 74 on the same side of the functional layer 28 as the front face of the loudspeaker 36. Sound outputs 74 may release rear sound into an interior space 15 (not shown, see FIG. 1) of a helmet. Besides free space, the interior space 15 may also comprise a cushion layer 16 (not shown, see FIG. 1) of a helmet as such a layer may be acoustically permeable and sound outlets 74 may release sound into or next to elements of a cushion layer 16. However, when such acoustic waves (rear sound) exit the sound guides 24 through the sound outlets 74, they may still be substantially inverted in phase relative to the acoustic waves (frontal sound) emitted from the front face of the loudspeaker 36. This is particularly the case for lower frequency acoustic waves (or sound) for which the wavelength is substantially larger than the length of the sound guides 24.

Generally, a cushion layer (not shown) such as that described previously, may be placed over the functional layer 28. In some examples, the cushion layer and functional layer 28 are combined into one functional part. Thus, the design of the sound outlets 74 may require additional sound guides or acoustic pathways configured to allow acoustic waves to exit the sound guides 24 through sound outlets 74 and penetrate a cushion material arranged on or forming part of the functional layer 28.

In the example of FIG. 5A, a portion of the protective layer cheek piece 4 comprises a recessed area providing a sound guide 24 between separators 54 distributed over the recessed area. The term separator is used throughout this specification to describe a surface section or other structural component that is arranged and constructed to separate or provide space between two other functional components or elements. At least one of these functional components or elements may in some cases be part of one physical component including at least one separator. At the same time, separators may also provide free intermediate space between opposite surface sections of one or more separators. Intermediate space may comprise space that can be crossed by a direct line between two opposing surface sections. Free intermediate space between surface sections of at least one separator may provide a sound propagation path. The sound propagation path may be partly confined by the at least one separator. Examples of separators include standoffs, spacers and distance holders in any suitable shape as well as uneven surface sections that provide similar features or functionality. When covered with a functional layer 28 as in FIG. 5B, the separators 54 provide controlled minimum spacing between the protective layer cheek piece 4 and the functional layer 28 to ensure sufficient rear ventilation of the loudspeaker 36. Free intermediate space between a plurality of surface sections of separators 54 provides sound propagation paths in form of sound guide 24 that is additionally bounded by the recessed area surrounding separators 54. The functional layer 28 of FIG. 5B covers sound guide 24 thereby further restricting propagation paths for rear sound of the loudspeaker 36. Acoustic waves emitted from the rear face of the loudspeaker 36 travel through the free space provided between separators 54 under the functional layer 28. The separators 54 may be of arbitrary shape and size, and of different materials. In a preferred embodiment, separators 54 will be part of protective layer cheek piece 4 and therefore made of the same material. In other cases, some or all of separators 54 may be part of functional layer 28 or may be individual components. FIG. 5A also shows raised sealing element 40 to provide sealing around the clip fastener recess 22 located in the area of sound guide 24, which accommodates the clip fastener receptacle 30 of the functional layer 28 shown in FIG. 5B.

FIG. 5B shows the functional layer 28 applied over the sound guide 24 formed by a recess in protective layer cheek piece 4 between separators 54. In the embodiment shown, the functional layer 28 is applied over the entirety of the protective layer cheek piece 4, but only that portion of it that covers the recessed area forming sound guide 24 and loudspeaker pocket 8 of the protective layer cheek piece 4 provides acoustical functionality, i.e., functions as a baffle. Similar to functional layer 28 of FIG. 4B, functional layer 28 of FIG. 5B provides sound outlets 74 through which acoustic waves exit sound guide 24. The functional layer sound outlets 74 are shown as oval but may be of any arbitrary shape and may be located at positions other than those shown. The remaining portion of the functional layer 28 provides additional clip fastener receptacles 30, which can be used for attaching a cushion layer.

FIGS. 6A-6B show an example of a protective layer cheek piece 4 with recessed loudspeaker pocket 8 and a multitude of cylindrical separators 54 raised from the surrounding surface of protective layer cheek piece 4. Free intermediate space between a multitude or plurality of surface sections of separators 54 provides sound propagation paths in form of sound guide 24. Like in the example of FIGS. 5A-5B, the separators 54 in the embodiment of FIGS. 6A-6B provide enough space between the functional layer 28 and the remaining protective layer cheek piece 4 surface for rear speaker ventilation. Raised sealings 40 on the protective layer cheek piece 4 support the functional layer 28 and are used to restrict potential sound propagations paths within sound guide 24 to control the minimum distance from the loudspeaker 36 at which rear sound may mix with frontal sound of the loudspeaker 36 by obstructing an otherwise open path for rear sound. While FIG. 6 show separators 54 as part of protective layer cheek piece 4, separators 54 may in other cases be part of functional layer 28 or may be individual components.

As can be seen in FIG. 6B, in this example the functional layer 28 covers only the area of the protective layer cheek piece 4 defined by the raised separators 54 and raised sealings 40 up to loudspeaker 36. Rear sound from the loudspeaker 36 is emitted at the unsealed outer edges along the perimeter of the functional layer 28. In this example the functional layer 28 is held at a distance from the main surface area of the protective layer cheek piece 4 by means of the raised separators 54. As a result, there is an open slit that functions as sound outlet 74 between the functional layer 28 and the protective layer cheek piece 4 that may be susceptible for ingress of wind coming into the helmet 12 from a frontal direction or circulating inside the helmet 12. As a counter measure, low profile wind shields (not shown) may be added in front of the sound outlet 74 for sides that are prone to wind ingress. There may also be a complete sealing around the edge of the functional layer 28 and holes (e.g., sound outlets 74) in the plane surface of the functional layer 28 may release rear sound towards the interior side of the functional layer 28 as shown in previous examples.

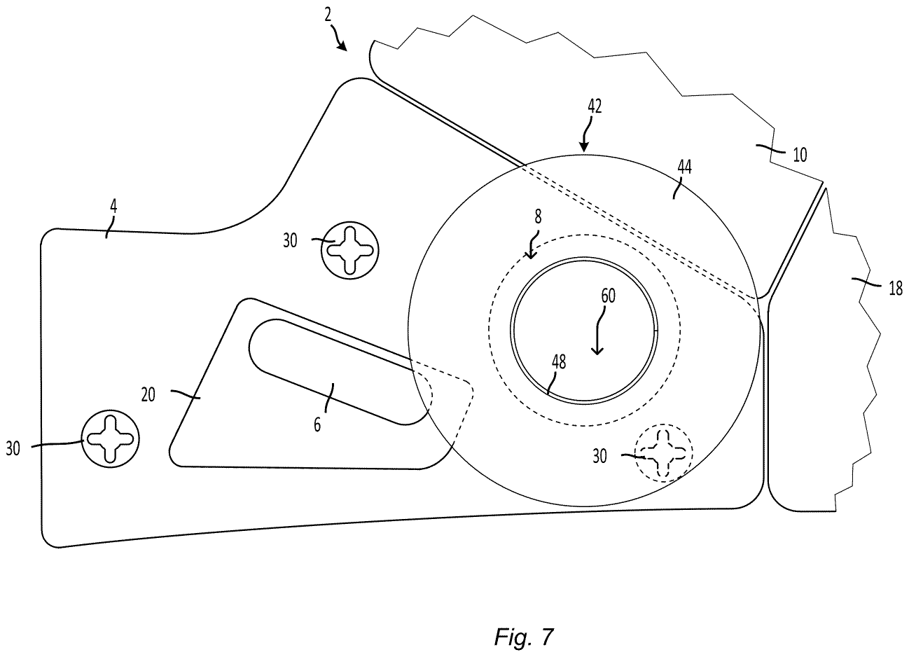

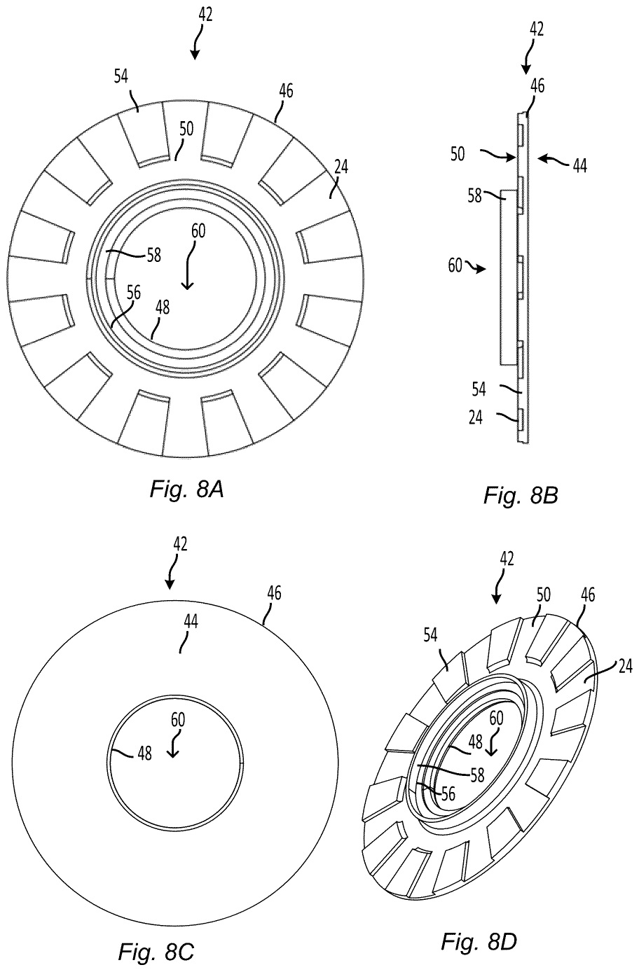

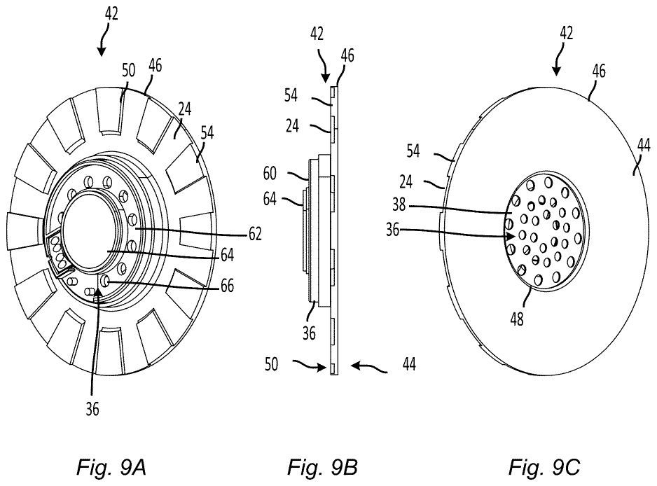

FIG. 7 shows an alternative embodiment of the invention in form of a baffle 42 that may be positioned on top of a protective layer cheek piece 4 and potentially additional functional layers that may be present in a helmet. While a baffle 42 as shown in FIG. 7 as well as FIGS. 8 and 9, could generally be part of a larger protective layer assembly of a helmet, it may also be provided as an aftermarket accessory to be added to an existing loudspeaker and/or helmet. A baffle 42 combined with a loudspeaker 36 (not shown in FIG. 7), is referred to as transducer assembly which may also be provided as an aftermarket accessory for helmets or included in a larger protective layer assembly of a helmet. Because the baffle 42 is intended to be assembled on a loudspeaker 36 and/or within existing helmets, the cheek piece 4 as shown in FIG. 7 does not involve sound guides formed in the protective layer. Instead, one or more sound guides are provided on the exterior facing side of the baffle 42, as can be seen in FIGS. 8A-D. In some embodiments, however, sound guides may additionally or alternatively be formed in the protective layer cheek piece 4 below the baffle 42.

Basic features of the protective layer 2 that are covered by the baffle 42 are shown as dashed lines to foster understanding of the relative position of individual elements. In the example of FIG. 7, the baffle 42 covers part of the protective layer cheek piece 4 and part of the protective layer temple piece 10. As previously mentioned, these parts of a protective layer (3, 10, 18 in FIG. 7) merely provide an illustrative example. In other cases, protective layers may comprise one or more components with various structural shapes. A generic baffle shape, for example circular, may be utilized for an aftermarket accessory meant to be retrofitted to multiple different existing helmets. A potential problem of generic baffle shapes is shown in FIG. 7, where the baffle 42 covers a female receptacle of a clip fastener 30 meant to receive a mating male part to attach an inner layer of a helmet (e.g., a cushion layer 16, not shown) to the protective layer 2. In other cases, a chin strap channel 6 may be covered at least partly by the baffle 42. Such problems may be solved by a user, simply by cutting away parts of the baffle 42 in the region of the clip fastener 30 and/or the chin strap channel 6. Therefore, a material that can be cut easily may be used for an aftermarket baffle 42 with generic shape. In some examples the baffle 42 may include cutting marks that support manual customization of the baffle perimeter to allow for adaption or addition of an opening in the baffle 42 or of an outer perimeter shape of the baffle 42.

FIG. 7 shows a baffle 42 placed against a protective layer cheek piece 4 that is positioned on the right side of the wearer's head when the helmet 12 is worn. As with all embodiments, it is to be appreciated that the disclosure contemplates a second baffle essentially mirror-symmetrical to the baffle 42 shown, which would be placed against a protective layer cheek piece 4 that is positioned on the left side of the wearer's head when the helmet 12 is worn. It should also be appreciated that the protective layer cheek piece 4 may in some cases comprise a functional layer 28 as previously described, covering at least part of the cheek piece 4. In such case the baffle 42 may at least partly rest on the functional layer 28.

FIGS. 8A-8D show different perspective views of an example of a generic baffle 42 as introduced in FIG. 7. FIG. 8A shows an example of an exterior facing side 50 of a baffle 42. FIG. 8B provides a profile view of the baffle 42. FIG. 8C shows an interior facing side 44 of the baffle 42, and FIG. 8D provides an angled view of the baffle 42 showing predominantly the exterior facing side 50 of the baffle 42. The outer shape of the baffle 42 is defined by its outer edge 46, defining the perimeter of the baffle 42. In this example, the shape of the perimeter of the baffle 42 is circular but other shapes are possible like, for example, round, oval or oblong shapes. Especially elongated shapes may help to fit a baffle 42 into an existing helmet as it may be rotated to comply with geometric features of the helmet.

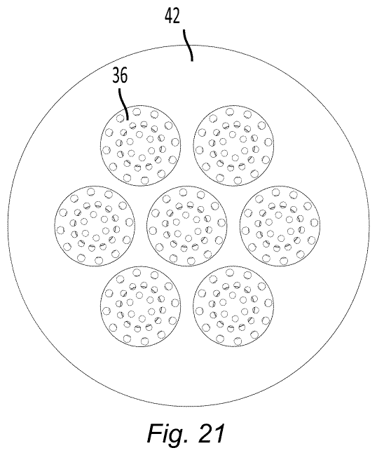

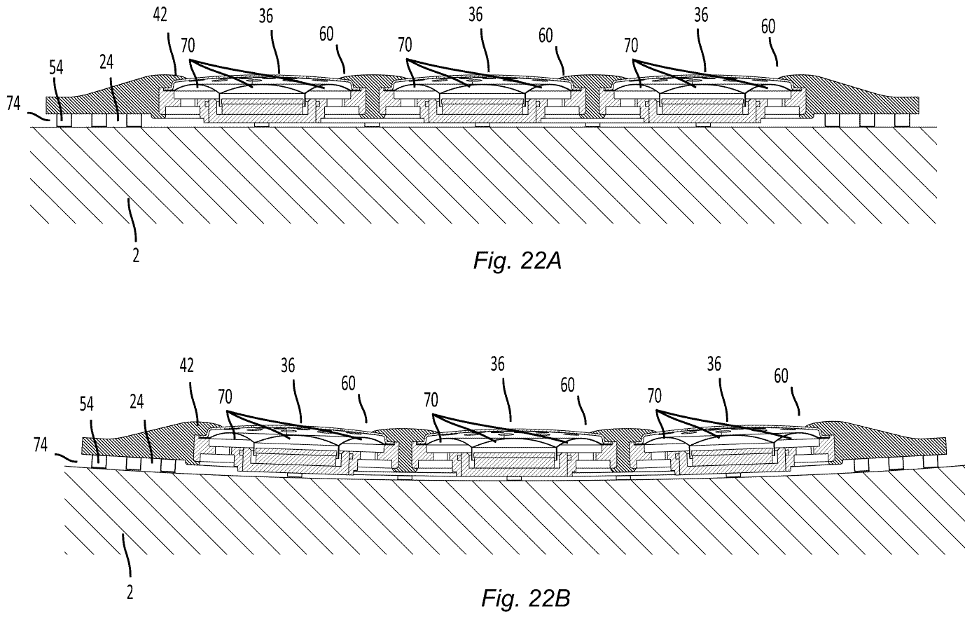

The baffle 42 comprises a loudspeaker receiving region 60 comprising an opening 48 from the exterior facing side 50 to an interior facing side 44 of the baffle 42 (44 not shown in FIG. 8A, see FIG. 8C). In other cases, the loudspeaker receiving region 60 may comprise multiple openings 48 within the loudspeaker receiving region 60 (see for example FIGS. 21, 22A-22B) for one or more loudspeaker(s) 36 (not shown in FIGS. 7-8, see for example FIG. 9). An inner edge 56 on the exterior facing side 50 of the baffle 42 defines the perimeter of the loudspeaker receiving region 60, thereby bounding the loudspeaker receiving region 60 laterally. With respect to the baffle 42, a lateral direction means a direction approximately perpendicular to the exterior facing and the interior facing direction. In the example of FIG. 8A, an inner rim 58 extends from the inner edge 56 on the exterior facing side of the baffle 42, the inner rim 58 further extending the lateral bounding of the loudspeaker receiving region 60 towards an exterior facing direction. In this case, either one of the inner edge 56 and the inner rim 58 may be understood to bound and therefore define the loudspeaker receiving direction 60. In other cases, the inner rim 58 surrounding the at least one opening 48 of the loudspeaker receiving region 60 may not extend from the baffle 42. The inner rim 58 may be an inner wall section of a single opening 48 between the exterior facing side 50 and the interior facing side 44 of the baffle 42. In such cases, the inner wall section of the opening 48 (the inner rim 58) may, for example, wrap around part of a loudspeaker 36 with loose- or tight-fitting materials. In this case, the inner edge 56 may be an edge where the exterior facing side 50 or the interior facing side 44 of the baffle 42 ends and the opening 48 begins. In yet another case, the inner edge 56 may be an edge on the exterior facing side 50 of the baffle 42 between surface sections with different angular orientation. For example, the baffle 42 may at least partly follow a curvature on a frontal side of a loudspeaker 36 within the loudspeaker receiving region 60 and become approximately flat outside the loudspeaker receiving region 60. Outside the loudspeaker receiving region 60, the baffle 42 may have a maximum thickness of less than 5 mm, less than 3 mm, or less than 2 mm. The minimum thickness of the baffle 42 outside the loudspeaker receiving region 60 may be less than 3 mm, less than 2 mm, less than 1.5 mm or less than 1 mm. In such or similar cases, there may also be an adhesive film on the exterior facing side 50 of the baffle 42 on the boundaries of the loudspeaker receiving region 60. In case no geometrical features like an edge or rim are present, the lateral extension of the adhesive film may define the loudspeaker receiving region 60. While the inner rim 58 in the example of FIGS. 8A-8D has an equal surface in an exterior facing direction, the inner rim 58 may comprise a groove, notch or slot extending around or along at least part of a surface of the rim 58 oriented towards the loudspeaker receiving region 60. The notch, groove or slot may be arranged and constructed to receive a mating geometrical feature of a loudspeaker 36 like a tongue, nose or key or simply and outer edge of the loudspeaker 36 to secure the loudspeaker 36 mechanically and/or seal it against the baffle 42.

In the illustrated example of FIGS. 8A-8D, the inner edge 56 and thus the loudspeaker receiving region 60 are circular and are designed to have dimensions for receiving an at least partly circular or cylindrical loudspeaker 36 or a cylindrical part of a loudspeaker 36 as often used in helmets. In other cases, the inner edge 56 and the loudspeaker receiving region 60 may approximate a circular or cylindrical shape. Such an approximation may, for example include polygon shapes, like for example hexagon or octagon shapes as well as elliptical or oval shapes. As an example of preferred dimensions, the circular or approximately circular cross-section area bounded by an inner edge 56 or rim 58 of the baffle 42 may comprise a maximum inner diameter between 28 mm and 55 mm, between 28 mm and 47 mm, or between 35 mm and 47 mm. In other embodiments, however, the inner edge 56 may be of any arbitrary shape, as described in more detail below.

In some embodiments, the inner edge 56 is sized to form an air-tight or acoustically tight seal around the loudspeaker 36 when the loudspeaker 36 is inserted into the loudspeaker receiving region 60. This may be achieved by press-fit sealing of the loudspeaker 36 within the loudspeaker receiving region 60, resulting in a press-fit connection that may also provide mechanical attachment. At least part of the loudspeaker receiving region 60, for example the inner edge 56 and/or the inner rim 58 may comprise an open sleeve arranged and constructed to fit tightly around at least part of the loudspeaker 36, for example a grille, a basket or frame of the loudspeaker 36. For easy assembly, the baffle 42 may comprise a flexible and/or soft material at least around the loudspeaker receiving region 60, that can be stretched around a loudspeaker 36. Alternatively, or additionally, there may be at least one sealing element either between the baffle 42 and the loudspeaker 36 or as integral part of either one, that seals the baffle 42 against the loudspeaker 36. Such sealing element may, for example, comprise soft and/or flexible materials like sponge rubber and other compressible foams. While sealing between baffle 42 and loudspeaker 36 helps to avoid acoustic short cuts from the rear of the loudspeaker 36 towards the front side, sealing requirements are generally much lower compared to a sealed rear enclosure because air pressure within the latter is much higher compared to the ventilated case with the baffle 42.

The loudspeaker receiving region 60 may be tiered in an interior or exterior facing direction or otherwise have some amount of depth to it so as to cradle at least part of the loudspeaker 36 and provide for the air-tight or acoustically tight seal. This is partly the case in the example of FIGS. 8A-8D, where the inner rim 58 comprises a certain depth in an exterior facing direction. There may, for example, be an additional step at an exterior facing end section of the inner rim 58, where the encircled cross section gets smaller such that the inner rim 58 can at least partly wrap around an external facing side of a loudspeaker 36 placed within the loudspeaker receiving region 60. The baffle 42 may also be clamped, glued or otherwise chemically, thermally or mechanically bonded to the loudspeaker 36 to achieve mechanical fixation and/or sealing within a resulting transducer assembly. In any such configurations with some degree of sealing, acoustic waves radiating from the rear side of the loudspeaker 36 are substantially kept behind the exterior facing side 50 of the baffle 42, i.e., between the exterior facing side 50 and a layer of the helmet abutting the exterior facing side of the baffle 42, for example a protective layer of the helmet, until they reach the outer edge 46. Acoustic waves emitted from the front face of the loudspeaker 36 are substantially kept in the interior side/space of the helmet abutting the interior facing side 44 (not shown in FIG. 8A, see FIG. 8D) of the baffle 42 and potentially the wearer's head or ear until they reach the outer edge 46. In other words, the baffle 42 separates the acoustic waves emitted from the rear side of the loudspeaker 36 from the acoustic waves emitted from the front side of the loudspeaker 36, such that acoustic waves emitted at the rear side of the loudspeaker 36 travel a much longer distance through free air until they reach the wearers ear than acoustic waves from the front side of the loudspeaker 36. Therefore, acoustic waves emitted at the rear side of the loudspeaker 36 will have expanded into a much larger air volume within the helmet until they reach the wearers ear than acoustic waves emitted at the front side of the loudspeaker 36. As a result, the remaining sound pressure level at the wearer's ear of rear emitted acoustic waves (rear sound), is much lower than sound pressure level of front emitted acoustic waves (frontal sound). This provides for lower cancellation of the frontal sound by rear sound than would be the case without the baffle 42.

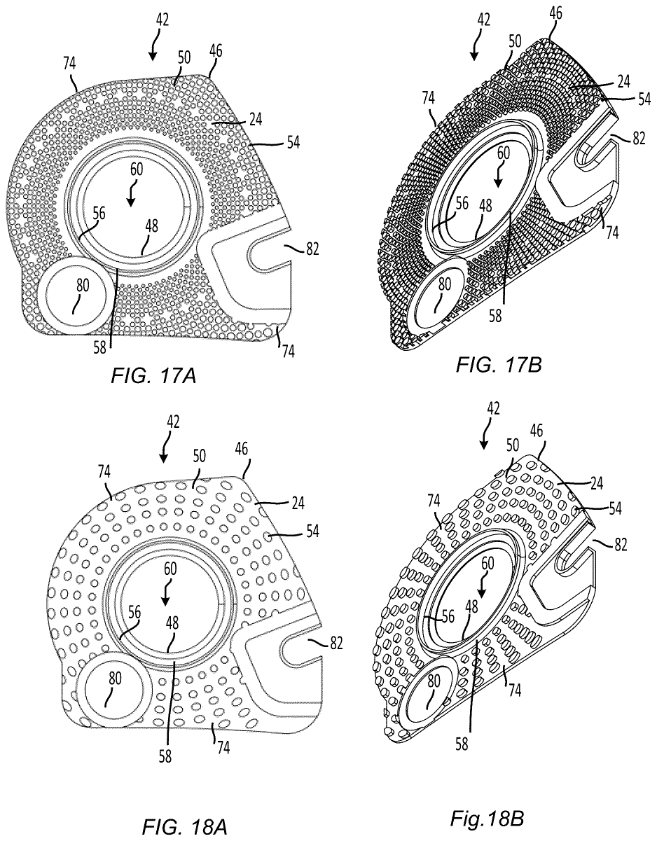

The exterior facing side 50 of the baffle 42 includes one or more sound guides 24. The sound guides 24 provide spacing between the exterior facing side 50 of the baffle and a layer of the helmet when the baffle 42 abuts a layer of the helmet. For example, the baffle 42 may abut a protective layer, a functional layer or a cushion layer of the helmet. The sound guides 24 are formed by a plurality of surface sections on the exterior facing side 50 of the baffle 42 including one or more separators 54. In the example of FIGS. 8-9, the support surface of the separators 54, that may directly abut a layer of the helmet, exhibits an approximately trapezoid shape with two curved sides. The separators 54 cover about 40% of the exterior facing side 50 of the baffle 42. In other cases, separators 54 may cover between 30% and 60% or between 20% and 80% of the exterior facing side 50 of the baffle 42. The support surface of each separator 54 is approximately 130 mm2 in the exemplary case that the loudspeaker receiving region 60 of FIGS. 8-9 comprises a diameter of 40 mm. In similar cases, the support surface per separator 54 may be between 100 mm2 and 180 mm2. In other cases, like for example shown in FIG. 17, there may be a higher number of separators 54 with a smaller support surface area. In such cases, the support surface area of separators 54 may be as small as 0.5 mm2. Depending on the number of separators 54, the support surface area of individual separators 54 may be between 0.5 mm2 and 200 mm2. The separators 54 extend essentially perpendicularly from the exterior facing side 50 of the baffle 42 but may in other cases also extend with different angles. Height of separators 54, meaning how far separators 54 extend from the baffle 42, is one factor defining the cross-section area of resulting sound guide(s) 24. Further depending on the percentage of coverage of the exterior facing side 50 of the baffle 42 by separators 54 and on the distance from the loudspeaker receiving region 60 or a loudspeaker 36, height of separators 54 may vary to keep sufficient cross-section area for sound guide(s) 24 while keeping the thickness of the baffle 42 as low as possible. In some cases, separators 54 on a baffle 42 may have a height between 0.3 mm and 5 mm and in other cases between 0.5 mm and 2 mm. The separators 54 are spaced apart from one another between multiple close positions, near to the loudspeaker receiving region 60 defined by the inner edge 56 or inner rim 58 of the baffle 42 and multiple remote positions, near the outer edge 46 of the baffle 42 such that a plurality of surface sections of separators 54 is arranged to provide free intermediate space in the form of sound guides 24. Sound guides 24 thereby provide multiple sound propagation paths from close positions to remote positions for rear sound of a loudspeaker 36 placed within the loudspeaker receiving region 60. While the example of FIG. 8 comprises 12 sound guides 24 providing substantially 12 sound propagation paths from respective close positions to corresponding remote positions, a baffle may provide at least one sound propagation path for rear sound from at least one close position to at least one remote position. The sound guides 24 may guide acoustic waves radiating from the rear side of the loudspeaker 36 in one or more directions approximately parallel to the front and rear face of the loudspeaker 36 as well as the interior facing side 44 of the baffle 42 and away from the loudspeaker 36, thus shifting the dipole null of the loudspeaker 36 also away from the loudspeaker 36. In effect, the sound pressure level of rear sound at the frontal side of the loudspeaker 36 is substantially reduced by the sound propagation path provided by the sound guides 24, as induced on sounds emitted by the rear side of the loudspeaker 36. According to certain examples, the distance between at least one of the at least one close position (e.g., adjacent the loudspeaker receiving region 60 or inner edge 56), and the at least one remote position (e.g., adjacent the outer edge 46) is at least 5 mm, at least 10 mm, or at least 15 mm, in a direction essentially parallel to the main extension of the interior facing side of the baffle 42. In the example of FIGS. 8A-8D, the separators 54 are shaped and arranged such that sound guides 24 extend substantially linearly between close positions near the inner edge 56 of the baffle 42 and remote positions near the outer edge 46 or perimeter of the baffle 42. It will be appreciated, that free intermediate space between a plurality of surface sections on the exterior facing side 50 of the baffle 42 forms sound propagation paths through free air in the form of sound guides 24 irrespective of any additional element or surface that the baffle 42 may abut to when installed inside a helmet. This means that the baffle 42 alone already provides these partly confined sound propagation paths through sound guides 24. In case an additional surface, for example an inner layer of a helmet, abuts the exterior facing side 50 of the baffle 42, propagation of rear sound through free air may be substantially restricted to sound guides 24.

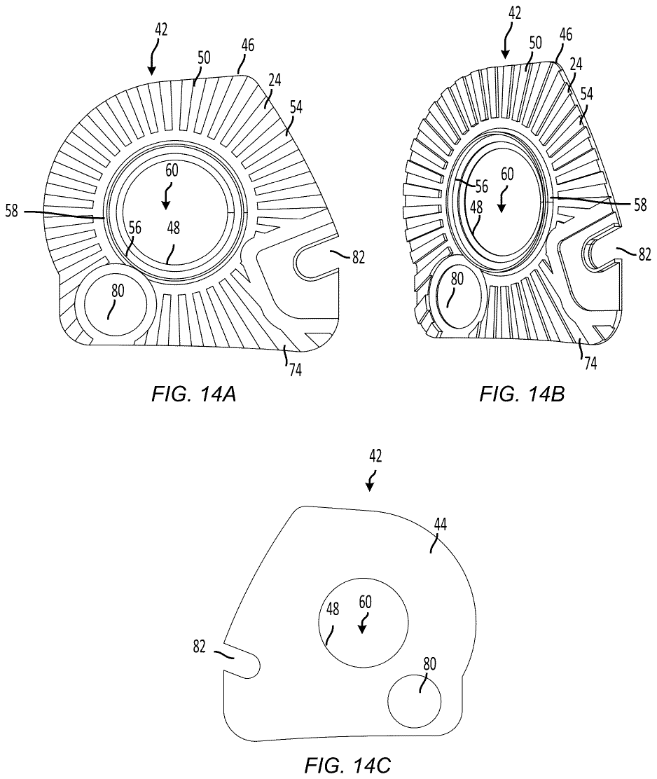

There may be one or more separators 54 present on the exterior facing side 50 of the baffle 42. The separators 54 may generally be of any arbitrary shape or size although specific geometries may provide acoustical or mechanical advantages. Separators 54 may for example be provided as woven or non-woven fabric comprising synthetic fibers in the form of hooks or loops as used for hook-and-loop fasteners with free air between a plurality of surface sections of respective hook or loop features providing fluid ventilation and therefore a sound propagation path for the rear side of the loudspeaker 36. For example, the baffle 42 may comprise hook features on the exterior facing side 50 that can be attached to a fabric layer within the helmet. The fabric layer may, for example, be part of a cushion layer of the helmet. In another example, the baffle 42 may comprise approximately constant material thickness but may be shaped to provide an uneven surface. For example, part of the baffle 42 may be bent into wave shapes providing free air between opposing surface sections spaced apart by the wave shape. In such a case, the wave features may be understood as separators 54 on the exterior facing side 50 of the baffle 42 and surface sections of the wave-shaped baffle 42 provide free intermediate space for sound propagation. The thickness or elevation of the separator from the surrounding surface sections, i.e., the distance it projects from the base of the exterior facing side 50 of the baffle 42, may range from approximately 0.3 mm to approximately 5 mm, or from approximately 0.5 mm to approximately 2 mm, or generally any other thickness suitable for creating sound guides 24 when used in connection with a loudspeaker 36 in a helmet to be worn by a user, i.e., when accounting for available space within the helmet. It is preferable in some embodiments that the overall thickness of the baffle 42 outside the loudspeaker receiving region 60, including the thickness of the separators 54, does not exceed approximately 5 mm for helmets with sufficient free space and does not exceed 3 mm or in some cases does not exceed 2 mm for helmets with more severe space constraints. The sound guides 24, defined by a plurality of surface sections on the exterior facing side 50 of the baffle 42, including the separators 54, may similarly be of any shape. For instance, the sound guides 24 may be nonlinear or may change in width as separators 54 extend and terminate in the radial direction from the inner edge 56 to the outer edge 46 of the baffle. Additional examples of separators 54 forming sound guides 24 are shown in FIGS. 14A-14C, 15A-15B, 16A-16B, 17A-17B, 18A-18B, and 19A-19B. In some cases, no distinct or individual sound guides 24 may be formed, for example in case of a multitude of relatively small separators 54. A multitude of small separators 54 may effectively form a multitude of partly overlapping sound propagation paths between surface sections of the separators 54 that may be understood as a multitude of small sound guides 24 or as a single sound guide 24.

The baffle 42 may be made of a flexible or semi-flexible material for example a plastic material or other material with suitable properties, including but not limited to Thermoplastic Polyurethane (TPU) and Polyether Block Amide (TPA), Nylon, Silicone and synthetic or natural Rubber. In some embodiments, the baffle 42 may comprise a material with a Shore A hardness between 30 and 98, between 40 and 95 or between 50 and 90. Depending on the actual material(s) of a baffle 42 or similar components of transducer arrangements as described herein, injection molding, milling, casting or 3D printing may be included in suitable production processes for the baffle 42 or components thereof. A baffle 42 may comprise multiple sub-components that jointly provide the form and function of the baffle 42. Such sub-components may require additional production steps to mount, assemble or attach them to obtain a full baffle 42. Sub-components of a baffle 42 or similar component may, for example, comprise separators 54, attachment or mounting means for a loudspeaker 36, like an adhesive film or specific mechanical part for loudspeaker attachment, as well as a grille or protective cover for the loudspeaker 36. EPS or other thermoplastic foam with suitable sound transmissibility may also be appropriate for construction of the baffle 42 or parts thereof. In many helmet applications, space is severely limited and a thin baffle 42 is required. Suitable material density may provide enough weight for a thin baffle 42 to reduce movement and deformation of the baffle 42 caused by an adjacent sound field and therefore help with acoustic separation between an interior and an exterior facing side of the baffle 42. Mechanic stability required to avoid excessive compression of sound guides 24 for sound transmission may also require suitable material density. A preferred density range for the material(s) of baffle 42 is between 0.8 g/cm3 and 2.3 g/cm3. In some cases, the baffle may comprise a single material, while in other cases multiple layers of different materials may be included. For instance, the outermost layer comprising the exterior facing side 50 may include one side of a hook-and-loop fastener, for example made from Polyamide or Polyester, or other woven or non-woven fabrics. Hook-and-loop fasteners are known and commercially available under the brand name Velcro. In this case as well as other cases, the material comprising the separators 54 may be of a more rigid material than other portions of the baffle 42. A thin layer of a hook-and-loop fastener may be provided on separators 54 to allow attachment to a helmet layer, e.g., a protective layer, a functional layer or a cushion layer. In this case the hook-and-loop fastener serves a similar purpose as an adhesive layer with the advantage of repeatable detachment and attachment and potential attachment to a fabric layer of the helmet. Hook as well as loop features may be small to provide attachment without much increase in baffle thickness. For example, hook-and-loop fasteners with less than 1.5 mm or less than 1 mm total thickness may be utilized for such applications. This may also limit sound transmission between layers of the hook-and-loop fasteners to keep sound guide structures on the baffle 42 acoustically effective with low air-leakage and therefore also low sound-leakage between sound guides 24. Separators 54 may alternatively be partly or completely provided in the form of hooks and/or loops of or similar to a hook-and-loop fastener structure if the respective features are sized and arranged accordingly. If there is enough free intermediate space between surface sections of individual hooks and/or loops that may provide for sufficient airflow supporting airborne sound transmission between carriers of the respective hook and/or loop features, this can provide at least one sound propagation path for rear sound of a loudspeaker 36. With suitable strength, shape and sizing, the hook and/or loop features may also serve as distance holders or separators 54 between respective carrier materials and thereby between the baffle 42 and any abutting layer of the helmet. Alternatively, hook-and-loop fastener features may be combined with distance holders on the exterior facing side 50 of the baffle 42 to ensure that the propagation path for rear sound is not blocked mechanically. Fastening systems similar to hook-and-loop fasteners exist, of which at least individual elements may be applied in a comparable way as described above. Examples would be sliding engaging fasteners and fasteners with interlocking mushroom-shaped heads on the end of pins extending from a carrier surface. The latter are, for example, known and commercially available under the trademark names Duotec and Dual Lock. The baffle 42 may also be made of a material that can easily be cut by the wearer without damaging the overall baffle structure, for example without cracking the structure. For instance, a wearer may want to adjust the outer edge 46 or perimeter of the baffle 42 so that the baffle 42 fits inside a wearer's helmet in a manner that fits geometrical or functional features of the helmet or provides greater comfort. For example, a portion of a baffle 42 may be cut away to avoid interference with a clip fastener, for example, between an inner lining or cushioning of the helmet and another layer, like a protective layer or an external layer of the helmet. If a baffle 42 is intended for use with multiple specific helmets that require cutouts at different locations of the baffle 42, cutting marks may be provided on the baffle 42 for easy cutting and adaption to at least one specific helmet. Cutting marks may be printed on a surface of the baffle 42. The baffle 42 may also comprise recessed or raised features such as lines or symbols that provide guidance for cutting. Cutting marks may also comprise regionally reduced thickness of baffle sections that support easy cutting, for example along lines of reduced thickness. Generally, cutouts may only concern an inner region of the baffle 42 within the outer edge 46 or perimeter or cutouts may adapt the shape of the outer edge 46 or perimeter. In some cases, a wearer may want to enlarge, e.g., cut, the inner edge 56 of the baffle 42 to accommodate a larger loudspeaker 36.

FIGS. 9A-9C show additional perspective views of the baffle 42 according to the example of FIGS. 8A-8D with a loudspeaker 36 attached. The loudspeaker 36 may be attached to the baffle 42 by a permanent or semi-permanent connection, e.g., by an adhesive film layer or a press-fit connection. Thus, in some examples, the baffle 42 may comprise at least one loudspeaker 36 to form a transducer arrangement with the loudspeaker 36. In other examples, the loudspeaker 36 may be a separate component for mounting or replacement on the baffle 42.

FIG. 9A, showing predominantly the exterior facing side 50 of the baffle 42 shows the rear face 62 of the loudspeaker 36 facing in the same direction as the exterior facing side 50 of the baffle 42. The rear face 62 of the loudspeaker 36 is shown including ventilation holes 66, allowing for acoustic waves to exit the rear face 62 of the loudspeaker 36. A magnet system 64 of the loudspeaker 36 is further shown as a component of the loudspeaker 36.

FIG. 9B, shows a profile view of the baffle 42 with the loudspeaker 36 mounted. In FIG. 9B the interior direction is to the right, the exterior direction is to the left and a lateral direction would be towards the top and bottom as well as into and out of the figure plane.

FIG. 9C, showing predominantly the interior facing side 44 of the baffle 42, shows the front face of the loudspeaker 36 (in the form of an exemplary loudspeaker grille 38). The baffle 42 thus allows for frontal sound to exit the front face of the loudspeaker 36. In some examples, a fabric or foam cover (not shown) may cover the loudspeaker grille 38 and may be mounted, attachable, or replaceable over the baffle 42 and/or a grille on the front face of the loudspeaker 36. The fabric or foam may be made of a material designed to protect the loudspeaker 36 against moisture such as sweat as well as dust and provide a more comfortable surface in case part of an ear were to touch the grille and/or baffle. In other cases, also not shown, a grille and/or fabric or foam cover may be part of the baffle 42 instead of the loudspeaker 36.

While loudspeakers 36 are shown as round according to the examples of FIGS. 9A-9C and in the additional figures within the disclosure, it should be understood that each baffle 42 according to any of the discussed embodiments may be shaped to fit a variety of loudspeaker shapes including elongated, square, trapezoidal and rectangular shapes, or some combination of each differently shaped loudspeaker 36.

FIGS. 10A-10C show examples of transducer arrangements including a loudspeaker and a baffle according to certain embodiments of the disclosure abutting a protective layer 2 of a helmet. In the example of FIG. 10A, a loudspeaker 36 is shown surrounded by a baffle 42. Baffles 42 may be the same or different baffles compared to baffles discussed with respect to FIGS. 8-9. Other baffles may have different configurations but otherwise having equivalent features and functions compared to baffles 42 of FIGS. 10A-10C. The loudspeaker 36 is shown including a grille 38, a membrane or diaphragm 70, a loudspeaker basket 72 including rear ventilation holes 66 and a magnet system 64. In some embodiments, the loudspeaker 36 is not provided together with the baffle 42. In other embodiments, the baffle 42 and the loudspeaker 36 are integrated into a transducer arrangement.

The rear ventilation holes 66 provide for acoustic coupling between the rear of the diaphragm 70 (sound generating element) and sound guide(s) 24, through the spacing between loudspeaker 36 and the protective layer 2. The acoustic coupling between the rear of the diaphragm 70 and sound guide(s) 24 allows acoustic signals radiated from the diaphragm 70 to pass through the rear ventilation holes(s) 66 and further to the sound guide(s) 24 formed in the baffle 42 prior to reaching sound outlets 74, also referred to as sound output positions.

The loudspeaker 36 is shown surrounded by the baffle 42. In other words, the loudspeaker 36 is positioned in the loudspeaker receiving region of the baffle 42. Specifically, the inner rim 58 of the baffle 42 is shown encircling the sides of the loudspeaker basket 72. In some embodiments, the baffle 42 itself may be shaped to form an acoustic seal between the baffle 42 and the loudspeaker 36. In the same or other embodiments, a sealing ring or other sealing components may be attached, for example at the inner edge 56 or inner rim 58 of the baffle 42, to provide an additional tighter acoustic seal around the loudspeaker 36.

When sound is emitted from the loudspeaker membrane or diaphragm 70, a first set of acoustic waves (frontal sound) may radiate through the loudspeaker grille 38 away from the front side of the loudspeaker 36 into an interior space of the helmet and towards the ear of a user. A second set of acoustic waves (rear sound), approximately 180 degrees out of phase from or inverse to the first set of acoustic waves (frontal sound), may travel in the opposite direction through rear ventilation holes 66 away from a rear side of the loudspeaker 36, wherein the rear ventilation holes 66 may be acoustically coupled to sound guide(s) 24 through free space between the loudspeaker 36 and the protective layer 2. Effectively, sound guide(s) 24 of the baffle 42 are thereby extended up to the rear ventilation holes 66 of the loudspeaker 36 by the free space between the loudspeaker 36 and the protective layer 2. In this context it may be understood that the baffle 42 as an individual component, which may itself be an embodiment of the invention, may provide at least one sound propagation path also referenced as sound guide(s) 24 by means of free intermediate space between surface sections of the exterior facing side 50 of the baffle 42. In combination with a loudspeaker 36 and/or elements of a helmet, like protective layer 2, sound guide(s) may be extended, for example towards rear ventilation holes 66 of the loudspeaker 36. Because the loudspeaker 36 comprises a central ventilation hole 66 through the magnet system 64, the sound guide(s) 24 effectively extend(s) right to the central part of the loudspeaker 36 providing ventilation through all ventilation holes 66. Additional separators or a hook-and-loop fastener (both not shown) between the magnet system 64 and/or the loudspeaker basket 72 and the protective layer 2 may in some cases provide a controlled distance between these components to ensure sufficient cross section area in the extension of rear sound guide(s) 24 provided by the free space between the loudspeaker 36 and the protective layer 2. Separators (not shown) may also separate the region between the rear side of the loudspeaker 36 and the protective layer 2 into multiple at least partly divided sound guides 24. Reference to the front side or front face of the loudspeaker 36 generally refers to the side pointing in the direction of the head of a wearer of the helmet, while the rear side or face refers to the opposite side. Front and rear sides are not necessarily defined by features of the loudspeaker itself.

The sound guide(s) 24, provided by the baffle 42 and extended by the free space between the loudspeaker 36 and the protective layer 2 or any similar helmet component(s) allow acoustic waves to travel through air (as airborne sound) from the rear side of the loudspeaker 36 to sound outlets 74. Thereby, sound guide(s) 24 also provide(s) rear ventilation for the loudspeaker 36. The sound outlets 74 may be defined between the outer edge 46 of the baffle 42 and the protective layer 2 as shown in the examples of FIGS. 10A to 10C. Sound outlets 74 may also comprise holes within the baffle 42 as exemplary shown in FIG. 10C (on the right side). The outer edge 46, defining the perimeter of the baffle 42, may be extended or shortened in relation to the inner edge 56 or inner rim 58 of the baffle defining the loudspeaker receiving region 60, thereby increasing or decreasing a length of the sound guide(s) 24 respectively and/or an area bounded by the perimeter of the baffle 42. Generally, the boost effect for sound pressure level as provided by a baffle 42 tendentially increases with the area of the baffle 42 between the outer edge 46 or perimeter of the baffle 42 and the inner edge 56 and/or inner rim 58 defining the loudspeaker receiving region 60 of the baffle 42. Therefore, an area within the boundaries of the outer edge 46 or perimeter of the baffle 42 may be at least 25% larger, at least 50% larger, or at least 100% larger than the area of the loudspeaker receiving region 60. Additionally, or alternatively, the minimum distance between the outer edge 46 or perimeter of the baffle 42 and the loudspeaker receiving region 60 may be more than 5 mm, more than 10 mm, or more than 15 mm. Because sound guide(s) 24 provide(s) rear ventilation for the loudspeaker 36, sufficient total cross-section area within sound guide(s) 24 is required to avoid detrimental effects such as air noise or distortion of the loudspeaker signal. Therefore, the baffle 42 may be further designed to provide a minimum total cross-section area of the free intermediate space between the plurality of surface sections on the exterior facing side of the baffle 42 arranged to form at least one rear sound propagation path, also referenced as sound guide(s) 24. Within a region of the baffle 42 at an equal distance from the center of the loudspeaker receiving region 60, the minimum total cross-section area of the free intermediate space (and therefore also of the sound guide(s) formed by the free intermediate space) may be at least 1%, at least 2.5%, or at least 5% of the area of the loudspeaker receiving region 60. In case of a transducer arrangement including a baffle 42 and a loudspeaker 36 as shown for example in FIG. 10, the minimum total cross-section area of the free intermediate space within a region of the baffle 42 at an equal distance from the center of the loudspeaker 36 may be at least 1%, at least 2.5%, or at least 5% of the effective radiating area of the sound generating element or diaphragm 70 of the loudspeaker 36. Additionally, or alternatively, the minimum total cross section area of the free intermediate space within a region of the baffle 42 at an equal distance from the center of the loudspeaker receiving region 60 may be at least 10 mm2, at least 15 mm2, or at least 25 mm2.

In the example of FIG. 10A, separators 54 are shown providing separation between surface sections of the exterior facing side of the baffle 42 between separators 54 and the protective layer 2, thereby ensuring that sound guide(s) 24 are not blocked when the baffle 42 abuts a layer of a helmet. The separators 54 may be formed as part of or attached to the baffle 42 for contact against the protective layer 2 or any other suitable layer of a helmet.

FIGS. 10B and 10C provide additional examples of baffle and loudspeaker configurations according to embodiments of the disclosure. For instance, FIG. 10B illustrates a loudspeaker 36 without central ventilation hole through the magnet system 64. Thus, the rear of the loudspeaker 36, such as part of the magnet system 64, may directly abut the protective layer 2 while still providing free space at the rear of the loudspeaker 36 for allowing acoustic waves leaving the rear of the loudspeaker 36 through the ventilation holes 66 to reach the sound guide(s) 24. Similar to what has been described with reference to FIG. 10A, the loudspeaker 36 may in some cases be attached to an abutting helmet layer (e.g. protective layer 2) by means of a permanent or removable joint like for example a hook-and-loop fastener or an adhesive layer. If the baffle 42 is attached to the loudspeaker 36 and the loudspeaker 36 is attached to a helmet layer, the loudspeaker 36 mechanically supports the baffle 42. In other cases, the baffle 42 may be attached or mounted to an element of a helmet and support a loudspeaker 36 attached to the baffle 42.

In FIG. 10C, the separators 54 are shown as extending from protective layer 2 as opposed to extending from the exterior facing side of the baffle 42. The exterior facing side of the baffle 42 could in this example be relatively smooth or could include its own additional separators. Thus, the spacing forming the sound guide(s) 24 can be formed by separators 54 extending from a combination of the baffle 42 and/or the protective layer 2. FIG. 10C further shows sound outlets 74 exiting in an upward direction from the protective layer 2. Sound outlet 74 is formed by a gap between the outer edge of the baffle 42 and the protective layer 2, while an additional sound outlet 74 is shown as a hole in the baffle 42. While multiple types of sound outlets 74 are shown in the embodiment of FIG. 10C, the baffle 42 may include either sound outlet 74 or a combination of both. The directionality of the sound outlets 74 is shown such that acoustic waves emitted from the rear face of the loudspeaker 36, after traveling through the ventilation holes 66 of the loudspeaker 36 and through the sound guide(s) 24 of the baffle 42, will emit in the same direction as the acoustic waves emitted from the front face of the loudspeaker 36. In the perspective view of FIG. 10C, the separators 54 are shown adjacent to and behind the sound guide 24, thus, the sound guide 24 exists in the spaces lateral to the separators 54 in addition to the space in front of the separators 54. As a result, acoustic waves may travel through air (as airborne sound) from the sound guide 24 to the sound outlets 74.

While components within FIGS. 10A-10C are separately defined for illustrative purposes, individual components may be combined in a single physical part or multiple physical parts to provide similar functionality to the components described herein. Additionally, multiple loudspeakers 36 may be provided within a common baffle 42 (as discussed with respect to FIGS. 21, 22A-22C). Multiple loudspeakers 36 may provide for increased sound pressure level, or for directional cues by directing sound towards the pinna of the listener from specific angles. Also, in some embodiments, a rear sound guide may be formed in the protective layer 2 beneath the loudspeaker 36 instead of or in addition to comprising space between the protective layer 2 and the loudspeaker 36. In other embodiments, the rear sound guide may be free space defined between loudspeaker components such as loudspeaker basket 72 or magnet system 64 and the protective layer 2.

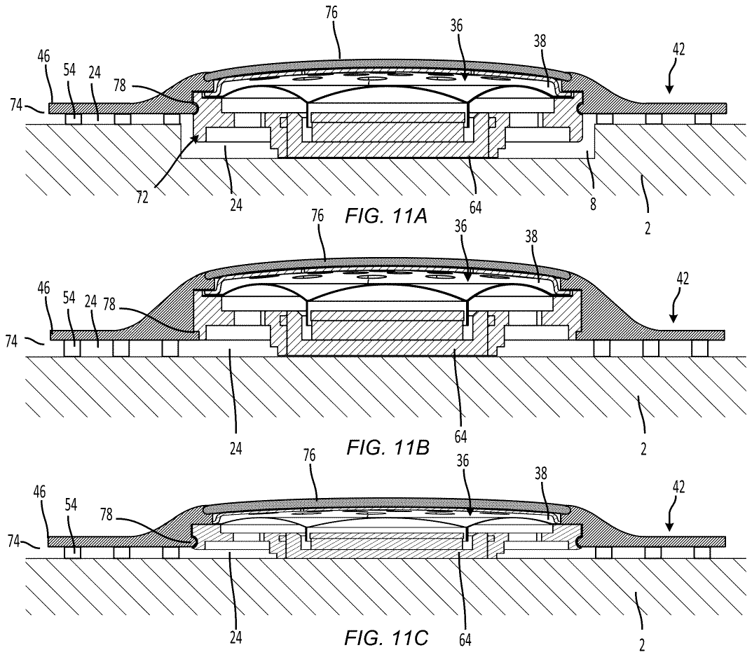

FIGS. 11A-11C show examples of a baffle 42 with a loudspeaker cover 76 and various speaker attachments and protective layer integration options according to certain embodiments. In the examples of FIG. 11, the baffle 42 is attached to the loudspeaker 36 by means of a circumferential baffle attachment feature 78 comprising, for instance, a groove, notch or slot in the loudspeaker basket 72 and a mating tongue, nose or key in the baffle 42. Such examples of a baffle attachment feature 78 may also be swapped between baffle 42 and loudspeaker basket 72. (e.g., corresponding baffle attachment features 78 may be interchangeable with corresponding loudspeaker attachment features). The baffle 42 may comprise a flexible material that allows an inner diameter to be expanded temporarily to mount it on the loudspeaker 36. Circumferential baffle attachment features 78, like a groove, notch, slot, tongue, nose or key, may alternatively or additionally be tilted or sloped to provide a thread function that allows mutual attachment by rotational movement between a baffle 42 and a loudspeaker 36. Either the loudspeaker 36 or the baffle 42 may comprise one or more grooves, notches or slot sections with a certain pitch or gradient that allows the loudspeaker 36 or baffle 42 to interlock with amating tongue, nose or key sections through relative rotation. Groove, notch or slot sections may have different angular extension than the mating tongue, nose or key sections. For example, tongue, nose or key sections may be implemented as pins that engage with corresponding groove, notch or slot sections that extend over a larger angular range, for example more than 15 degrees or more than 30 degrees.

Baffles 42 may comprise an acoustically permeable cover for the loudspeaker 36. In the given examples, the loudspeaker cover 76 is provided on top of a loudspeaker grille 38. Another option for the baffle 42 would be to include a loudspeaker grille 38 with or without an additional cover. In another example merely the openings within a loudspeaker grille 38 may be additionally covered. A loudspeaker cover 76 may comprise, for example, open pore foam, mesh or fabrics. A loudspeaker cover 76 may protect the loudspeaker 36 from dust and other small particles as well as water drops or spray. A loudspeaker cover 76 may also be exchangeable such that it can be replaced, for example in case of soiling or damage. For this purpose, a loudspeaker cover 76 may for example be partly clamped between a part of the baffle 42 and a part of the loudspeaker 36. For example, an outer edge of a loudspeaker cover 76 may be clamped between the baffle 42 and a loudspeaker grille 38 and/or loudspeaker basket 72. In such case, the outer edge may comprise the same or a different material than the remaining cover 76. There may be a ring of thin, potentially flexible material like, for example TPU or other suitable material, around the foam, mesh or fabrics of the cover. The thin ring may be clamped between the baffle 42 and a loudspeaker grille 38 and/or loudspeaker basket 72 or any other part of loudspeaker 36 that would otherwise adjoin the baffle 42. In this way, a loudspeaker cover 76 may be removably attached to an assembly of a loudspeaker 36 and a baffle 42. The previously described thin ring of a loudspeaker cover 76 or other parts of a loudspeaker cover 76 may additionally or alternatively be glued to a part of loudspeaker 36, for example grille 38 and/or loudspeaker basket 72 and/or part of baffle 42. For example, an adhesive tape, adhesive film or adhesive coating may be applied, attached or collocated to one or both sides of the loudspeaker cover 76, for example on a thin ring on an outer edge of loudspeaker cover 76 or on any other surface on loudspeaker cover 76, to attach loudspeaker cover 76 to a part of a loudspeaker 36, for example a grille 38 and/or loudspeaker basket 72 and/or part of a baffle 42. Alternatively or additionally, an adhesive tape, adhesive film or adhesive coating may be applied, attached or collocated to a part of loudspeaker 36, for example grille 38 and/or loudspeaker basket 72 and/or part of a baffle 42. In any such case, a protective cover provided on top of the adhesive tape, adhesive film or adhesive coating may be removable by a user before gluing the loudspeaker cover 76 to part of a loudspeaker 36 or a baffle 42. In this way, a user can replace a loudspeaker cover 76 with a provided spare part as may be required after some time of use of the loudspeaker 36. A loudspeaker cover 76 may comprise multiple layers, for example a mesh layer and a foam or fabric layer. In a specific case, a mesh layer may primarily provide mechanical protection while a foam or fabric layer may provide protection against water and dust. A mesh layer on top of a loudspeaker grille 38 may also keep any additional flexible layer, like a foam layer, from entering openings in the loudspeaker grille 38. Multiple layers of a loudspeaker cover 76 may be attached in the previously described ways to parts of a loudspeaker 36 or baffle 42. In one example, a foam layer is attached to baffle 42 while a mesh layer is attached to loudspeaker 36. Previously described attachment of loudspeaker cover 76 by means of some kind of adhesive may in some cases ease attachment of loudspeaker 36 to baffle 42. For example, in cases, where a loudspeaker 36 shall be attached to a baffle 42 by means of press-fit assembly, it may be required to wrap a flexible part of baffle 42 around part of loudspeaker 36. Adhesive attachment of the loudspeaker cover 76 to the baffle 42 or the loudspeaker 36 may in such cases avoid instances where the loudspeaker cover 76 accidentally falls off during attachment of the loudspeaker 36 to the baffle 42. A loudspeaker cover 76 may also be attached to a baffle 42 or loudspeaker 36 by other mechanical means, for example a hook-and-loop fastening mechanism, or by magnetic forces. For the latter, a loudspeaker cover 76 may comprise a permanent magnet and/or a magnetic material while the baffle 42 and/or the loudspeaker 36 comprise a corresponding magnetic material or permanent magnet.

A loudspeaker pocket 8, or more generally, a recess within an inner layer of a helmet, may be utilized to position a loudspeaker 36 approximately flush with the surface level around the recess. It is also possible that considerable parts of a loudspeaker 36 protrude or stick out from a loudspeaker pocket 8 or recess. In some cases, there may be no loudspeaker pocket 8 or recess. In any of such cases, free space between the loudspeaker 36 and the inner layer of the helmet (e.g., the protective layer 2) and between the baffle 42 and the inner layer of the helmet provides rear ventilation by means of sound guide(s) 24 for rear sound of the loudspeaker 36. A loudspeaker pocket 8 or recess merely alters the geometrical shape and geometrical details of the sound guide(s) 24. Because there is no sealed volume on the rear side of the loudspeaker 36, no large air volume is required which saves space. And no air has to be compressed by the loudspeaker 36 which may reduce loudspeaker distortion. Instead, the air within sound guide(s) 24 may represent an acoustic load to the loudspeaker 36, which may reduce the resonance frequency of the loudspeaker 36 compared to the free-air resonance frequency of the loudspeaker 36.

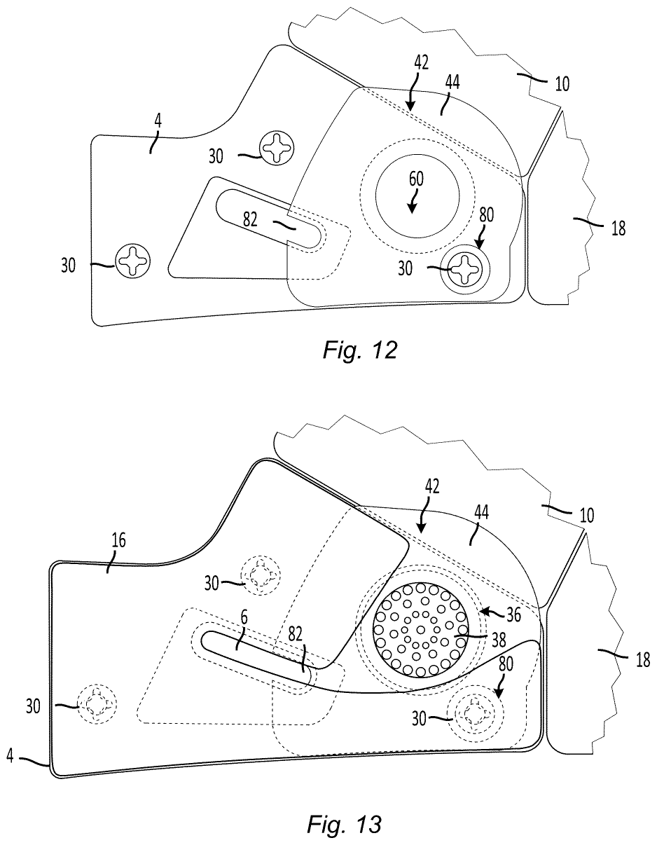

FIGS. 12 and 13 show an example of an alternatively shaped baffle 42, that may according to certain embodiments of the invention be supplied as an aftermarket accessory for helmet loudspeakers and/or helmets or in some cases applied as part of a larger protective structure of a helmet system. Specifically, the interior facing side 44 of the baffle 42 is shown. As such, the structure of the exterior facing side 50 of the baffle 42, such as the separators 54 and sound guides 24 are not shown in the example of FIGS. 12 and 13 since such components are on the opposite side of the baffle 42. Dashed lines are shown to indicate portions of the underlying protective layer components covered by the baffle 42. The baffle 42 of FIGS. 12 and 13 is shaped to accommodate other structural elements of a helmet system (e.g., comprising cut-outs for clip fasteners and chin straps, without further user modification). Specific baffle shapes may be offered to support retrofitting of the baffle 42 in helmets existing on the market.

In FIG. 12, the baffle 42 is shown placed over a protective layer cheek piece 4 and a protective layer temple piece 10. In some examples, intermediate functional pieces or layers may be present between the baffle 42 and the protective layer. The intermediate functional pieces or layers may include plastic materials glued onto or otherwise attached to the protective layer. The intermediate functional pieces or layers may provide additional features as well as attachment components for attaching internal parts of the helmet, like for example an inner cushioning layer, or any accessories, like for example a microphone, to the protective layer cheek piece 4. Thus, when reference is made to attachment between the baffle 42 and the protective layer 2, this may encompass attachment between the baffle 42, intermediate functional pieces or layers, and the protective layer 2.

Free intermediate space on an exterior facing side 50 of the baffle 42, like for example sound guides as shown in FIGS. 8-10 (24, not shown in FIGS. 12-13), serves as a sound propagation path between the baffle 42 and the protective layer 4, 10, or any intermediate functional piece(s) or layer(s). Female receptacles of clip fasteners 30 are shown, which may be used to connect a cushion layer 16 (not shown in FIG. 12, see FIG. 13) to the protective layer cheek piece 4, as previously described. The clip fasteners 30 may be included on the protective layer cheek piece 4 or an intermediate functional layer. A clip opening 80 on the baffle 42 provides a passage for a mating part of the clip fastener 30 provided on a cushion layer 16 to attach the cushion layer 16 through the clip opening 80. In FIG. 12, one side of a clip fastener 30, a female receptacle in this example, is shown basically flush mounted to the surface of the protective layer cheek piece 4. A male part of the clip fastener 30 comprised on a cushion layer 16 is represented by a circular shape in the center of clip fastener 30 in FIG. 13. In the example of FIG. 12, clip opening 80 and chinstrap cut-out 82 are shown in alignment with corresponding elements of the protective layer cheek piece 4. Clip opening 80 may generally be flat relative to the surface of the interior facing side 44 of the baffle 42 such that no additional spacing is formed between the interior facing side 44 of the baffle 42 and a cushion layer 16 (not shown in FIG. 12) discussed with respect to FIG. 13. Chinstrap cut-out 82 may in some cases comprise an alignment feature that allows alignment with at least parts of a chinstrap channel 6 or surrounding recessed area that is part of the chinstrap channel 6. For example, the baffle 42 may comprise a wall section on parts of chinstrap cut-out 82, that protrudes from the exterior facing side 50 of the baffle 42 and is arranged and constructed to align with at least part of a chinstrap channel 6 of a helmet.

FIG. 13 shows an example of a cushion layer 16 applied over the baffle 42. The baffle 42 itself is applied to the protective layer 4, 10 or intermediate functional layer as discussed above. The cushion layer 16 is shown as covering the baffle 42, with the baffle 42 covering protective layer components 4, 10. A chinstrap channel 6 is shown formed into the contour of the cushion layer 16. The chinstrap channel 6 is formed to allow a chinstrap to be placed through each component of the larger protective layer structure. The chinstrap channel 6 is shown in alignment with the chinstrap cut-out 82 of the baffle 42. The clip fastener 30 is shown in FIG. 13 in dashed lines to indicate its positioning under the cushion layer 16. In the given example, the clip fastener 30 comprises a clip fastener with a slotted flexible plate (female part of fastener) located within the protective and/or functional layer of the helmet that allows the insertion of a ball on a rod (male part of fastener) attached to a cushion carrier of the cushion layer 16. Thus, the clip cutout 80 of the baffle 42 allows the cushion layer 16 to be mounted on the protective layer cheek piece 4 without interference by the baffle 42. In some cases, the clip fastener 30 may in this way also attach the baffle 42 between the protective layer and the cushion layer 16 through the clip opening 80. In some cases, the baffle 42 may be attached to the underlying helmet layer (e.g., a protective layer or a functional layer) and/or a loudspeaker 36 within the loudspeaker receiving region of the baffle 42 may be attached to the underlying helmet layer. In other cases, it may be sufficient if the baffle 42 is somewhat clamped between a cushion layer 16 and another underlying layer of the helmet like a functional and/or protective layer 4, 10. So, in some cases the loudspeaker 36 may support the baffle 42 mechanically while in other cases the baffle 42 may support the loudspeaker 36, both with respect to layers of a helmet.

FIGS. 14A-14C show exemplary details of a baffle 42 as shown in FIGS. 12 and 13. The exterior facing side 50 is shown in FIGS. 14A and 14B. The perimeter of the baffle is defined by its outer edge 46. Compared to the baffle 42 of FIGS. 7 to 9, the outer edge 46 of the baffle 42 of FIGS. 14A-14C is shown to accommodate features of a protective layer cheek piece 4 as shown in FIGS. 12 and 13. An inner edge 56 of the baffle 42 surrounds opening 48 and defines the perimeter of a loudspeaker receiving region 60. The baffle 42 comprises the same loudspeaker receiving region 60 as the baffle 42 with loudspeaker receiving region 60 in FIGS. 8A-8D but generally allows for the same alternative implementations as previously described with respect to the inner edge 56 and inner rim 58 of baffle 42.

The exterior facing side 50 includes multiple separators 54 arranged such that the cross-section area of each canal-shaped sound guide 24 and thereby also a total cross-section area of all sound guides 24 increases essentially continuously or essentially linearly with increasing distance from the loudspeaker receiving region 60 When the baffle 42 is placed against a layer of a helmet (e.g. a protective or functional layer), the separators 54 will align with the helmet layer to form generally tubular structures between the baffle 42 and the helmet layer. These tubular structures may exhibit varying tube resonances according to the configurations of the sound guides 24 and separators 54 and specifically according to the length of respective canal-shaped sound guides 24. Tubular structures with different lengths resulting from sound guides 24 with different lengths will also exhibit different resonance frequencies. A superposition of acoustic tube resonances with different frequencies may reduce unwanted peaks and dips in the frequency response of loudspeaker 36. Thus, the sound guides 24 and separators 54 may be designed to provide specific resonant frequencies that vary over a range of at least +/−5% or at least +/−10% of an average resonance frequency of all tubular structures based on sound guides 24. When confined between baffle 42 and an abutting helmet layer, air within sound guides 24 will mass-load the loudspeaker 36, which may lower the resonance frequency and/or resonance quality factor of the loudspeaker 36 when the loudspeaker 36 is mounted within a helmet with a baffle 42 compared to when the loudspeaker 36 is mounted to the helmet without the baffle 42.

The outer edge 46 of the exemplary baffle 42 shown in FIGS. 14A-14B is shaped to conform with and to be integrated into a protective and cushion layer configuration of a helmet, as shown in and described with respect to FIGS. 12 and 13. Within the perimeter defined by outer edge 46 the baffle 42 includes a clip opening 80 and a chinstrap cut-out 82. The clip opening 80 is shown as circular and the chinstrap cut-out 82 is shown as a recess in the perimeter of the baffle 42 having an oblong shape, however any shape may be used for either of the clip opening 80 or the chinstrap cut-out 82. The chinstrap cut-out 82 may alternatively be located within the perimeter of the baffle 42 instead of altering the perimeter shape. In some applications, the clip opening 80 may allow for feeding through an attachment component, like a male part of a clip fastener, between two layers of a helmet that abut the baffle 42 from two respective sides. While this mainly allows existing clip fasteners of a helmet to function in combination with a retrofitted baffle 42, such clip fasteners may also provide mechanical attachment of the baffle 42 to at least one layer of a helmet. The clip opening 80 may also be configured for directly receiving a clip fastener or similar mechanical attachment component to hold the baffle 42 in place internal to a helmet. In case the clip opening is close to the loudspeaker receiving region 60, the clip opening 80 may be configured to provide some kind of sealing with at least one layer of a helmet to avoid an acoustical short-cut for rear sound towards an interior facing side 44 of the baffle 42 (FIG. 14C). This may be achieved by just the right material thickness to allow a clip fastener to press a region of the baffle 42 surrounding the clip opening 80 against a layer of the helmet. There may also be some kind of sealing like a rubber or foam ring around the clip opening 80. Another option is to glue a region of the baffle 42 surrounding the clip opening 80 onto a layer of the helmet. For this purpose, there may be, for example, a ring of adhesive film provided around the clip opening 80. The chinstrap cut-out 82 may similarly be configured for receiving at least a portion of a chin band (shown in FIG. 1B) of a helmet.

FIG. 14C shows an example of an interior facing side 44 of baffle 42 according to certain embodiments of this disclosure. The interior facing side 44 of the baffle 42 faces towards an interior of the helmet when the baffle 42 is installed in a helmet or towards a head or ear of a user wearing the helmet. Similar to the interior facing side 44 shown and described with respect to FIG. 8C, the interior facing side 44 is shown as having a smooth surface relative to the exterior facing side 50 because it lacks separators 54 and the associated sound guides 24. The example interior facing side 44 of FIG. 14C, may similarly be representative of the interior facing sides 44 of baffles 42 according to the examples of FIGS. 14A-14B, 15A-15B, 16A-16B, 17A-17B, 18A-18B, and 19A-19B.

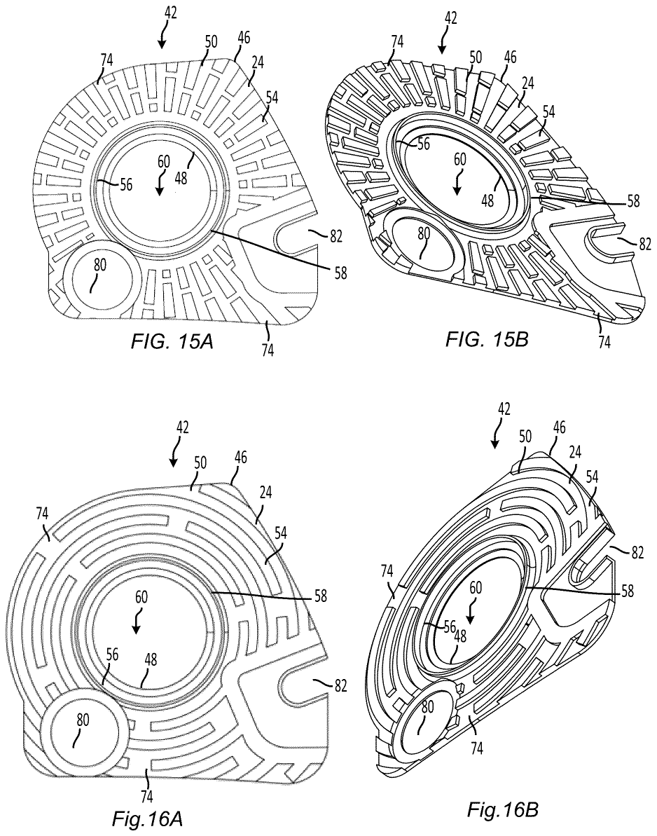

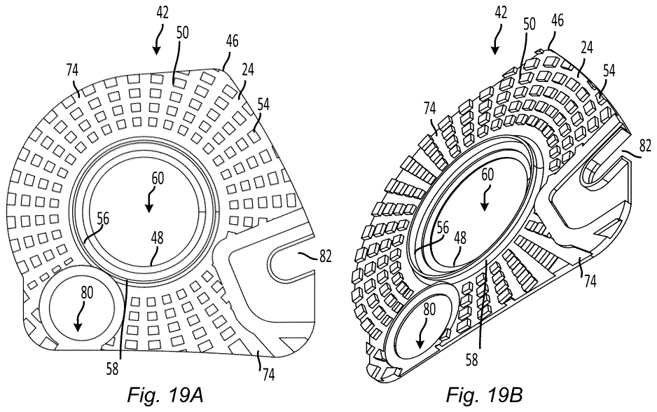

FIGS. 15A-15B, 16A-16B, 17A-17B, 18A-18B, and 19A-19B each show alternate examples of an exterior facing side 50 of a baffle 42 according to certain embodiments of this disclosure. As can be seen, the separator 54 designs may take on different shapes and sizes, with the size and shape of each separator 54 forming uniquely shaped sound guides 24. Different separator structures forming different sound guide shapes may affect the acoustic qualities of the baffle. For instance, separators 54 forming smaller sound guides 24 as in FIGS. 17A-17B may provide for shifting resonance frequencies within the sound guides. Similarly, separator 54 shape may also affect acoustic qualities of the baffle. Separators 54 forming a multitude of sharp corners and edges, for instance by square, rectangular, and trapezoidal shapes (as in FIGS. 19A-19B), may be applied to damp high frequency sound components and resonances by diffusely reflecting and diffracting acoustic waves traveling through the sound guides. Moreover, intermittent sound guide 24 designs forming a baffle with intermittent and/or irregular patterns (as in FIGS. 15A-15B), may similarly be used to reduce tube resonances. By providing abrupt changes in the sound guide width in the form of intermittent sound guides 24, the baffle 42 may produce multiple tube resonances at different frequencies which are then superimposed at the sound outlet(s) 74 of the sound guides 24, thereby reducing sharp resonant peaks. Shorter sound guide sections may move resonances to higher frequencies where the resonances are less intrusive. Separators 54 and sound guides 24 may be shaped and arranged such that the sound guides 24 are distributed around angular subsections of the loudspeaker receiving region 60. In some examples, a multitude of sound guides 24 are distributed around the loudspeaker receiving region 60 over an angular range of more than 90°, more than 180° or up to more than 270°.

FIGS. 15A-15B show an example of the baffle 42 with an alternative configuration of its exterior facing side 50. In the example of FIGS. 15A-15B, multiple separators 54 are shown having longer and shorter roughly rectangular shapes with surface sections arranged to form a multitude of small sound guides 24 (as compared to those shown in the embodiment of FIGS. 14A-14B) within the free intermediate space that extend in radial directions relative to a center of the loudspeaker receiving region 60 with a multitude of intersections extending in circular direction. The separators 54 are also shaped and arranged such that the sound guides 24 have varying widths and lengths and sound guides 24 are intermitted by interconnections to neighboring sound guides 24 at different positions with respect to the length of neighboring sound guides 24. As a result, standing waves that develop in tubular structures will be distributed over multiple frequencies corresponding to various lengths of sound guide segments. Tubular sections may result from sound guides 24 when the exterior facing side 50 of the baffle 42 abuts an approximately even surface of an abutting element, such as a protective layer or intermediate functional layer of a helmet.

Depending on the sound guide 24 length, tube resonances may become less intrusive if occurring at sufficiently high frequencies. The fundamental resonance of the sound guides 24 will occur at the frequency for which half a wavelength fits in the tube and may be calculated as f₁=c/2l where f₁ is the fundamental resonance, c is the speed of sound traveling in air, and 1 is the length of the sound guide section. For example, a 2 cm sound guide 24 would exhibit a fundamental resonant frequency of approximately 8.5 kHz. This may be generally audible and require designing specific sound guides 24 to shift the resonant frequency to an inaudible frequency range. For instance, reducing the sound guide length may thereby increase the fundamental resonance beyond audible range. Thus, in some examples, each of the sound guides 24 of a baffle 42 has a length less than 1 cm.

FIGS. 16A-16B show an example of another possible exterior facing side 50 of the baffle 42, where curved separators 54 of various lengths and sizes are shown in addition to sound guides 24 formed between the curved separators 54. Long sound guides 24 may provide an air-load on the rear side of the loudspeaker with resistive losses as acoustic waves travel around the corners of the separators 54. Such designs may shift a free-air resonance frequency of the loudspeaker to a lower frequency and dampen the resonance of acoustic waves traveling through the sound guides 24. Similar shifts of various degrees of the free-air resonance may also occur within the other baffle examples like discussed with respect to FIGS. 15A-15B. The sound outlets 74, i.e., where the sound guides 24 reach the outer edge of the baffle 42, may be defined at varying locations to further configure the sound pressure at each output position. For instance, comparing sound output positions 74 shows that the sound output positions 74 may alternate in a repeating structure with the separators providing roughly equal sound output in all directions of the baffle 42, or alternatively may be defined across a larger perimeter of portions of the baffle directing acoustic waves to provide concentrated output at specified portions of the baffle outer edge 46.

FIGS. 17A-17B show an example of another possible exterior facing side 50 of the baffle 42, where the separators 54 are much smaller but more numerous compared to other embodiments. In addition to damping particular resonance frequencies due to the sound guide 24 design with increasing cross-section area over increasing distance from the center of the loudspeaker receiving region 60, the shape of the separators 54 may contribute to the rigidity or flexibility of the baffle 42. For instance, smaller distance between separators 54 as in FIGS. 17A-17B, may allow for lower wall thickness and potentially greater flexibility of the baffle 42. Especially in cases where the separators 54 are attached to an inner layer of a helmet with a suitable method, they provide stability to a thin and otherwise easily deformable baffle 42. A certain rigidity of the installed baffle 42 is required in order to sufficiently separate sound fields on both sides of the baffle 42. Thin baffles 42 can be integrated into space constraint helmets. High flexibility allows good alignment with curved surfaces inside a helmet. Variations in distance between separators 54 can further adapt the flexibility of the baffle 42 at specific positions or areas. In this way, flexibility may be tailored at specific areas of the baffle 42 to meet alignment or bending requirements at corresponding positions withing a given helmet shape. Alternatively, or additionally, the thickness of the baffle 42 within the sections between separators 54 may vary in order to adapt flexibility of specific areas of the baffle 42.

FIGS. 18A-18B show an example of another possible exterior facing side 50 of the baffle 42, where round, elliptic and oval separators 54 and relatively larger sound guides 24 are formed between the separators 54. Fewer separators 54, comparatively to FIGS. 17A-17B, may require the baffle 42 to be relatively more rigid or with greater thickness to ensure formation of the sound guides 24 when the baffle 42 is applied against a protective layer 2 of a helmet. Greater distance between rounded separators result in sound guides having cross-section areas that increase approximately continuously with increasing distance from the mounting ring of the baffle 42. The lack of distinct tubular structures helps to avoid or reduce resonances in the sound guide structure. Without distinct sound canals in the sound guide 24, there may be less control regarding sound output positions 74. It is, however, possible to add structural sound barriers to the baffle 42 that reduce sound output at unfavorable positions.

FIGS. 19A-19B show an example of another possible exterior facing side 50 of the baffle 42, where smaller, roughly square separators 54 are arranged on the baffle 42 instead of the longer separators according to the examples of FIGS. 14A-14C and 15A-15B. Arrangement of separators 54 on radial lines still results in intermittent tubular structures. Stepwise variation in cross-section area may provide damping of resonances within the tubular structures. Corners and edges provided by the square shape of the separators 54 also help against high frequency resonances as sound is heavily reflected and diffracted.

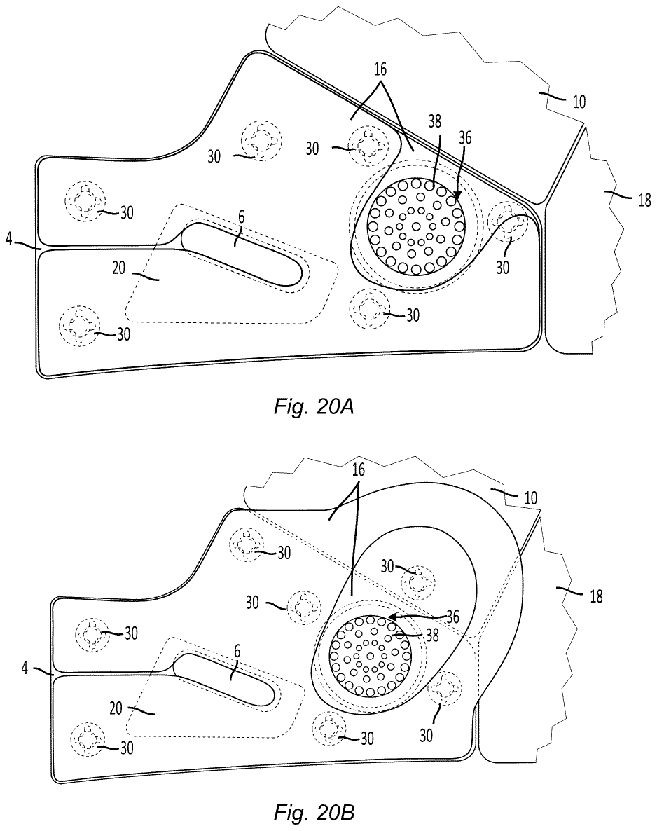

As another embodiment of the invention, FIGS. 20A-20B provide examples of a cushion layer 16 (e.g., as introduced in FIG. 1B) comprising a cushion carrier, where the cushion carrier may function as a baffle. Generally, helmets may comprise multiple cushion layers at different positions within the helmet. In the examples of FIG. 20, the cushion layer 16 specifically refers to an assembly of multiple elements (at least cushion carrier/baffle and padding) that is located or prepared to be installed in a region on either side of a helmet that at least extends in the vicinity of an ear of a wearer of the helmet. A cushion layer 16 in this sense may be an integral part of a helmet as delivered to end customers. It may also be an accessory or replacement part that can be retrofitted to an existing helmet. A loudspeaker 36 may be attached to the cushion layer 16 or means for attachment of a loudspeaker 36 may be provided on the cushion layer 16 or more specifically the cushion carrier of the cushion layer 16. A cushion layer 16 including or attached to a loudspeaker 36 may likewise be an accessory or replacement part for retrofitting to existing helmets or part of the original assembly or scope of delivery of a helmet. In the example of FIG. 20A, the cushion layer 16 is restricted to the exemplary outline of the protective layer cheek piece 4. As a result, the distance between the loudspeaker 36 and the end of the cushion layer 16 comprising the cushion carrier that at the same time functions as a baffle, is small in the area where the loudspeaker 36 is close to the outer edge of the protective layer cheek piece 4. To minimize leakage of rear sound too close to the loudspeaker 36, there may be some sealing along the edge on the protective layer cheek piece 4 that is close to the loudspeaker 36. Sealing may merely comprise tight fitting between protective layer and baffle or some dedicated sealing material like foam or rubber. Alternatively, the baffle may protrude over adjacent protective layer components (e.g., 10, 18).

Cushion layers 16 are generally often attached to a protective layer (2 in FIGS. 1, 4, 10, 18 in FIG. 20) or an intermediate functional layer by means of clip fasteners 30. For the integration of clip fasteners 30 to a cushion layer 16, a cushion carrier may be utilized as integral part of the cushion layer 16. Such a cushion carrier may comprise a layer of, for instance, thin plastic material to which the actual cushioning material or padding is attached. The cushion layer 16 may for example comprise a padding with a suitable soft foam and some kind of cover. The padding may be arranged on an interior facing side of the cushion carrier that is oriented towards the head of a wearer of the helmet. On an opposite side (exterior facing side), the cushion carrier may comprise male parts of clip fasteners 30 that fit into female clip fastener 30 parts in the protective layer. In this way, the cushion layer 16 can be attached to the protective layer by means of clip fasteners 30 on the cushion carrier.

Baffles with specific shape for a given helmet have been discussed before, for example as an intermediate, functional layer between a cushion layer 16 and a protective layer 2. An alternative option as shown in the embodiments illustrated by FIGS. 20 A and 20B, is the use of the baffle as a cushion carrier. This means that the padding of the cushion layer 16 may be arranged on one side of the baffle/cushion carrier that is oriented towards the head of a user of the helmet (an interior facing side). The opposite side of the baffle/cushion carrier (exterior facing side) may comprise male parts of clip fasteners that fit into female clip fastener parts in the protective layer 2 or any intermediate functional layer that may cover the protective layer 2. In this way the baffle/cushion carrier can be attached to protective layer 2. Other attachment methods may also be used like, for example, screwing, gluing, snaps or hook-and-loop fasteners. Positions of clip fasteners 30 in FIG. 20 are exemplary illustrations of the general concept. While these fasteners may be replaced by other suitable fastening methods or systems, also their positions(s) may vary. In both FIG. 20, some clip fasteners 30 are arranged around the region of loudspeaker 36. This may provide mechanical tension and/or force to press the cushion carrier/baffle against parts of the loudspeaker 36 or an intermediate sealing component. In FIGS. 20A-20B, the baffle is integrated to the cushion layer 16 as a cushion carrier like previously described. In FIG. 20A the cushion layer 16 covers protective layer cheek piece 4 almost completely. In the region directly around loudspeaker 36 only the cushion carrier is present that serves as a baffle which separates frontal sound from rear sound of the loudspeaker 36 as previously described (e.g., with regard to FIG. 3B). The padding of cushion layer 16 extends in an approximately u-shape around a lower part of the region of the loudspeaker 36. The padding of the cushion layer 16 may be supported by the cushion carrier/baffle at least in the vicinity of mechanic fasteners like clip fasteners 30 or alternative attachment points. Below the padding, the cushion carrier/baffle may comprise a closed surface or comprise a variety of one or more openings. There may be openings within the cushion carrier/baffle that function as sound outlets like for example the sound outlets 74 in FIGS. 4B and 5B or sound outlets 74 in FIG. 10C. Such sound outlets may be located below the padding and release sound into the padding layer. Alternatively sound outlets may be positioned on surface sections of the cushion carrier/baffle that are not covered by padding. Similar to, for example, FIG. 6B and FIG. 10, there may be a slit between the cushion carrier/baffle and an underlying helmet layer (e.g. protective layer 2) that serves as sound outlet 74.

In FIGS. 20A and 20B, the cushion layer 16 is arranged around chinstrap channel 6 of protective layer cheek piece 4 with a slot extending up to the frontal edge of protective layer cheek piece 4 (front direction with respect to a helmet is towards the left in FIG. 20). This slot allows easy assembly of the cushion layer 16 around a chin strap (e.g., 14 in FIG. 1B) that may be present in a helmet. In order to provide a closed surface of the cushion carrier in the vicinity of loudspeaker 36 that supports the baffle function as previously described, the slot extends towards the front rather than the back (compare to FIG. 13 where the slot extends towards the back). Between the protective layer 2 or any intermediate functional layer on protective layer 2 and the cushion carrier (baffle) of the cushion layer 16, at least one sound guide or, more general, at least one ventilation slot or ventilation gap may be provided as described in combination with preceding figures (e.g., FIGS. 3-6, 10 and 12-19) with regard to different baffles. Between the cushion carrier (baffle) and the loudspeaker 36 some kind of seal, e.g., foam or rubber, may be arranged that avoids excessive sound leakage from the rear side of the loudspeaker 36 to the front side. Slight mechanical tension, for example provided by clip fasteners 30, may ensure that the sealing is in good contact with loudspeaker 36 and the cushion carrier/baffle. Alternatively, the loudspeaker 36 may be attached to the cushion carrier/baffle and thereby to the cushion layer 16, in any suitable way. Potential attachment methods have been discussed, for example with reference to FIG. 11.

No sound guides or separators are shown in FIGS. 20A and 20B as these are located between the cushion layer 16 including the padding as well as cushion carrier/baffle and the underlying helmet layer (e.g., protective layer cheek piece 4) and therefore not exposed in this view. Sound guide(s) may be implemented in various ways as previously described for various baffles. There may be sound guide(s) and/or separators on the cushion carrier/baffle, on the protective layer, or both.

Sound outlets for rear ventilation may be arranged on the edge of the cushion carrier/baffle and potentially also an edge of the protective layer (e.g., an edge of protective layer cheek piece 4) or anywhere on the surface of the cushion carrier/baffle. Rear sound may be ventilated into open-pore foam utilized as padding of the cushion layer 16. In that regard, the baffle serving as cushion carrier (or vice versa) may not comprise a closed surface but may include multiple openings or through holes that allow rear sound to penetrate the foam material of the cushion layer 16.

FIG. 20B shows another format for the structure of a cushion layer 16 as it would be placed over an underlying layer of a helmet like a protective layer (2 in FIGS. 1A and 1C, 4, 10, 18 in FIG. 20). In some cases, it may be desired to create a sealed frontal chamber around the ear that is coupled to one side of a loudspeaker 36. This allows higher maximum sound pressure level from a given loudspeaker than an open configuration without sealed frontal chamber around the ear. A sealed frontal chamber around the ear may allow use of relatively small and lightweight loudspeakers for music playback. It may also be of particular interest for active noise cancellation (ANC) because noise levels in helmets can reach up to 120 dB SPL which can be challenging to generate with a reasonably sized loudspeaker. This is especially the case for low frequencies, for example below 100 Hz or below 50 Hz. A sealed frontal chamber around the ear may be created with a portion of the cushion layer 16 that encircles the ear completely without gaps. This means that the cushion layer 16 surrounds the ear over an angular range of 360° within at least one plane that is approximately parallel to the median plane of a person wearing the helmet.

As previously described, a baffle in the form of a cushion carrier may carry the cushion layer 16 and provide mechanical support for the cushion and especially a padding layer providing the cushioning function of the cushion layer within the helmet. In combination with either a protective layer (2 in FIGS. 1A and 1C, 4, 10, 18 in FIG. 20) or an intermediate functional layer or both, the cushion carrier/baffle may also provide rear ventilation for the loudspeaker 36 as previously described. Thereby it is avoided that the loudspeaker 36 has to compress a small nonlinear air volume within a closed rear chamber.

Generally, sealing of the frontal chamber around the ear may be achieved with a soft, compressible cushion material as a padding of the cushion carrier/baffle of cushion layer 16. For example, open-pore or closed-pore foam are both suitable. Open-pore foam is more compressible than closed-pore foam and thus can adapt better to various head shapes than closed-pore foam. Especially open-pore foam may be covered at least partly with an air-tight or semi air-tight material, like for example faux leather, to increase the degree of sealing provided by the cushion. Faux leather may, for example, be applied to an inner side of the cushion layer 16 or the padding of cushion layer 16 that is oriented towards the ear of a wearer. In other cases, sealing may not be the highest priority. Air-tight materials like faux leather may reflect high frequency sound and can therefore cause resonance and cancellation effects around the ear. As a result, the high-frequency transfer function from the loudspeaker may vary excessively towards different positions within the frontal chamber around the ear. To avoid or reduce such effects, open-pore foam arranged around the ear may be covered with acoustically permeable material. In this way the foam and potentially also the cover material may provide damping of high frequency sound to reduce reflections.

The cushion layer 16 may also comprise a combination of foam materials with different degree of hardness. For example, a foam ring with approximately round or oval shape made of foam with low hardness may be arranged around the region of the loudspeaker 36 and therefore around the ear for high compressibility and therefore good sealing. This ring may be arranged directly on the cushion carrier/baffle or with a layer of foam with higher hardness in between the cushion carrier/baffle and the foam ring. A cushion comprising multiple foam layers may be partly or completely covered with one or more suitable fabrics.

It shall be noted that a cushion layer 16 which is shaped and arranged to provide a sealed frontal chamber around the ear, may also be constructed with a cushion carrier that is separate from an independent baffle, for example a baffle like previously discussed as baffle 42 with regard to FIGS. 12-19. In such a case, the baffle may be arranged between cushion carrier and protective layer or any intermediate functional layer like previously described (e.g., with respect to FIG. 13). To provide good sealing of the frontal chamber around the ear, there may be an additional seal between the cushion carrier and the baffle. Rubber, foam rubber or other foam materials may be utilized, for example.

A potential problem of a sealed frontal chamber around the ear is passive damping of sound from outside the helmet. While this may be an advantage at low frequencies, where wind noise reaches the highest sound pressure levels, it can become dangerous at medium to high frequencies. For example, if the wearer of the helmet cannot hear surrounding traffic. Therefore, it may not be desired to create complete sealing of the ear. Instead, it may be preferred to have controlled ventilation of the frontal chamber around the ear in order to allow ambient sound of medium to high frequency to reach the ear.

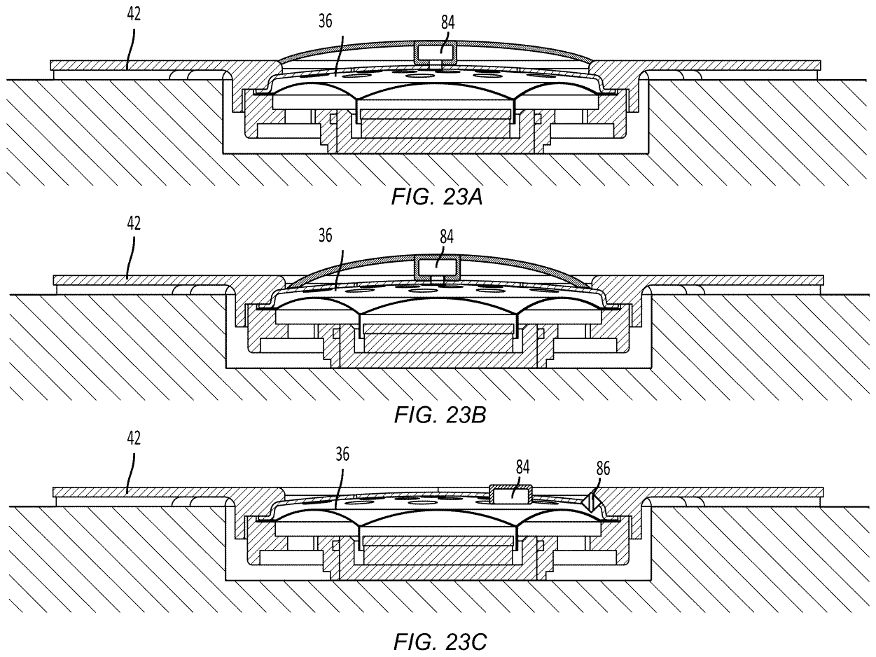

Furthermore, it may be desired to achieve low variation in acoustic transfer function from the loudspeaker 36 to the ear of users with different head size and shape. Sealing provided by a cushion layer 16 depends on the compression applied to the padding of the cushion layer 16 and the aforementioned transfer function changes drastically with the degree of sealing. Within a given helmet, wide heads may result in better sealing than narrow heads. Variation in loudspeaker to ear transfer function and also in the transfer function from the loudspeaker 36 to a microphone (e.g. 84 in FIG. 23) within the frontal chamber around the ear may be problematic. On one hand, bass levels delivered to different wearers may change drastically, requiring specific compensation, for example by means of equalization in signal processing. On the other hand, variations in the transfer function from the loudspeaker to the ear and to a microphone utilized for ANC (active noise compensation) can adversely affect ANC performance. In order to reduce these transfer function variations for different head sizes, controlled ventilation of the frontal chamber around the ear can provide a limit for the degree of sealing that can be achieved. A combination of a cushion with good sealing performance over a large range of head-sizes with controlled ventilation of the frontal chamber around the ear can provide more stable transfer functions from the loudspeaker 36 to the ear and to an ANC microphone 84 than a cushion alone. Basically, the cushion layer 16 provides a minimum level of sealing for all expected head-variations and the controlled ventilation limits sealing to, for example, a lower degree than the minimum degree of sealing without ventilation. For ANC applications low variation of transfer functions is mainly important over a lower frequency range. For example, below 2 kHz or below 1 kHz. And this is also the frequency range which is most affected by sealing variations.

Another reason to add controlled ventilation to an otherwise sealed frontal chamber around the ear is to provide pressure equalization for both respective sides of a loudspeaker membrane or diaphragm. Typical headphone speakers, as often used in helmets, comprise thin diaphragms of, for example, polyethylene terephthalate (PET) or polyether ether ketone (PEEK) material. Such diaphragms are easily deformed by pressure differences on both respective sides. Pressure differences within a helmet may arise from driving wind or headwind. Wind may enter an open front of the helmet, leak through insufficient sealing against wind or simply pass through ventilation openings in the helmet. Once wind entered a helmet, relative sound pressure between mechanically separate sections of the helmet may vary. Deformation of the loudspeaker diaphragm can cause acoustic noises and even damage to the diaphragm due to wrinkling. It may be an important factor to avoid such issues in specific helmets.

Besides acoustic effects and protection of the loudspeaker, ventilation of the ear is also desirable to keep ear temperatures within a comfortable range. This may also be supported by ventilation of a frontal chamber around the ear.

Generally, it is advantageous to ventilate the frontal chamber around the ear into surrounding space within the helmet (e.g. interior space 15 in FIG. 1) and in most cases within the same volume that comprises the head. In many cases this means on the interior facing side of a protective layer (2 in FIG. 1) or on the interior facing side of a functional layer covering the protective layer. At least for closed face helmets comprising a visor in front of the face, the inside or interior space is protected against strong wind, humidity, salt spray and similar environmental threats. And even open helmets may comprise areas that are well protected against environmental influences, especially above or behind the head or on the sides of the head behind the ears.

Different minimum levels of ventilation may be required to achieve audibility of ambient sound, stabilization of transfer functions and thermal ventilation of the ear. For audibility of ambient sound, required cross-section area for ventilation is minimal while stabilization of acoustic transfer functions within the frontal chamber and especially thermal ventilation require higher passage areas. The acoustic transfer function for ambient sound from outside of the frontal chamber to the inside depends on the volume inside the chamber, high frequency damping of boundary materials of the frontal chamber as well as the cross-section area and length of a front ventilation opening, front ventilation canal or duct from the outside to the inside. Required ventilation cross section area for stabilization of acoustic transfer functions from the loudspeaker 36 depends on the expected leakage range for different head sizes. Most effective stabilization may be achieved with higher low-frequency sound transfer through ventilation than through the cushion layer 16. Pressure equalization for the respective sides of a loudspeaker membrane coupled to the frontal chamber around the ear depends on the maximum pressure differences caused by wind without pressure equalization. A well-sealed helmet may require either low or no pressure equalization. In contrast an open helmet may require very high ventilation of the frontal chamber around the ear. For example, cross-section area for frontal chamber ventilation may be comparable to the cross-section area of rear speaker ventilation.

For pressure equalization it can be beneficial to have ventilation openings next to front ventilation canal openings or sound outputs for the rear side of the loudspeaker. In this way both openings receive the same wind pressure and thus the pressure equalization may be further improved. This is especially the case if such openings are exposed to some levels of wind inside the helmet.

In order to implement various requirements for ventilation of the frontal chamber around the ear as previously described, front ventilation canals, guides or tubes may be integrated to the baffle (e.g. cushion carrier of cushion layer 16) in similar ways as described before with respect to the exterior facing side 50 of baffles 42. The exterior facing side of a baffle/cushion carrier may be in contact to the protective layer or intermediate functional layer of the helmet at specific areas that form separators for separation of sound canals or sound guides. Such separators may provide separation for sound canal or sound guides for ventilation of the rear side of a loudspeaker 36 and separately for the frontal chamber ventilation. Mentioned separators may be an integral part of the protective layer 2 or any functional layer of the helmet, of the baffle/cushion carrier, or both. Separators may also be provided by a separate part between the protective or functional layer and baffle/cushion carrier. Openings in the baffle/cushion carrier may allow frontal sound within the frontal chamber around the ear to enter a sound guide on the exterior facing side of the baffle/cushion carrier.

Front ventilation canals, guides or tubes for different ventilation functions (front or rear side ventilation) may be integrated to the helmet in the described way. Intake of medium to high frequency ambient sound may require short front ventilation canals with low cross section area. Short canal structures reduce high-frequency attenuation by acoustic low-pass function. Stabilization of acoustic transfer functions, thermal ventilation and pressure equalization may require larger cross section area. In case mid or high frequencies shall not be transferred into the frontal chamber around the ear, long front ventilation canals or sound guides may be used.

As previously described, a cushion layer 16 which provides a sealed frontal chamber around the ear, may also be constructed with a cushion carrier that is separate from any baffle (e.g., 42). In such a case, a baffle 42 may be arranged between a cushion carrier and a protective or functional layer of the helmet like previously described. Front ventilation canals or guides for frontal chamber ventilation may alternatively or additionally be integrated to the interior facing side 44 of the baffle 42 facing the cushion carrier instead of the exterior facing side 50. Similar to sound canals or guides between a baffle 42 and a protective layer or functional layer on a protective layer, sound guides between the baffle 42 and a cushion carrier may comprise geometric structures in either one of the baffle 42 and the cushion carrier that provide free intermediate space for controlled ventilation.

FIGS. 21, 22A and 22B show an alternate example of a baffle 42 comprising multiple loudspeakers 36 according to certain embodiments. FIG. 21 shows a top-down perspective view of an interior facing side of baffle 42 with multiple loudspeakers 36 aligned with respective openings between the interior facing side and an exterior facing side (not shown) of the baffle 42. FIGS. 22A-22B provide profile views of the baffle 42. In FIGS. 21, 22A and 22B, the baffle 42 is shown mounted against multiple loudspeakers 36 and a protective layer 2. Particularly for helmets without a loudspeaker pocket (8 in FIG. 1), thin or slim transducer assemblies may be required due to space constraints. Such assemblies may benefit from multiple small loudspeakers 36 instead of a single large loudspeaker. Thus, in the examples of FIGS. 21, 22A-22B, the baffle 42 can include multiple loudspeaker receiving regions 60 each capable of receiving a loudspeaker 36 and allowing first acoustic waves to leave the front face of the loudspeaker 36 while requiring second acoustic waves exiting the rear face of the loudspeaker to travel through sound guides 24 and through sound outlets 74 prior to colliding with the first acoustic waves. In the profile view of FIGS. 22A-22B separators 54, providing the spacing forming the sound guides 24, are shown behind a fluid path connecting sound guides 24 to the sound outlets 74 (e.g., as in the example of FIGS. 19A-19B). Additionally, as shown in FIG. 22B, the baffle 42, when made of a flexible material, may adapt to surfaces of a curved protective layer 2. Alternatively, a stiff baffle 42 may comprise a curved shape for placement against curved protective layers 2.

In some embodiments, a transducer arrangement comprising a loudspeaker within a baffle or a transducer arrangement within a helmet may be part of an Active Noise Cancellation (ANC) system. The ANC system may further include one or more microphones mechanically and/or acoustically coupled to the transducer arrangement. As receiving acoustic transducers, such microphones may become an integral part of a larger transducer arrangement comprising at least one microphone and at least one loudspeaker (radiating acoustic transducer) within any of the baffle configurations previously described. For instance, any combination of the microphone configurations discussed with respect to FIGS. 23A-23C may be applied as part of the ANC system and/or larger transducer arrangement for operation with the loudspeaker and baffle.

FIGS. 23A-23C show examples of various microphone configurations within the transducer arrangement according to certain embodiments of the disclosure in cross-sectional views. The baffle 42 in FIG. 23 is merely an example and may generally be similar to or the same as any of the baffles 42, discussed with respect to the preceding figures and applied to a loudspeaker 36 and/or within a helmet in similar ways as discussed before. Baffle 42 may also be implemented in the form of a functional layer 28 as described with reference to FIGS. 3B, 4B, 5B and 6B or integrated to a cushion layer 16 as discussed with regard to FIG. 20. The orientation and position of the microphone 84 can have an influence on the performance of ANC applications. Beneficial microphone placement and orientation relative to loudspeaker 36 depend on the acoustic situation within the helmet. Any distance between the acoustic input of a microphone 84 (the opening on the bottom side of schematically illustrated microphones 84 in FIG. 23 represents the acoustic input) and the loudspeaker 36 generally adds delay to the loudspeaker signal with reference to the microphone 84. This will reduce the upper frequency limit for feedback ANC because the open-loop transfer function of a feedback ANC system including the loudspeaker 36 and the microphone 84 has to cross the zero-gain threshold at a lower frequency in order to keep the closed feedback loop stable. In that regard it is preferable to have the acoustic input of the microphone 84 as close to the membrane or diaphragm of the loudspeaker 36 as possible without both getting in contact during operation. In order to minimize loudspeaker 36 to microphone 84 distance, the acoustic opening of the microphone 84 can be orientated towards the loudspeaker 36 and/or towards the sound generating element (e.g. membrane or diaphragm) of loudspeaker 36. This is the case in all FIG. 23. In addition, the microphone 84 may be placed centrally over the diaphragm of the loudspeaker 23 like in FIGS. 23A and 23B. In case there is no sealed frontal chamber around the ear which includes the microphone 84 and is coupled to the loudspeaker 36, or in case such frontal chamber has controlled ventilation, differences in sound pressure and phase of the loudspeaker signal will occur between the close vicinity of the loudspeaker 36 and the more distant ear of a wearer. As a result, an ANC feedback loop including the loudspeaker 36 and a microphone 84 placed in direct vicinity of the loudspeaker membrane may provide high noise reduction at the microphone position but less noise reduction at the ear position. In such cases, it can be preferable to position the microphone 84 with an offset to the center of the loudspeaker 36 or in higher distance than required for clearing of the movement of the diaphragm. This is illustrated in the example of FIG. 23C, where microphone 84 is positioned with an offset from the center of the diaphragm. In addition, the acoustic input of the microphone may not be facing the loudspeaker 36 or the diaphragm of the loudspeaker 36 but may be rotated by, for example, 90° or 180°. With 180° rotation compared to FIG. 23, the acoustic input of the microphone faces away from the loudspeaker 36 and towards an interior space of the helmet and/or towards the ear of a wearer.

Because of the rear ventilation provided by the baffle configuration (e.g., sound guides between baffle and underlying helmet layer), the microphone 84 in all FIG. 23 receives frontal sound and rear sound from the loudspeaker 36 which are superimposed at the acoustic input of the microphone 84. The position close to the frontal side of the loudspeaker 36 means that the sound pressure level of frontal sound will typically be higher than the sound pressure level of rear sound. A ratio between the sound pressure level of frontal sound and the sound pressure level of rear sound will vary depending on the location of the microphone 84 relative to the loudspeaker 36 and the baffle 42. In the example of FIG. 23A, the microphone 84 is attached to a curved segment that ends on two sides on the baffle 42. This curved segment supporting the microphone 84 illustrates a case in which the microphone is attached to baffle 42. The curved segment may, for example, be part of a protective grille integrated to the baffle 42 that also holds the microphone 84. In this case no protective grille may be required on the loudspeaker 36. The curved segment may also be some kind of arched element passing over the opening in the loudspeaker receiving region of the baffle 42 between the interior facing side and the exterior facing side of the baffle 42 and supporting the microphone 84 at a desired position relative to the loudspeaker 36. In FIG. 23B, the curved segment holding the microphone 84 ends on the grille of the loudspeaker 36. This illustrates a case where the microphone 84 is attached to the loudspeaker 36 instead of the baffle 42. Finally, FIG. 23C shows a case where the microphone 84 is arranged within the protective grille of the loudspeaker 36 and is mechanically supported by the grille. Additionally, other microphone configurations not shown may be used. Any such microphone configuration may be used to facilitate active noise cancellation.

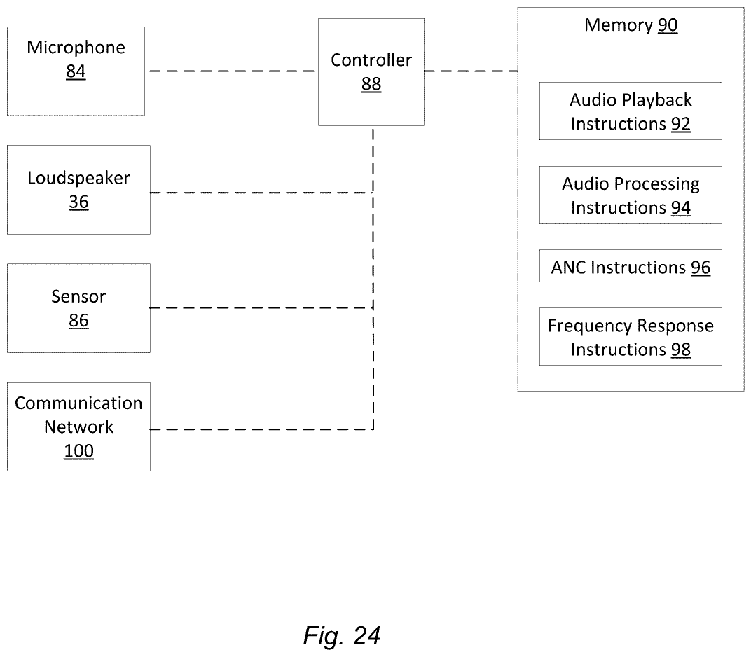

FIG. 23C shows an additional sensor 86 exemplary arranged on the loudspeaker 36 according to certain embodiments of the disclosure. The sensor 86 may be present additionally or alternatively to the microphone 84 according to various embodiments. When present, the sensor 86 may be configured to detect if a baffle 42 has been placed against or attached to the loudspeaker 36 and provide information about an assembly status of the baffle 42 on the loudspeaker 36. For instance, the sensor 86 may communicate such information to a controller 88 (shown in and discussed with respect to FIG. 24), which would control a loudspeaker driving signal to reconfigure the audio output from the loudspeaker 36 to account for changes in the acoustic profile of the loudspeaker 36 owing to the attached baffle 42. Sensors 86 may include capacitive sensors, including microphones, hall sensors, mechanic switches, and electrical contacts bridged by the baffle 42. The sensor 86 may be placed on the baffle 42, the loudspeaker 36, or multiple sensors 86 or multiple elements of a single sensor 86 may be placed on a combination of the baffle 42 and the loudspeaker 36. Alternatively, a microphone, like for example microphones 84, which itself may be understood as a sensor, may be used to measure a transfer function or sound pressure level from the loudspeaker 36 and determine if a baffle 42 is present. Measuring a transfer function or sound pressure level from the loudspeaker 36 may include playback of a suitable test signal like a noise signal, sine waves(s) of one or more fixed or variable frequencies or a music signal, for example a startup jingle or other generated or received music signal, over the loudspeaker 36, recording of a resulting loudspeaker signal with a microphone 84 and analyzing the recorded loudspeaker signal with reference to the test signal. Additionally, or alternatively, a controller 88 may be configured to recognize the baffle 42 or receive information about the baffle 42 per other inputs such as communications received by the controller 88 from a mobile device or personal computer, for example a smartphone. For example, a smartphone may retrieve information from a machine readable visual or geometric feature, for example a quick-response (QR) code on a surface of the baffle 42, the loudspeaker 36 or any related item like, for example, packaging of a baffle 42 and/or loudspeaker 36, that comprises encoded information with regard to the baffle 42. A smartphone or similar mobile device may also retrieve information from a user indicating through a software application executed on the mobile device that a certain baffle 42 and/or loudspeaker 36 is/are installed. Another option for a smartphone or similar device to retrieve information from the loudspeaker 36 or baffle 42 would be a passive near field communication device (e.g., NFC tag or NFC chip) on either of these components. Information about a baffle 42 may include an assembly status of the baffle 42 on a loudspeaker 36, any kind of reference to specific baffle types or related helmets, expected frequency response alterations caused by the baffle 42, parameters defining compensation filters for said frequency response alterations and loudspeaker type(s) related to the baffle 42. Information about a loudspeaker 36 may include acoustic parameters of the specific loudspeaker 36 or a loudspeaker type or model that the loudspeaker 36 belongs to. Such acoustic parameters may include a loudspeaker sensitivity or other aspects of a loudspeaker transfer function. In some cases, information about a loudspeaker 36 may include audio processing parameters or instructions, for example filter parameters for equalizing filters that are suitable to compensate for unwanted aspects of a loudspeaker transfer function. Audio processing parameters or instructions may generally include signal flow information for signal processing and respective parameters for processing elements of an audio processing signal flow or path. Other information may include any kind of reference for specific loudspeaker types or models or related helmets and/or a reference or identifier for the loudspeaker 36 (e.g., type number/reference, model number/reference, production code, part number/reference).

Thus, a controller 88 may be dynamically configured to output modified signals to a loudspeaker 36 in response to a loudspeaker 36 and/or baffle 42 being installed, thereby providing further acoustic benefits with or without ANC. For instance, a baffle 42 as described herein, when integrated within a helmet audio system, may a have a substantial effect on loudspeaker frequency response. It may thus be desirable to compensate for changes in frequency response due to the baffle 42, such as the boost in bass and potential midrange modifications. One potential solution would be to sense or otherwise determine if a baffle 42 is installed and, in response, modify a loudspeaker driving signal applied to the loudspeaker 36. Likewise, information about a specific loudspeaker 36 as previously described, may be utilized to modify the loudspeaker driving signal applied to the loudspeaker 36 by application of specific signal processing for the respective loudspeaker 36. The loudspeaker driving signal may, for example, be supplied by controller 88 (FIG. 24) or another suitable electronic component located downstream a signal path of controller 88 or controlled by controller 88.

FIG. 24 shows an example of various components of an in-helmet audio system. The in-helmet audio system is capable of generating, receiving (e.g., from an external device such as a mobile phone or other communications device, a microphone 84 or an internal memory 90) and processing audio signals, including for implementing aspects of an ANC system as wells as a frequency response detection system according to certain embodiments of the disclosure. The in-helmet audio system includes a controller 88, such as one or more microprocessor(s) or other processing device(s) like a digital signal processor (DSP). Controller 88 may, for example, be an SOC (system on chip) comprising hardware interfaces for attached components like for example microphone(s) 84, loudspeaker(s) 36, sensor(s) 86 and wireless communication network(s) 100. The overall system as shown in FIG. 24, also includes a memory device 90 or other non-transitory computer readable medium for storing and executing computer executable instructions and data. The computer executable instructions can include audio playback instructions 92, audio processing instructions 94, ANC instructions 96, and frequency response instructions 98. In some cases, the memory device 90 may be included in one or more system component like, for example, the controller 88. Other components, like for example the loudspeaker 36 or baffle 42 may also comprise memory device(s) or other means to store certain information as will be described below. Memory device(s) on the loudspeaker 36 or baffle 42 may comprise a suitable interface to the controller 88, like a wired or wireless connection. In case of a wired connection, connection wires may at least partly be shared with wires utilized for a loudspeaker driving signal. For example, an electronic storage device or electronic component may share a common wire with the loudspeaker 36 that providers a common signal, for example an electrical reference voltage (e.g., signal ground). Memory device(s) on the loudspeaker 36 or baffle 42 may for example store information about the loudspeaker 36, the baffle 42 or a helmet for which these components are configured. Memory device(s) on the baffle 42 may also support a wireless connection for exchange of data or information with corresponding devices, like for example smartphones or other computers. In some cases, the wireless connection may also include power transmission through magnetic induction to power the memory device. An actual implementation of the exemplary audio system of FIG. 24 may comprise further components, including batteries, loudspeakers, sensors, memory devices, cable harnesses and connectors. A helmet audio system may be part of a larger system providing additional functionality for a helmet.

An audio system as illustrated by FIG. 24 may be implemented with various interconnected parts or sub-assemblies. For example, there may be a first part of the audio system including at least controller 88 and one or more loudspeaker 36 comprising a detachable electronic (e.g., wired) connection to the first part of the audio system. The controller 88 may be communicatively coupled to one or more other devices, such as one or more microphone(s) 84, one or more loudspeaker(s) 36, one or more sensor(s) 86, or a communication network 100. The controller 88 may be connected to such devices by way of any suitable communication link, such as wired connection(s), including connection(s) established by USB or similar ports or protocols, and/or wireless connection(s), such as Wi-Fi, Bluetooth or similar signaling methods. Microphone(s) 84 may include any suitable type of microphone capable of receiving acoustic signals and may include microphones such as 84 discussed with respect to FIG. 8. Microphone(s) 84 receive acoustic signals and transmit such signals or representations of them to the controller 88, which executes the audio processing instructions 94 and/or the ANC instructions 96. Communication network 100 may allow the controller 88 to communicate with other devices, for instance, through Bluetooth, such that the in-helmet audio system can receive audio signals such as voice communications, voice prompts and music from other devices.

The loudspeaker(s) 36 may be arranged for operation with any of the baffle configurations and/or transducer arrangements described herein (including all examples of FIGS. 3-23). Certain types of loudspeaker(s) 36 with/without certain baffle(s) 42 in certain helmets may require specific signal processing for audio playback and ANC. Especially in cases of loudspeakers 36, baffles 42 and transducer arrangements provided as aftermarket accessory for certain helmets, it may be required to adapt signal processing in an audio system (as in FIG. 24) to the specific loudspeaker 36 and/or baffle 42 and/or helmet. The sounds emitted from the loudspeaker(s) 36 may be generated based on execution of the audio playback instructions 92 stored in a memory device 90. Such sounds may also include previously mentioned test signals for measurement or determination of aspects of a loudspeaker transfer function like a signal level or phase at one or more frequencies. Sensor(s) 86 may include but are not limited to the sensor(s) 86 described with respect to FIG. 23C and may be configured for detecting an installed baffle and/or any physical parameter related to the installation status of a baffle in connection with at least one loudspeaker 36 and communicating such information to the controller 88 or for enabling the controller 88 to retrieve such information from the sensor 86. The loudspeaker(s) 36 may in some cases provide an interface that allows retrieval of information about the loudspeaker 36 and/or a baffle 42 attached to the loudspeaker 36 and/or a helmet in which the loudspeaker 36 may be installed, for example by a controller 88. For example, the loudspeaker 36 may comprise an electrical connection that allows sensing of a parameter like a resistance value related to specific loudspeaker and/or baffle and/or helmet types. For example, certain ranges of resistance values may be associated with such information. The resistance value may be an electrical parameter of a loudspeaker component, like for example a voice coil of the loudspeaker 36. The resistance value may also be related to a resistor located somewhere on the loudspeaker 36 or on a cable or connector of the loudspeaker 36. Certain loudspeaker and/or baffle and/or helmet types may be identified based on a resistance value or value range, or other electrical or physical parameter received from the loudspeaker 36. In yet another case, the loudspeaker 36 may comprise a memory device (not shown) that stores and provides information related to the loudspeaker 36 and/or the baffle 42 and/or a helmet to which any of the components belong or for which these components have been designed. A controller 88 may read such information and apply corresponding audio playback instructions 92, audio processing instructions 94, ANC instructions 96 and/or frequency response instructions 98 within signal handling and or processing for audio playback and/or ANC.

Audio processing instructions 94 may generally provide programs and/or parameters for processing of an audio signal, for example a playback signal prior to application to loudspeaker 36 or a microphone signal. Audio processing instructions 94 may include analog to digital conversion programs or parameters for converting audio received from microphone(s) 84. For instance, audio processing instructions 94 may be executed by the controller 88 in response to operations determined through execution of the ANC instructions 96 or frequency response instructions 98. The latter refers to determining a loudspeaker transfer function as previously described and applying specific compensation functions for the loudspeaker transfer function. Other programs may also be included in audio processing instructions 94 such as noise filtration or equalization programs. Audio processing instructions 94 may also include digital to analog conversion programs. Audio processing instructions 94 may further include application of one or more filter transfer function(s) to one or more audio playback signal(s), for example for compensation of loudspeaker transfer functions and loudspeaker protection like limitation of a loudspeaker driving signal to a save operation range or general sound improvements including loudness compensation, bass extension or stereo base widening. Other programs may also be included in audio processing instructions 94 such as other noise filtration or equalization programs. Audio processing instructions 94 may also include digital to analog conversion programs or parameters. Audio processing instructions 94 may be related to information about the loudspeaker 36 and/or a baffle 42 attached to the loudspeaker 36 and/or a helmet in which the loudspeaker 36 may be installed as previously described. Audio processing instructions 94 may include programs and/or parameters for processing of the audio playback signal for certain cases corresponding to the aforementioned information about a loudspeaker 36 and/or a baffle 42 attached to the loudspeaker 36 and/or a helmet. As a result, the loudspeaker driving signal may comprise a processed version of an audio playback signal and processing of the audio playback signal is adapted based on information regarding the baffle. Information regarding the baffle may be received from a transfer function measurement and/or user input to a device controlling the processing applied to the audio playback signal and/or a sensor on the loudspeaker 36 or baffle 42 and/or a machine-readable code on the loudspeaker 36 or baffle 42 or on any related item like a packaging of the loudspeaker 36 and/or baffle 42.

ANC instructions 96 may include or relate to programs or parameters for processing microphone signal(s) received by the microphone(s) 84, recording ambient noise, frontal sound and/or rear sound from loudspeaker(s) 36, for generating noise cancelling signals and/or distortion compensation signals for output by and/or to the loudspeaker 36. ANC instructions 96 may, for example, include information about signal processing paths and methods, representations of filter transfer functions or parameters for other linear or nonlinear signal processing steps like inversion, compression or limitation. The ANC instructions 96 may be executed by the controller 88 to generate and cause the loudspeaker 36 to emit acoustic waves for reducing or cancelling ambient noise detected from the microphone(s) 84 and/or for reducing distortion(s) of the loudspeaker(s) 36. Execution of ANC instructions 96 may include application of a filter transfer function to a microphone signal from a microphone 84 as well as any other suitable processing steps, for example signal inversion or signal compression, to receive a processed microphone signal. The processed microphone signal may subsequently be applied to the loudspeaker(s) 36 as loudspeaker driving signal or added to a loudspeaker driving signal to become a signal component of the loudspeaker driving signal.

Frequency response instructions 98 may be related to audio processing instructions 94 in that they may provide information regarding a loudspeaker 36 and/or a baffle 42 attached to the loudspeaker 36 and/or a helmet in which the loudspeaker 36 and/or baffle 42 may be installed. Frequency response instructions 98 may also provide processing parameters required by audio processing instructions 94. Frequency response instructions 98 may also utilize audio processing instructions 94 to provide certain functionality. Frequency response instructions 98 may comprise programs for detecting if a baffle 42 is installed with a loudspeaker 36. For instance, sensor(s) 86 may detect a baffle 42 or helmet in proximity to the loudspeaker 36 which may be retrieved through a program or routine included in frequency response instructions 98. Alternatively, the controller 88 may receive communications from a user (e.g., through a smartphone app and Bluetooth or other communication link) that the baffle 42 is installed with a loudspeaker 36. Such information may include specific baffle types or baffle references, loudspeaker types or loudspeaker references and/or helmet types or helmet references. In response to detecting that a baffle 42 has been installed with a loudspeaker 36 or specific helmet configuration, the controller 88 can execute specific frequency response instructions 98, for instance, by modifying the audio signals output through the loudspeaker 36 in combination with audio processing instructions 94. As discussed, specific baffle configurations may cause the loudspeaker 36 to have a certain acoustic profile. The frequency response instructions 98 may be executed by the controller 88 to identify the acoustic profile and to appropriately boost or attenuate particular frequency ranges of an output signal of the loudspeaker 36 in combination with audio processing instructions 94. The frequency response instructions 98 and audio processing instructions 94 thus allow for the controller 88 to compensate for modified acoustic characteristics of the loudspeaker 36 owing to the baffle 42 being installed. To identify the acoustic profile of a loudspeaker 36 with/without a baffle 42 in a given helmet, frequency response instructions 98 may comprise a measurement routine that determines specific aspects of a transfer function of the loudspeaker 36 like a sound pressure level or phase at one or more frequencies. Frequency response instructions 98 may for example invoke audio playback instructions 92 to provide a test signal for measurement or determination of aforementioned aspects of the loudspeaker transfer function. Furthermore, frequency response instructions 98 may invoke certain processing steps provided by audio processing instructions 94 like analog to digital conversion programs for converting audio received from microphone(s) 84 to a digital domain and processing the microphone signal to determine desired aspects of the transfer function of the loudspeaker 36. Based on determined aspects of the transfer function of the loudspeaker 36 frequency response instructions 98 may provide processing parameters required by audio processing instructions 94 to compensate for certain acoustic characteristics of the transfer function of the loudspeaker 36 as previously described.

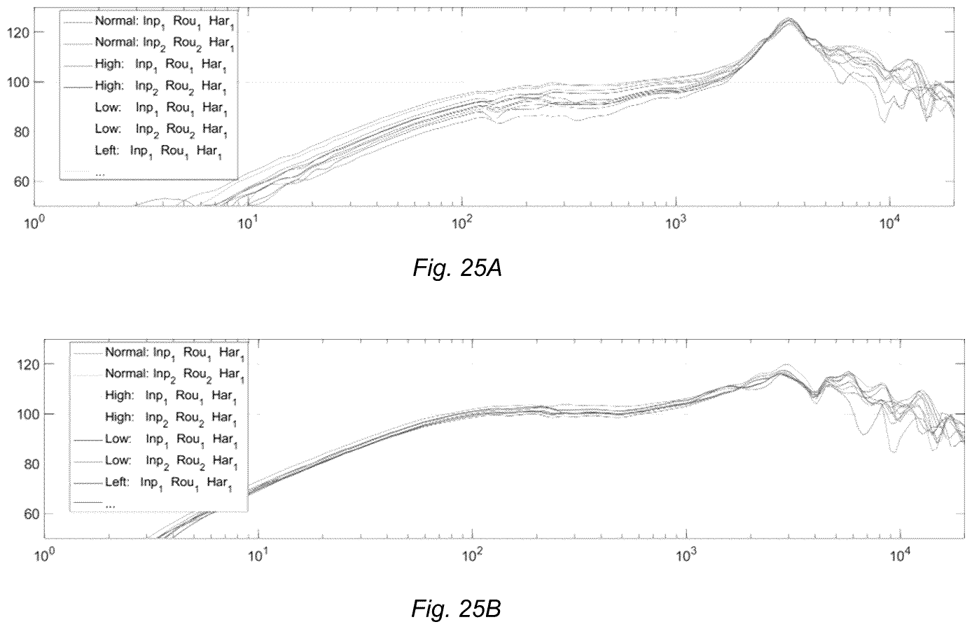

FIGS. 25A-25B show experimental results of transducer arrangements with the same loudspeakers 36 in the same helmet without (FIG. 25A) and with (FIG. 25B) the baffle 42 of FIGS. 7-9 improving acoustic characteristics within the protective layer structure of the helmet. The helmet was similar to the helmet shown in FIG. 1. The configuration that corresponds to FIG. 25A is the de-facto industry standard for motorcycle helmets with 40 mm loudspeakers arranged in loudspeaker pockets 8 (see FIG. 1) next to the respective ear. The only difference in the measurements of FIG. 25B is the addition of baffles 42 on both loudspeakers 36 (FIG. 9). Comparable results may be achieved by other example baffles 42 and transducer arrangements (e.g., FIGS. 3-6 and 20A) discussed herein. FIGS. 25A-25B are magnitude response plots illustrating the acoustic response of a loudspeaker 36 embedded in a helmet without a baffle 42 (FIG. 25A) compared to the case with a baffle 42 (FIG. 25B). The Y-axis in each figure denotes sound pressure level in decibels, and the X-axis provides a log frequency scale. Ten measurements are shown in each of FIGS. 25A-25B. Five measurements including audio received from a measurement microphone placed adjacent to a left baffle 42 internal to a helmet, and five measurements including audio received from a measurement microphone placed adjacent to a right baffle 42 internal to a helmet. Each of the five signals on the left and right sides further reflecting a placement of a helmet on a dummy-head relative to a reference helmet wearing position. The helmet with the loudspeaker 36 and in case of FIG. 25B a baffle 42 mounted inside, was placed on the dummy-head in a central position, a lowered position, a raised position, a position with the helmet rotated to the left side and a position with the helmet rotated to the right side. Measurement microphones were located within the ears of the anthropomorphic dummy-head for acoustic measurements. The ten measurements thus indicate a variety of wearing positions of a helmet and the installed loudspeaker 36 with and without baffle 42 relative to the dummy-head as may be taken by a human wearing the helmet. Measurements have been conducted with equal level of the loudspeaker driving signal. Differences in sound pressure level are caused by the baffles 42 installed on both respective sides of the helmet for the measurements of FIG. 25B.

As seen in FIGS. 25A-25B, embodiments of the present disclosure can result in substantial improvements in the acoustic environment of a helmet system. Variations in sound pressure level are decreased from FIG. 25A to FIG. 25B. Particularly, without a baffle, as in FIG. 25A, detected magnitude response varied dramatically over tested helmet positions, the sound pressure level variation between helmet positions varying more than 10 dB (decibels) at 100 Hz. In comparison, in FIG. 25B the sound pressure level variation between helmet positions with the baffles 42 applied to loudspeakers 36 varies less than 5 dB at 100 Hz. With the baffles, the sound pressure level between different positions only begins to diverge at upwards of 4 kHz, as shown in FIG. 25B. In addition to reduced variations in sound pressure level, FIG. 25B shows that the baffles 42 boost the sound pressure level across most positions by more than 10 dB compared to the same measurements shown in FIG. 25A without the baffles 42. Average sound pressure level at 100 Hz with the baffles 42 can be taken from FIG. 25B as roughly 100 dB SPL. In comparison, the sound pressure level at 100 Hz without the baffle 42 can be taken from FIG. 25A as being about 90 dB SPL in average. For lower frequencies, the boost in sound pressure achieved by the baffle 42 is even higher. In addition, the peak at approximately 3.5 kHz in FIG. 25A, is reduced by approximately 10 dB in FIG. 25B, effectively improving frequency response linearity in the treble range. Thus, the addition of a baffle to an in-helmet audio system may reduce variations in sound pressure level over various ear-positions close to the loudspeaker 36, boost the sound pressure level across a broad range of frequencies and improve frequency response nonlinearities. Especially the measured low-frequency boost is substantial and highly beneficial for the sound quality of helmet audio systems. With a baffle 42, the sound quality of existing helmet loudspeakers 36 without baffle 42 may be achieved with substantially smaller loudspeakers 36. Alternatively, a significantly improved sound quality may be achieved with loudspeakers 36 of the same size. The boost in sound pressure level of about 10 dB at 100 Hz is a major improvement in the acoustic capabilities of the loudspeaker 36. To reach a comparable improvement in maximum sound pressure level with changes on the loudspeaker 36, the membrane area would have to increase by a factor of approximately 2-3 (speaker diameter increases from 40 mm to approx. 55-70 mm) or alternatively the excursion of the loudspeaker membrane would have to increase by a factor of approximately 3 (from about +/−1mm in the given case to +/−3 mm resulting in a 6 mm higher speaker, increasing bare loudspeaker heigh from 9 to 15 mm). Both is impossible in many helmets, because of limited space available for the loudspeaker 36. Furthermore, loudspeaker dimensions for helmets, for example motorcycle helmets, are in many countries limited by legal norms or regulations. Previously existing transducer arrangements in helmets do not provide high quality sound like for example high quality consumer headphones. Such sound quality is enabled by embodiments of the specified invention. Vast improvements in measured sound quality of the given example match sound quality perception of listeners. Reduced frequency response variation for various placements of a helmet on the head of a user is also beneficial for sound quality in providing constant bass levels. Such reduced frequency response variation is even more beneficial for ANC, because the effectiveness of noise cancellation depends on the frequency response of the loudspeaker 36. Variations in the loudspeaker transfer function can drastically reduce ANC, cause actual noise boost instead of cancellation or even feedback instability. The latter may result in feedback loop oscillation generating loud whistling or rumbling noises. These can cause a shock or fear reaction of a wearer of a helmet equipped with such an ANC system. As a result, accidents can happen, for example in traffic situations. Therefore, it is vital for transducer arrangements in ANC systems to provide stable acoustic transfer functions. Furthermore, noise levels in specific types of helmets, like for example motorcycle helmets, can be extremely high especially at and below 100 Hz. Loudspeakers without a baffle 42 usually cannot provide sound levels that come even close to the required levels. In providing substantially higher maximum sound pressure levels from a given loudspeaker 36, a baffle 42 as described herein can enable ANC applications that are otherwise not possible. Note that the acoustic function of local separation of frontal and rear sound of a loudspeaker 36 by a baffle 42 as shown in examples of FIGS. 7-19 and FIG. 23, is provided in a similar manner by functional layer 28 as applied in the examples of FIGS. 3-6 and FIGS. 20-22. Therefore, the advantages outlined above generally also apply to the transducer arrangements of the examples of FIGS. 3-6 and FIGS. 20-22 in comparison to prior art loudspeaker integration as corresponding to FIG. 25A.

The examples of baffles (e.g., 42) for loudspeakers (e.g., 36) to be applied within helmets and transducer arrangements for or within helmets as described above, provide advantages in the field of loudspeaker-integration to helmets and related applications for such loudspeakers. As discussed, baffles and functional layers (e.g., 28) functioning as baffles may be configured to separate acoustic waves emitted from a front face of a loudspeaker from acoustic waves emitted from a rear face of the loudspeaker such that the acoustic waves emitted from the rear face of the loudspeaker travel through sound guide(s) (e.g., 24) before superimposing and cancelling with the acoustic waves emitted from the front face of the loudspeaker. As a result, dipole null cancellation is shifted away from the loudspeaker preventing reduction in sound pressure level adjacent to a wearer's ear. The sound guides further provide outlets (e.g., 74) for sound emitted from the rear of the loudspeaker such that the rear waves do not reflect back towards the loudspeaker, preventing distortion from the loudspeaker due to nonlinear air stiffness. Limited space inside the helmet shell may be preserved through various configurations of the described baffles and integrated transducer arrangements, allowing for a larger size loudspeaker (increasing sound pressure level) while ensuring sufficient padding within the protective layer to ensure protective layer functionality and safety. In some of the examples described above, component(s) of a cushion layer (e.g., 16) of a helmet, for example a cushion carrier, may function as a baffle. In some of these examples, a cushion layer mounted to a cushion carrier can form a ring around the loudspeaker, further forming an acoustic chamber for an ear of a wearer of the helmet which provides passive damping of external noise and further boost of frontal sound from the loudspeaker. Additional sealing as discussed, provided along the edge of the protective layer adjacent to the loudspeaker may minimize leakage of rear sound close to the loudspeaker, further preventing sound pressure level reduction due to dipole cancellation. An ANC feedback microphone (e.g., 84) may be placed close to the frontal side of a loudspeaker within one of the baffle or transducer arrangements described above. At this position, influence of rear sound of the loudspeaker is relatively low. However, the ear is further away from the loudspeaker, which means that the sound at the ear position will be influenced by frontal and rear sound of the loudspeaker if rear sound is allowed to directly radiate towards the ear. In such a situation, there is a mismatch of sound pressure and phase between the microphone position and the ear position. If the ANC feedback microphone is applied in a closed feedback loop including the loudspeaker, configured to cancel noise at the ANC microphone position, the noise cancellation will be less effective at the ear position than at the microphone position due to the previously described mismatch in sound pressure and phase between these positions. The baffles and transducer arrangements proposed above, reduce the influence of rear sound at the ear position and thereby the described mismatch. This will effectively increase ANC at the ear. Major improvements in acoustic parameters of transducer arrangements for helmets, as described above and throughout the specification, may be achieved by embodiments of the invention with low cost and low impact on helmet comfort or safety. Exemplary embodiments described throughout the specification demonstrate, that the invention may generally be implemented with low additional effort compared to existing solutions. The invention therefore represents a significant advancement in the fields of transducer arrangements for helmets and transducer integration to helmets.

### General Remarks

It should be understood that parts of a loudspeaker, like for example a loudspeaker basket or a loudspeaker grille, may be integrated to other parts of a transducer arrangement, for example a baffle. Such modifications are within the scope of the invention. Generally, parts with individual designation may be combined in a single physical part and multiple physical parts may provide the features of a part with a single designation.

It should also be noted that loudspeakers, which emit sound on two sides with relatively inverted phase, may generally face the ear of a wearer of the helmet with any of these sides. The frontal side of a loudspeaker refers to the side pointing in the direction of the head of a wearer of a helmet comprising the loudspeaker. The rear side refers to the opposite side of the loudspeaker. Frontal and rear side are not features of the loudspeaker itself.

The primary purpose of a baffle as described above is optimized acoustic integration of at least one loudspeaker to a helmet. Depending on implementation details, the baffle may additionally provide mechanical support for other parts of a transducer arrangement like a loudspeaker, a microphone, a microphone holder or a grille in front of the loudspeaker and/or microphone. In other cases, parts of a transducer arrangement including a baffle, like a loudspeaker, may mechanically support the baffle. It is generally also possible to provide multiple loudspeakers within a common baffle. This may be desirable for multi-way loudspeakers or parallel loudspeakers for increased sound pressure level. In some configurations additional loudspeakers may provide directional cues to a listener by directing sound towards the pinna of the listener from specific angles.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the attached claims. The following examples may illustrate further aspects and embodiments of the invention.

### EXAMPLES

Baffles, transducer arrangements, helmets with transducer arrangements and methods for providing sound within helmets are described herein, capable of improving acoustic qualities of loudspeakers placed inside helmets to control sound within helmets. Improvements in acoustic qualities and control of sound within helmets include examples such as increased sound pressure level of desired frequencies, reduced sound pressure level of undesired sounds and frequencies and reduced variation of sound pressure levels over potential ear positions within a helmet. Improved acoustic qualities are achieved by disclosed control of sound propagation paths, capable of preventing sound emitted from a loudspeaker from interacting with inverse sound emitted from the loudspeaker, until sound and inverse sound reach a remote position, further away from the loudspeaker. Thereby, losses in sound pressure due to mutual cancellation of sound and inverse sound of the loudspeaker may be reduced in desired regions of a helmet. This may shift a region with low sound pressure, also referred to as the dipole null, away from the loudspeaker and from an ear of a wearer. In the following, several examples of baffles, transducer arrangements, helmets with transducer arrangements, their application and methods for operation as well as corresponding methods to provide or modify sound in helmets will be described. Reference numbers, corresponding to elements of the drawings of FIGS. 1-25, are provided in brackets in the following examples for exemplary illustration of certain features or components. These references to the drawings shall neither limit the scope of the following examples nor limit alternative embodiments of respective features or components. To avoid reiteration of common features, components or steps, the following examples are organized into independent examples and dependent examples referring to independent examples either directly or via other dependent examples. Any number of dependent examples referring to a common independent example may be combined with the common independent example. Such combinations are meant to be included in the examples described below.

Example 1: According to a first example, a baffle (42) for at least one loudspeaker (36) within a helmet comprises an outer edge (46) defining a perimeter of the baffle (42) and a loudspeaker receiving region (60) within the perimeter of the baffle (42). The loudspeaker receiving region (60) comprises at least one opening (48) between an interior facing side (44) and an exterior facing side (50) of the baffle (42). The baffle (42) further comprises a plurality of surface sections on the exterior facing side (50) of the baffle (42) arranged to provide free intermediate space, wherein the free intermediate space forms at least one rear sound propagation path (24) from at least one close position near to the loudspeaker receiving region (60) to at least one remote position near to the perimeter of the baffle (42).

Example 2: The baffle (42) of example 1, wherein a distance between at least one of the at least one close position and at least one of the at least one remote position is at least 5 mm, at least 10 mm or at least 15 mm in a direction essentially parallel to the main extension of the interior facing side (44) of the baffle (42).

Example 3: The baffle (42) of example 1, wherein the loudspeaker receiving region (60) is defined by an area on the exterior facing side (50) of the baffle (42) covered with an adhesive film.

Example 4: The baffle (42) of example 1, wherein the loudspeaker receiving region (60) is defined by mechanical features arranged and constructed to receive at least a cylindrical part of a loudspeaker (36).

Example 5: The baffle (42) of example 1, wherein the loudspeaker receiving region (60) is bounded by an inner edge (56) or inner rim (58) of the baffle (42).

Example 6: The baffle (42) of example 1, wherein the loudspeaker receiving region (60) is bounded by an inner edge (56) or inner rim (58) of the baffle (42) arranged and constructed to encircle at least part of a loudspeaker (36).

Example 7: The baffle (42) of example 1, wherein the loudspeaker receiving region (60) is bounded by an inner groove or notch (78) of the baffle (42) arranged and constructed to encircle at least part of a loudspeaker (36).

Example 8: The baffle (42) of example 1, wherein the loudspeaker receiving region (60) is bounded by an inner edge (56) or inner rim (58) of the baffle (42) arranged and constructed to encircle a loudspeaker (36) and provide acoustic sealing against the loudspeaker (36) by means of press-fit assembly on the loudspeaker (36).

Example 9: The baffle (42) of example 1, wherein the loudspeaker receiving region (60) comprises an adhesive layer that allows the attachment to and sealing against a loudspeaker (36).

Example 10: The baffle (42) of example 1, wherein the loudspeaker receiving region (60) comprises multiple openings (48) between the interior facing side (44) and the exterior facing side (50) of the baffle (42) and an adhesive layer at least around these openings (48) that allows the attachment to and sealing against a loudspeaker (36).

Example 11: The baffle (42) of example 1, wherein the loudspeaker receiving region (60) comprises an open sleeve arranged and constructed to partly enclose a loudspeaker (36) and thereby attach it to the baffle (42).

Example 12: The baffle (42) of example 1, wherein the loudspeaker receiving region (60) is bounded by an inner edge (56) or inner rim (58) of the baffle (42) and has a circular cross-section area.

Example 13: The baffle (42) of example 1, wherein the loudspeaker receiving region (60) has a circular cross-section area bounded by an inner edge (56) or inner rim (58) of the baffle (42) with a maximum inner diameter between 28 mm and 55 mm, between 28 mm and 47 mm or between 35 mm and 47 mm.

Example 14: The baffle (42) of example 1, wherein the loudspeaker receiving region (60) comprises an inner edge (56) or inner rim (58) comprising a flexible material, the inner edge (56) or inner rim (58) can be stretched such that it provides sealing against a body, the body comprising a two-dimensional cross-sectional shape with a perimeter between 7.5 cm and 20 cm.

Example 15: The baffle (42) of example 1, wherein an area of the loudspeaker receiving region (60) is bounded by an inner edge (56) or inner rim (58) of the baffle (42), and wherein an area within the boundaries of the perimeter of the baffle (42) is at least 25% larger, at least 50% larger or at least 100% larger than the area of the loudspeaker receiving region (60).

Example 16: The baffle (42) of example 1, wherein a minimum distance between the perimeter of the baffle (42) and the loudspeaker receiving region (60) is more than 5 mm, more than 10 mm or more than 15 mm.

Example 17: The baffle (42) of example 1, wherein an area of the loudspeaker receiving region (60) is bounded by an inner edge (56) or inner rim (58) of the baffle (42) and wherein a minimum total cross-section area of the free intermediate space within a region of the baffle (42) at an equal distance from a center of the loudspeaker receiving region (60) is at least 1%, at least 2.5% or at least 5% of the area of the loudspeaker receiving region (60).

Example 18: The baffle (42) of example 1, wherein an area of the loudspeaker receiving region (60) is bounded by an inner edge (56) or inner rim (58) of the baffle (42) and wherein a minimum total cross-section area of the free intermediate space within a region of the baffle (42) at an equal distance from a center of the loudspeaker receiving region (60) is at least 10 mm2, at least 15 mm2 or at least 25 mm2.

Example 19: The baffle (42) of example 1, wherein an area of the loudspeaker receiving region (60) is bounded by an inner edge (56) or inner rim (58) of the baffle (42) and wherein a total cross-section area of the free intermediate space within a region of the baffle (42) at an equal distance from a center of the loudspeaker receiving region (60) increases essentially linearly or essentially continuously with increasing distance from the center of the loudspeaker receiving region (60).

Example 20: The baffle (42) of example 1, further comprising at least one flexible material.

Example 21: The baffle (42) of example 1, further comprising a flexible material supporting at least partial alignment of the baffle (42) with a curved surface of a helmet.

Example 22: The baffle (42) of example 1, further comprising a material with a density between 0.8 g/cm3 and 2.3 g/cm3.

Example 23: The baffle (42) of example 1, further comprising a flexible material with a density of more than 0.8 g/cm3.

Example 24: The baffle (42) of example 1, wherein a maximum thickness of the baffle (42) outside the loudspeaker receiving region (60) is less than 5 mm, less than 3 mm or less than 2 mm.

Example 25: The baffle (42) of example 1, wherein a minimum thickness of the baffle (42) outside of the loudspeaker receiving region (60) is less than 1.5 mm or less than 1 mm.

Example 26: The baffle (42) of example 1, further comprising a clip opening (80) for feeding through an attachment component between two layers of a helmet that abut the baffle (42) from two respective sides.

Example 27: The baffle (42) of example 1, further comprising a chinstrap cut-out (82) in form of a recess in the perimeter of the baffle (42) or in form of an opening outside the loudspeaker receiving region between an interior facing side (44) and an exterior facing side (50) of the baffle (42) for receiving at least a portion of a strap of the helmet.

Example 28: The baffle (42) of example 1, further comprising helmet attachment means for attaching the baffle (42) to at least one layer of a helmet, the helmet attachment means comprising an adhesive film on a surface of at least one side of the baffle (42) and/or an adhesive film on a surface of at least one separator (54) extending from the baffle (42) and/or a hook-or loop-side of a hook-and-loop fastener on a surface of at least one side of the baffle (42) and/or a hook-or loop-side of a hook-and-loop fastener on a surface of at least one separator (54) extending from the baffle (42) and/or or a clip fastener (30) permanently or detachably coupled with the baffle (42).

Example 29: The baffle (42) of example 1, wherein the plurality of surface sections on the exterior facing side (50) of the baffle (42) comprises hooks or loops of a hook-and-loop fastener.

Example 30: The baffle (42) of example 1, wherein the plurality of surface sections on the exterior facing side (50) of the baffle (42) comprises a woven or non-woven fabric, the fabric comprising synthetic fibers formed in hook-shape or loop-shape.

Example 31: The baffle (42) of example 1, wherein the plurality of surface sections on the exterior facing side (50) of the baffle (42) comprises a multitude of pin-shaped elements extending from the baffle (42) with approximately mushroom-shaped end-sections.

Example 32: The baffle (42) of example 1, wherein the free intermediate space of the baffle 42 comprises an acoustically resistive or sound absorbing material.

Example 33: The baffle (42) of example 1, wherein the plurality of surface sections on the exterior facing side (50) of the baffle (42) forms at least one sound guide (24) in the surface of the exterior facing side (50) of the baffle (42), the at least one sound guide (24) located between the loudspeaker receiving region (60) and the perimeter of the baffle (42).

Example 34: The baffle (42) of example 1, wherein the plurality of surface sections on the exterior facing side (50) of the baffle (42) forms separators (54) to provide a multitude of at least partially separate sound guides (24) in the surface of the exterior facing side (50) of the baffle (42).

Example 35: The baffle (42) of example 34, wherein the separators (54) are shaped and arranged such that at least one sound guide (24) extends substantially linearly.

Example 36: The baffle (42) of example 34, wherein the separators (54) are shaped and arranged such that at least one sound guide (24) extends substantially nonlinear.

Example 37: The baffle (42) of example 34, wherein the separators (54) are shaped and arranged such that multiple sound guides (24) in the surface of the exterior facing side of the baffle (42) form intermittent patterns.

Example 38: The baffle (42) of example 34, wherein the separators (54) are shaped and arranged such that multiple sound guides (24) in the surface of the exterior facing side (50) of the baffle (42) form irregular patterns.

Example 39: The baffle (42) of example 34, wherein the separators (54) are shaped and arranged such that multiple sound guides (24) in the surface of the exterior facing side (50) of the baffle (42) comprise varying width.

Example 40: The baffle (42) of example 34, wherein the separators (54) are shaped and arranged such that multiple sound guides (24) in the surface of the exterior facing side (50) of the baffle (42) comprise varying length.

Example 41: The baffle (42) of example 34, wherein at least part of the sound guides (24) are arranged and constructed to form tubular structures with an abutting element when an approximately even surface of the abutting element abuts the exterior facing side (50) of the baffle (42).

Example 42: The baffle (42) of example 34, wherein at least part of the sound guides (24) are arranged and constructed to form tubular structures with an abutting element when a curved surface of the abutting element abuts the exterior facing side of the baffle (42).

Example 43: The baffle (42) of example 34, wherein at least part of the sound guides (24) are arranged to extend approximately radially with respect to a central point within the loudspeaker receiving region (60).

Example 44: The baffle (42) of example 34, wherein at least part of the sound guides (24) are intermitted by interconnections to neighboring sound guides (24).

Example 45: The baffle (42) of example 34, wherein at least part of the sound guides (24) are intermitted by interconnections to neighboring sound guides (24) at different positions with respect to a length of neighboring sound guides (24).

Example 46: The baffle (42) of example 34, wherein the sound guides (24) are distributed around the loudspeaker receiving region (60) over an angular range of more than 90°, more than 180° or more than 270°.

Example 47: The baffle (42) of example 34, wherein at least part of the sound guides (24) comprises stepwise variation in cross-section area.

Example 48: The baffle (42) of example 34, wherein the plurality of surface sections on the exterior facing side (50) of the baffle (42) comprises a multitude of sharp edges that cause diffuse reflections and diffractions of high frequency sound components within the multitude of sound guides (24).

Example 49: The baffle (42) of example 34, wherein a cross-section area of the sound guides (24) increases essentially continuously or essentially linearly with increasing distance from the loudspeaker receiving region (60).

Example 50: The baffle (42) of example 34, wherein at least one sound guide (24) further comprises a sound outlet (74) towards the interior facing side (44) of the baffle (42).

Example 51: The baffle (42) of example 1, wherein the plurality of surface sections on the exterior facing side (50) of the baffle (42) comprises multiple separators (54) with a cross-section area of a round shape and/or an elongated shape and/or an elliptic shape and/or a rectangular shape and/or a trapezoid shape.

Example 52: The baffle (42) of example 1, wherein the exterior facing side (50) of the baffle (42) is further arranged and constructed to abut a protective layer, a functional layer or a cushioning layer of the helmet.

Example 53: The baffle (42) of example 1, wherein a sound pressure level of a 100 Hz sine wave signal radiated by a loudspeaker (36) to a position in front of the loudspeaker (36) is at least 3 dB, at least 5 dB or at least 10 dB higher when the loudspeaker (36) is placed in the loudspeaker receiving region (60) of the baffle (42) than for the loudspeaker (36) without the baffle (42).

Example 54: The baffle (42) of example 1, wherein at least one of a resonance frequency and a resonance quality factor of a loudspeaker (36) is lower when the loudspeaker (36) is mounted within a helmet with the baffle (42) than without the baffle (42).

Example 55: The baffle (42) of example 1, wherein the interior facing side (44) of the baffle (42) further comprises a fabric layer and/or a cushion layer.

Example 56: The baffle (42) of example 1, further comprising an acoustically largely transparent cover on at least one opening (48) in the loudspeaker receiving region (60).

Example 57: The baffle (42) of example 1, further comprising a machine readable visual or geometric feature on a surface of the baffle (42) that comprises encoded information with regard to the baffle (42).

Example 58: The baffle (42) of example 1, further comprising cutting marks that support manual customization of the perimeter shape of the baffle (42) or adaption or addition of an opening in the baffle (42).

Example 59: The baffle (42) of example 1, further comprising an alignment feature that limits the orientation of the loudspeaker (36) within the loudspeaker receiving region (60) of the baffle (42). The alignment feature comprises a cable-guide for receiving a cable connected to the loudspeaker (36) and/or a protruding element for insertion to a recess or cavity of the loudspeaker (36) and/or a recess or cavity for receiving a protruding element of the loudspeaker (36) and/or an opening for alignment with a corresponding opening in the loudspeaker (36).

Example 60: The baffle (42) of example 1, wherein the perimeter of the baffle (42) has a round, oval or oblong shape.

Example 61: A pair of baffles comprising a first baffle (42) according to any of the previous examples and a second baffle (42) that is essentially mirror-symmetrical to the first baffle (42) at least with respect to the features described in the respective example.

Example 62: A helmet comprising a baffle (42) according to any of the previous examples, further comprising a loudspeaker (36) placed in the loudspeaker receiving region (60) of the baffle (42).

Example 63: The helmet of example 62, wherein the baffle (42) is positioned in the helmet such that it abuts an inner layer of the helmet with at least parts of the exterior facing side (50) of the baffle (42).

Example 64: The helmet of example 62, wherein the loudspeaker (36) is at least partly positioned within a recess in an inner layer of the helmet.

Example 65: The helmet of example 62, wherein the baffle (42) is mechanically attached to at least one inner layer of the helmet.

Example 66: The helmet of example 62, wherein the baffle (42) is mechanically attached to the loudspeaker (36) and to an inner layer of the helmet.

Example 67: The helmet of example 62, wherein the loudspeaker (36) is mechanically attached to an inner layer of the helmet.

Example 68: According to a sixty-eighth example, a transducer arrangement for helmets comprises a baffle (42) with an outer edge (46) defining a perimeter of the baffle (42) and a loudspeaker receiving region (60) within the perimeter of the baffle (42). The loudspeaker receiving region (60) comprises at least one opening (48) between an interior facing side (44) and an exterior facing side (50) of the baffle (42). The transducer arrangement further comprises a plurality of surface sections on the exterior facing side (50) of the baffle (42) arranged to provide free intermediate space and a loudspeaker (36) provided within the loudspeaker receiving region (60) of the baffle (42). Wherein the free intermediate space forms at least one rear sound propagation path (24) from at least one close position near to the loudspeaker receiving region (60) to at least one remote position near to the perimeter of the baffle (42).

Example 69: The transducer arrangement of example 68, wherein a distance between at least one of the at least one close position and at least one of the at least one remote position is at least 5 mm, at least 10 mm or at least 15 mm in a direction essentially parallel to the main extension of the interior facing side (44) of the baffle (42).

Example 70: The transducer arrangement of example 68, wherein the loudspeaker receiving region (60) comprises an area covered with an adhesive film that attaches the loudspeaker (36) to the baffle (42).

Example 71: The transducer arrangement of example 68, wherein the baffle (42) comprises loudspeaker attachment means for attaching the loudspeaker (36) to the baffle (42), the loudspeaker attachment means comprising an adhesive film covering at least one surface section of the baffle (42) and/or an edge or rim that encircles at least part of the loudspeaker (36) and/or an edge or rim that fits tightly around at least part of the loudspeaker (36) and seals the baffle (42) against the loudspeaker (36) and/or an edge or rim constructed and arranged to support press-fit assembly of the loudspeaker (36) in the baffle (42) and/or a clamp holding the loudspeaker (36) and/or a sleeve that encompasses at least a part of the loudspeaker (36).

Example 72: The transducer arrangement of example 68, wherein the loudspeaker (36) comprises a baffle attachment feature comprising a groove around a perimeter of an element of the loudspeaker (36) and/or a notch around a perimeter of an element of the loudspeaker (36) and/or a slot around a perimeter of an element of the loudspeaker (36). The loudspeaker receiving region (60) of the baffle (42) comprises a corresponding loudspeaker attachment feature comprising a tongue and/or a nose and/or a key.

Example 73: The transducer arrangement of example 68, wherein the loudspeaker receiving region (60) of the baffle (42) comprises a loudspeaker attachment feature comprising a groove and/or a notch and/or a slot. The loudspeaker (36) comprises a corresponding baffle attachment feature comprising a tongue and/or a nose and/or a key.

Example 74: The transducer arrangement of example 68, wherein the loudspeaker (36) is configured to emit frontal sound from a frontal side and rear sound from a rear side and wherein frontal sound is emitted at the interior facing side (44) of the baffle (42) and rear sound is emitted at the exterior facing side (50) of the baffle (42).

Example 75: The transducer arrangement of example 68, wherein the loudspeaker receiving region (60) of the baffle (42) comprises multiple openings (48) between the interior facing side (44) and the exterior facing side (50) of the baffle (42) and the loudspeaker (36) is arranged on the baffle (42) such that sound emitted by a frontal side of the loudspeaker (36) passes through the openings (48) towards the interior facing side (44) of the baffle (42).

Example 76: The transducer arrangement of example 68, wherein the loudspeaker (36) comprises a sound generating element (70) with an effective radiating area Sd and wherein an area within the boundaries of the perimeter of the baffle (42) is at least 25% larger, at least 50% larger or at least 100% larger than the effective radiating area Sd of the loudspeaker (36).

Example 77: The transducer arrangement of example 68, wherein a minimum distance between the perimeter of the baffle (42) and the loudspeaker (36) is more than 5 mm, more than 10 mm or more than 15 mm.

Example 78: The transducer arrangement of example 68, wherein the loudspeaker (36) comprises a sound generating element (70) with an effective radiating area Sd, and wherein a minimum total cross-section area of the free intermediate space within a region of the baffle (42) at an equal distance from a center of the loudspeaker (36) is at least 1%, at least 2.5% or at least 5% of the effective radiating area Sd of the sound generating element.

Example 79: The transducer arrangement of example 68, wherein a minimum total cross-section area of the free intermediate space within a region of the baffle (42) at an equal distance from a center of the loudspeaker (36) is at least 10 mm 2, at least 15 mm2 or at least 25 mm2.

Example 80: The transducer arrangement of example 68, wherein a total cross-section area of the free intermediate space within a region of the baffle (42) at an equal distance from a center of the loudspeaker (36) increases essentially linearly or essentially continuously with increasing distance from the center of the loudspeaker (36).

Example 81: The transducer arrangement of example 68, wherein the baffle (42) comprises at least one flexible material.

Example 82: The transducer arrangement of example 68, wherein the baffle (42) comprises a flexible material supporting at least partial alignment of the baffle (42) with a curved surface of a helmet.

Example 82: The transducer arrangement of example 68, wherein the baffle (42) comprises a material with a density between 0.8 g/cm3 and 2.3 g/cm3.

Example 83: The transducer arrangement of example 68, wherein the baffle (42) comprises a material with a density of more than 0.8 g/cm3.

Example 84: The transducer arrangement of example 68, wherein a maximum thickness of the baffle (42) outside the loudspeaker receiving region (60) is less than 5 mm, less than 3 mm or less than 2 mm.

Example 85: The transducer arrangement of example 68, wherein a minimum thickness of the baffle (42) outside of the loudspeaker receiving region (60) is less than 1.5 mm or less than 1 mm.

Example 86: The transducer arrangement of example 68, wherein the baffle (42) further comprises a clip opening (80) for feeding through an attachment component between two layers of a helmet that abut the baffle (42) from two respective sides.

Example 87: The transducer arrangement of example 68, further comprising a chinstrap cut-out (82) in form of a recess in the perimeter of the baffle (42) or in form of an opening outside the loudspeaker receiving region (60) between an interior facing side (44) and an exterior facing side (50) of the baffle (42) for receiving at least a portion of a strap of the helmet.

Example 88: The transducer arrangement of example 68, wherein the baffle (42) comprises helmet attachment means for attaching the baffle (42) to at least one layer of a helmet. The helmet attachment means comprising an adhesive film on a surface of at least one side of the baffle (42) and/or an adhesive film on a surface of at least one separator (54) extending from the baffle (42) and/or a hook-or loop-side of a hook-and-loop fastener on a surface of at least one side of the baffle (42) and/or a hook-or loop-side of a hook-and-loop fastener on a surface of at least one separator (54) extending from the baffle (42) and/or a clip-fastener permanently or detachably coupled with the baffle (42).

Example 89: The transducer arrangement of example 68, wherein the plurality of surface sections on the exterior facing side (50) of the baffle (42) comprises hooks or loops of a hook-and-loop fastener.

Example 90: The transducer arrangement of example 68, wherein the plurality of surface sections on the exterior facing side (50) of the baffle (42) comprises a woven or non-woven fabric, the fabric comprising synthetic fibers formed in hook-shape or loop-shape.

Example 91: The transducer arrangement of example 68, wherein the plurality of surface sections on the exterior facing side of the baffle (42) comprises a multitude of pin-shaped elements extending from the baffle (42) with approximately mushroom-shaped end sections.

Example 92: The transducer arrangement of example 68, wherein the free intermediate space of the baffle (42) comprises an acoustically resistive or sound absorbing material.

Example 93: The transducer arrangement of example 68, wherein the plurality of surface sections on the exterior facing side (50) of the baffle (42) forms at least one sound guide (24) in the surface of the exterior facing side (50) of the baffle (42), the at least one sound guide (24) located between the loudspeaker receiving region (60) and the perimeter of the baffle (42).

Example 94: The transducer arrangement of example 68, wherein the plurality of surface sections on the exterior facing side (50) of the baffle (42) forms separators (54) to provide a multitude of at least partially separate sound guides (24) in the surface of the exterior facing side (50) of the baffle (42).

Example 95: The transducer arrangement of example 94, wherein the separators (54) are shaped and arranged such that at least one sound guide (24) extends substantially linearly.

Example 96: The transducer arrangement of example 94, wherein the separators (54) are shaped and arranged such that at least one sound guide (24) extends substantially nonlinear.

Example 97: The transducer arrangement of example 94, wherein the separators (54) are shaped and arranged such that multiple sound guides (24) in the surface of the exterior facing side (50) of the baffle (42) form intermittent patterns.

Example 98: The transducer arrangement of example 94, wherein the separators (54) are shaped and arranged such that multiple sound guides (24) in the surface of the exterior facing side (50) of the baffle (42) form irregular patterns.

Example 99: The transducer arrangement of example 94, wherein the separators (54) are shaped and arranged such that multiple sound guides (24) in the surface of the exterior facing side (50) of the baffle (42) comprise varying width.

Example 100: The transducer arrangement of example 94, wherein the separators (54) are shaped and arranged such that multiple sound guides (24) in the surface of the exterior facing side (50) of the baffle (42) comprise varying length.

Example 101: The transducer arrangement of example 94, wherein sound guides (24) are arranged and constructed to form tubular structures with an abutting element when an approximately even surface of the abutting element abuts the exterior facing side (50) of the baffle (42).

Example 102: The transducer arrangement of example 94, wherein sound guides (24) are arranged and constructed to form tubular structures with an abutting element when a curved surface of the abutting element abuts the exterior facing side (50) of the baffle (42).

Example 103: The transducer arrangement of example 94, wherein at least part of the sound guides (24) are arranged to extend approximately radially with respect to a central point within the loudspeaker receiving region (60).

Example 104: The transducer arrangement of example 94, wherein at least part of the sound guides (24) are intermitted by interconnections to neighboring sound guides (24).

Example 105: The transducer arrangement of example 94, wherein at least part of the sound guides (24) are intermitted by interconnections to neighboring sound guides (24) at different positions with respect to a length of neighboring sound guides (24).

Example 106: The transducer arrangement of example 94, wherein the sound guides (24) are distributed around the loudspeaker receiving region (60) over an angular range of more than 90°, more than 180° or more than 270°.

Example 107: The transducer arrangement of example 94, wherein at least part of the sound guides (24) comprises stepwise variation in cross-section area.

Example 108: The transducer arrangement of example 94, wherein the plurality of surface sections on the exterior facing side (50) of the baffle (42) comprises a multitude of sharp edges that cause diffuse reflections and diffractions of high frequency sound components within the multitude of sound guides (24).

Example 109: The transducer arrangement of example 94, wherein a cross-section area of at least one sound guide (24) increases essentially continuously or essentially linearly with increasing distance from the loudspeaker receiving region (60).

Example 110: The transducer arrangement of example 94, wherein at least one sound guide (24) further comprises a sound outlet (74) towards the interior facing side (44) of the baffle (42).

Example 111: The transducer arrangement of example 68, wherein the plurality of surface sections on the exterior facing side (50) of the baffle (42) comprises multiple separators (54) with a cross-section area of a round shape and/or an elongated shape and/or an elliptic shape and/or a rectangular shape and/or a trapezoid shape.

Example 112: The transducer arrangement of example, wherein the exterior facing side (50) of the baffle (42) is further arranged and constructed to abut a protective layer, a functional layer or a cushioning layer of the helmet.

Example 113: The transducer arrangement of example 68, wherein a sound pressure level of a 100 Hz sine wave signal radiated by the loudspeaker (36) to a position in front of the loudspeaker (36) is at least 3 dB, at least 5 dB or at least 10 dB higher when the loudspeaker (36) is placed in the loudspeaker receiving region (60) of the baffle (42) than for the loudspeaker (36) without the baffle (42).

Example 114: The transducer arrangement of example 68, wherein at least one of a resonance frequency and a resonance quality factor of the loudspeaker (36) is lower when the loudspeaker (36) is mounted within a helmet with the baffle (42) than without the baffle (42).

Example 115: The transducer arrangement of example 68, wherein the interior facing side (44) of the baffle (42) further comprises a fabric layer and/or a cushion layer.

Example 116: The transducer arrangement of example 68, wherein the baffle (42) further comprises an acoustically largely transparent cover on at least one opening 48 in the loudspeaker receiving region (60).

Example 117: The transducer arrangement of example 68, further comprising a machine readable visual or geometric feature on a surface of the baffle (42) or the loudspeaker (36) that comprises encoded information with regard to the baffle (42).

Example 118: The transducer arrangement of example 68, further comprising cutting marks that support manual customization of the perimeter shape of the baffle (42) or adaption or addition of an opening in the baffle (42).

Example 119: The transducer arrangement of example 68, further comprising an alignment feature that limits the orientation of the loudspeaker (36) within the loudspeaker receiving region (60) of the baffle (42). The alignment feature comprises a cable guide for receiving a cable connected to the loudspeaker (36) and/or a protruding element for insertion to a recess or cavity of the loudspeaker (36) and/or a recess or cavity for receiving a protruding element of the loudspeaker (36) and/or an opening for alignment with a corresponding opening in the loudspeaker (36).

Example 120: The transducer arrangement of example 68, further comprising a sensor (86) on at least one of the baffle (42) and the loudspeaker (36). The sensor (86) providing information about an assembly status of the baffle (42) on the loudspeaker (36).

Example 121: A helmet comprising a transducer arrangement according to one of examples 68-120.

Example 122: The helmet of example 121, wherein the baffle (42) is positioned in the helmet such that it abuts an inner layer of the helmet with at least parts of the exterior facing side (50) of the baffle (42).

Example 123: The helmet of example, wherein the loudspeaker (36) is at least partly positioned within a recess in an inner layer of the helmet.

Example 124: The helmet of example 121, wherein the baffle (42) is mechanically attached to at least one inner layer of the helmet.

Example 125: The helmet of example 121, wherein the baffle is mechanically attached to the loudspeaker (36) and to an inner layer of the helmet.

Example 126: The helmet of example 121, wherein the loudspeaker (36) is mechanically attached to an inner layer of the helmet.

Example 127: The transducer arrangement of example 68, further comprising a microphone (84) on an interior facing side of the loudspeaker (36).

Example 128: The transducer arrangement of example 68, further comprising a microphone (84) on an interior facing side (44) of the baffle (42).

Example 129: The transducer arrangement of examples 127 or 128, wherein the microphone (84) is attached to the baffle (42) and/or a part of the loudspeaker (36).

Example 130: The transducer arrangement of any of examples 127 to 129, wherein the microphone (84) comprises an acoustic input that faces the loudspeaker (36).

Example 131: A method to operate the transducer arrangement of any of examples 127 to 131, the method comprising: receiving a microphone signal from the microphone (84), processing the microphone signal and playing the processed microphone signal on the loudspeaker (36). Wherein the microphone (84) receives sound radiated by the loudspeaker (36).

Example 132: According to a hundred and thirty-second example, a helmet with a transducer arrangement comprises a loudspeaker (36) configured to emit frontal sound from a frontal side and rear sound from a rear side and at least one sound guide (24), arranged and constructed to guide the rear sound away from the loudspeaker (36) and into an interior space (15) of the helmet.

Example 133: The helmet of example 132, wherein the rear sound of the loudspeaker (36) is substantially out of phase with respect to the frontal sound.

Example 134: The helmet of example 132, wherein the frontal sound is emitted into the interior space (15) of the helmet adjacent to an ear of a wearer.

Example 135: The helmet of example 132, wherein the loudspeaker (36) is located adjacent to a typical ear position of a wearer of the helmet.

Example 136: The helmet of example 132, wherein the frontal sound is directly emitted into the interior space (15) of the helmet.

Example 137: The helmet of example 132, wherein the rear sound is emitted into the interior space (15) with a distance of at least 5 mm, at least 10 mm or at least 15 mm to the loudspeaker (36).

Example 138: The helmet of example 132, wherein the interior space (15) is located on an interior facing side of the transducer arrangement.

Example 139: The helmet of example 132, further comprising an outer shell and at least one protective layer (2) within the outer shell, wherein the interior space (15) of the helmet is located on an interior facing side of the protective layer (2).

Example 140: The helmet of example 139, wherein the protective layer (2) comprises a rigid foam material.

Example 141: The helmet of example 132, wherein the interior space (15) comprises a cushion layer (16) of the helmet.

Example 142: The helmet of example 132, wherein the at least one sound guide (24) comprises at least two layers of the helmet (2, 4, 28) arranged and constructed to provide free intermediate space forming the sound guide (24).

Example 143: The helmet of example 132, wherein the at least one sound guide (24) comprises a multitude of sound canals.

Example 144: The helmet of example 132, wherein the at least one sound guide (24) comprises a multitude of separators (54) providing free intermediate space between two layers (2, 4, 28) of the helmet.

Example 145: The helmet of example 132, wherein the at least one sound guide (24) comprises a functional layer (28) of the helmet configured to provide an acoustic barrier between the frontal side and the rear side of the loudspeaker (36).

Example 146: The helmet of example 132, wherein the at least one sound guide (24) comprises a functional layer (28) of the helmet configured to provide an acoustic barrier between the frontal side and the rear side of the loudspeaker (36) such that frontal sound reaches the ear of a wearer earlier than rear sound emitted by the loudspeaker (36) at the same time.

Example 147: The helmet of example 132, wherein the at least one sound guide (24) comprises a functional layer (28) of the helmet configured to provide an acoustic barrier between the frontal side and the rear side of the loudspeaker (36) and a protective layer (2, 4) of the helmet.

Example 148: The helmet of example 132, wherein the at least one sound guide (24) comprises a functional layer (28) of the helmet configured to provide an acoustic barrier between the frontal side and the rear side of the loudspeaker (36) and a protective layer (2, 4) of the helmet comprising a multitude of sound canals (24).

Example 149: The helmet of example 132, wherein the at least one sound guide (24) comprises a functional layer (28) of the helmet configured to provide an acoustic barrier between the frontal side and the rear side of the loudspeaker (36) and a protective layer (2, 4) of the helmet comprising a multitude of separators (54).

Example 150: The helmet of example 132, wherein the at least one sound guide (24) comprises a functional layer (28) of the helmet configured to provide an acoustic barrier between the frontal side and the rear side of the loudspeaker (36) and further comprises a protective layer (2, 4) of the helmet. The functional layer (28) covers a recessed area within the protective layer (2, 4), the recessed area providing free space for the at least one sound guide (24).

Example 151: The helmet of example 132, wherein the at least one sound guide (24) comprises a functional layer (28) of the helmet configured to provide an acoustic barrier between the frontal side and the rear side of the loudspeaker (36) and further comprises a protective layer (2, 4) of the helmet. The functional layer (28) abuts a multitude of separators (54) raised from the protective layer (2, 4), free space between the separators (54) forming the at least one sound guide (24).

Example 152: The helmet of example 132, wherein the at least one sound guide (24) comprises a functional layer (28) of the helmet configured to provide an acoustic barrier between the frontal side and the rear side of the loudspeaker (36) and further comprises at least one opening (74) within the functional layer (28) that releases rear sound towards the interior space (15) of the helmet.

Example 153: The helmet of example 132, wherein the at least one sound guide (24) comprises a functional layer (28) of the helmet configured to provide an acoustic barrier between the frontal side and the rear side of the loudspeaker (36) and further comprises at least one opening (74) within the functional layer (28) that releases rear sound towards the interior space (15) of the helmet. The at least one opening (74) within the functional layer (28) is located in a distance of at least 10 mm, at least 15 mm or at least 20 mm from the loudspeaker (36).

Example 154: The helmet of example 132, wherein the at least one sound guide (24) comprises a functional layer (28) of the helmet configured to provide an acoustic barrier between the frontal side and the rear side of the loudspeaker (36). The largest dimension of the at least one sound guide (24) extends approximately in parallel to the functional layer (28).

Example 155: The helmet of example 132, wherein the at least one sound guide (24) comprises a functional layer (28) of the helmet configured to provide an acoustic barrier between the frontal side and the rear side of the loudspeaker (36) and an interior facing side of the functional layer (28, 16) is at least partly covered by a cushion layer (16).

Example 156: The helmet of example 132, wherein the at least one sound guide (24) comprises a functional layer (28) of the helmet configured to provide an acoustic barrier between the frontal side and the rear side of the loudspeaker (36) and an interior facing side of the functional layer (28, 16) is partly covered by a cushion layer (16) arranged to form a frontal chamber with the functional layer (28, 16), the frontal chamber arranged and constructed to receive an ear of a wearer.

Example 157: The helmet of example 132, further comprising a cushion layer (16) arranged to encircle a typical ear position of a wearer.

Example 158: The helmet of example 132, further comprising a cushion layer (16) arranged to encircle a typical ear position of a wearer, thereby creating a frontal chamber for an ear of a wearer, wherein the at least one sound guide (24) is arranged and constructed to release rear sound outside the frontal chamber.

Example 159: The helmet of example 132 further comprising a cushion layer (16) leaving free space at a typical ear position of a wearer, thereby creating a frontal chamber for an ear of a wearer and the at least one sound guide (24) is arranged and constructed to release rear sound outside the frontal chamber.

Example 160: The helmet of example 132 further comprising a cushion layer (16) arranged to encircle a typical ear position of a wearer, thereby creating a frontal chamber for an ear of a wearer and at least one front ventilation canal providing fluid ventilation between the frontal chamber and the interior space (15) of the helmet outside the frontal chamber.

Example 161: The helmet of example 132, wherein the cushion layer (16) comprises a soft and elastic material.

Example 162: The helmet of example 132, wherein the cushion layer (16) comprises a soft and elastic material covered with a fabric and/or an acoustically permeable material and/or a fabric covered with an air-tight layer and/or a fabric coated with an air-tight layer and/or an air-tight layer.

Example 163: The helmet of example 132, wherein the at least one sound guide (24) is at least partly filled with an acoustically resistive material.

Example 164: The helmet of example 132, wherein the loudspeaker (36) comprises a sound generating element (70) with an effective radiating area Sd and wherein a minimum total cross-section area of the at least one sound guide (24) at an equal distance from a center of the loudspeaker (36) is at least 1%, at least 2.5% or at least 5% of the effective radiating area Sd of the loudspeaker (36).

Example 165: The helmet of example 132, further comprising a microphone (84) arranged in front of the loudspeaker (36), the microphone (84) receiving frontal sound and rear sound from the loudspeaker (36).

Example 166: The helmet of example 165, wherein a sound pressure level of frontal sound of the loudspeaker (36) as received by the microphone (84) is substantially lower than a sound pressure level of rear sound of the loudspeaker (36) received by the microphone (84).

Example 167: A method to operate the transducer arrangement of the examples 165 or 166 comprises receiving a microphone signal from the microphone (84), processing the microphone signal and playing the processed microphone signal on the loudspeaker (36).

Example 168. According to a hundred and sixty-eighth example, a method for providing sound within a helmet comprises driving a loudspeaker (36) with a loudspeaker driving signal and releasing frontal sound on a frontal side of the loudspeaker (36) and rear sound in a distance to the loudspeaker (36) with inverse relative acoustic polarity at least within a first frequency range. Frontal sound is radiated directly towards an interior space (15) of the helmet and rear sound is guided through a rear sound propagation path behind a baffle (42, 28) surrounding the loudspeaker (36) before it is released towards the interior space (15).

Example 169: The method of example 168, wherein a sound pressure level of the rear sound at the frontal side of the loudspeaker (36) is substantially reduced by the rear sound propagation path induced on rear sound by the baffle (42, 28).

Example 170: The method of example 168, wherein rear sound arriving time at the frontal side of the loudspeaker (36) is substantially delayed by the baffle (42, 28).

Example 171: The method of example 168, further comprising: sensing superimposed frontal sound and rear sound of the loudspeaker (36) with a microphone (84) on the frontal side of the loudspeaker (36) to receive a microphone signal, processing the microphone signal to receive a processed microphone signal and adding the processed microphone signal to the loudspeaker driving signal.

Example 172: The method of example 171, wherein processing of the microphone signal comprises application of a filter transfer function.

Example 173: The method of example 168, wherein the loudspeaker driving signal comprises a processed version of an audio playback signal and processing of the audio playback signal is adapted based on information regarding the baffle (42, 28).

Example 174: The method of example 168, wherein information regarding the baffle (42, 28) is received from a sensor (86) on the loudspeaker (36) and/or a sensor (86) on the baffle (42, 28) and/or an interface on the loudspeaker (36) and/or a machine-readable code on the loudspeaker (36) and/or a machine-readable code on the baffle (42, 28) and/or user input to a device controlling the processing applied to the audio playback signal.

Example 175: According to a hundred and seventy-fifth example, a transducer arrangement for helmets comprises a loudspeaker (36), configured to emit frontal sound from a first side and rear sound with inverse acoustic polarity from a second side. The transducer arrangement further comprises a baffle (42) extending from the loudspeaker (36). The loudspeaker (36) is arranged with and/or within the baffle (42), such that the baffle (42) provides an acoustic barrier between the first and second side of the loudspeaker (36).

Example 176: The transducer arrangement of example 175, further comprising at least one separator (54) arranged to provide at least one sound propagation path (24) between surface sections of the baffle (42) and an inner layer of a helmet.

Example 177: The transducer arrangement of example 176, further comprising at least one sound outlet (74) from at least one of the at least one sound propagations path (24) towards an interior space (15) of the helmet.

Example 178: The transducer arrangement of example 177, wherein the sound outlet (74) comprises at least one of a through-hole between two sides of the baffle (42) and/or free space between surface sections of the at least one separator (54).

Example 179: The transducer arrangement of example 175, wherein the baffle (42) comprises an opening (48) and the loudspeaker (36) is arranged within the opening (48) of the baffle (42).

Example 180: According to a hundred and eightieth example, a transducer arrangement for helmets comprises a loudspeaker (36), configured to emit frontal sound and rear sound with inverse relative acoustic polarity. The transducer arrangement further comprises a baffle (42) extending from the loudspeaker (36). The loudspeaker (36) is arranged with the baffle (42), such that the baffle (42) provides a local barrier between frontal sound and rear sound of the loudspeaker (36).

Example 181: According to a hundred and eighty first example, a transducer arrangement for helmets comprises a loudspeaker (36) and a baffle (42). The baffle (42) is arranged with the loudspeaker (36) such that the loudspeaker (36) is configured to emit sound into an interior space (15) of a helmet on at least one first position (48) and approximately inverse sound at multiple second positions (74), wherein the second positions (74) are in greater distance to the loudspeaker (36) than the at least one first position (48).

Example 182: A helmet comprising the transducer arrangement of example 180, wherein the at least one first position (48) is arranged to be adjacent to an ear of a wearer and the second positions (74) are arranged to be more remote from the ear.

Example 182: According to a hundred and eighty-third example, an audio system for helmets comprises a loudspeaker (36) with a detachable electronic connection to at least a first part of the audio system and a controller (88) comprised in the first part of the audio system. The controller (88) is configured to retrieve information about at least the loudspeaker (36) and adjust a signal processing path upstream to the loudspeaker (36) based on the information about the loudspeaker (36).

Example 184: The audio system of example 183, wherein the loudspeaker (36) comprises information storage means comprising a memory device and/or an electronic component and/or a machine-readable code and wherein the controller (88) is configured to retrieve information about the loudspeaker (36) from the information storage means of the loudspeaker (36).

Example 185: The audio system of example 183, further comprising a sensor (86, 84) and wherein the controller (88) is configured to retrieve information about the loudspeaker (36) from the sensor (86, 84).

Example 186: The audio system of example 185, wherein the sensor (86, 84) is arranged on the loudspeaker (36).

Example 187: The audio system of example 185, wherein the sensor is a microphone (84) arranged on a frontal side of the loudspeaker (36).

Example 188: The audio system of example 185, wherein the sensor (86, 84) provides at least one parameter related to an assembly status of an acoustically effective component (42) on the loudspeaker (36).

Example 189: The audio system of example 184, further comprising a baffle (42) attached to the loudspeaker (36) and wherein the information storage means of the loudspeaker (36) comprise information about the loudspeaker (36) and about the baffle (42).

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A baffle for at least one loudspeaker within a helmet, the baffle comprising:
an outer edge defining a perimeter of the baffle;
a loudspeaker receiving region within the perimeter of the baffle, the loudspeaker receiving region comprising at least one opening between an interior facing side and an exterior facing side of the baffle; and
a plurality of surface sections on the exterior facing side of the baffle, arranged to provide free intermediate space; wherein
the free intermediate space forms at least one rear sound propagation path from at least one close position near to the loudspeaker receiving region to at least one remote position near to the perimeter of the baffle.

2. The baffle of claim 1, wherein a distance between at least one of the at least one close position and at least one of the at least one remote position is at least 5 mm, at least 10 mm or at least 15 mm in a direction essentially parallel to at least one of:
the interior facing side of the baffle; or
a main extension of the interior facing side of the baffle.

3. The baffle of claim 1, wherein the loudspeaker receiving region is bounded by an inner edge or inner rim of the baffle and comprises a circular cross-section area.

4. The baffle of claim 1, wherein the loudspeaker receiving region is further defined by at least one of:
an area on the exterior facing side of the baffle covered with an adhesive film, surrounding the at least one opening of the loudspeaker receiving region;
an inner edge or inner rim of the baffle, surrounding the at least one opening of the loudspeaker receiving region, arranged and constructed to encircle an at least partly circular part of a loudspeaker; or
an inner groove or inner notch of the baffle, surrounding the at least one opening of the loudspeaker receiving region, arranged and constructed to encircle an at least partly circular part of a loudspeaker.

5. The baffle of claim 1, wherein the loudspeaker receiving region comprises an inner edge or inner rim comprising a flexible material; and wherein
the inner edge or inner rim can be stretched such that it provides sealing against a body comprising a two-dimensional cross-sectional shape with a perimeter that falls into a range between 7.5 cm and 20 cm.

6. The baffle of claim 1, wherein an area of the loudspeaker receiving region is bounded by an inner edge or inner rim of the baffle; and
an area within the boundaries of the perimeter of the baffle is at least 25% larger, at least 50% larger or at least 100% larger than the area of the loudspeaker receiving region.

7. The baffle of claim 1, wherein an area of the loudspeaker receiving region is bounded by an inner edge or inner rim of the baffle; and wherein
a minimum total cross-section area of the free intermediate space within a region of the baffle at an equal distance from a center of the loudspeaker receiving region is at least one of:
at least 10 mm², at least 15 mm² or at least 25 mm²; or
at least 1%, at least 2.5% or at least 5% of the area of the loudspeaker receiving region.

8. The baffle of claim 1, wherein the plurality of surface sections on the exterior facing side of the baffle forms a multitude of separators, the multitude of separators configured to provide spacing between an abutting layer of the helmet and part of the exterior facing side of the baffle.

9. The baffle of claim 1, wherein the plurality of surface sections on the exterior facing side of the baffle forms at least one separator, the at least one separator provides at least one sound guide in the surface of the exterior facing side of the baffle.

10. The baffle of claim 1, wherein the plurality of surface sections on the exterior facing side of the baffle forms separators that provide a multitude of at least partially separate sound guides in the surface of the exterior facing side of the baffle.

11. The baffle of claim 1, wherein at least one of the at least one rear sound propagation path further comprises at least one sound outlet towards the interior facing side of the baffle.

12. The baffle of claim 1, wherein the plurality of surface sections on the exterior facing side of the baffle comprises multiple separators that cover between 30% and 60% or between 20% and 80% of the exterior facing side of the baffle.

13. The baffle of claim 1, wherein a sound pressure level of a 100 Hz sine wave signal radiated by a loudspeaker to a position in front of the loudspeaker is at least 3 dB, at least 5 dB or at least 10 dB higher when the loudspeaker is placed in the loudspeaker receiving region of the baffle than for the loudspeaker without the baffle.

14. The baffle of claim 1, further comprising a machine readable visual or geometric feature on a surface of the baffle that comprises encoded information with regard to at least one of:
the baffle;
a loudspeaker that fits into the loudspeaker receiving region of the baffle; or
a helmet that is suitable to receive the baffle.

15. The baffle of claim 1, further comprising a memory device that comprises encoded information with regard to at least one of:
the baffle;
a loudspeaker that fits into the loudspeaker receiving region of the baffle; or
a helmet that is suitable to receive the baffle.

16. A transducer arrangement for helmets, the transducer arrangement comprising:
a baffle with an outer edge defining a perimeter of the baffle;
a loudspeaker receiving region within the perimeter of the baffle, the loudspeaker receiving region comprising at least one opening between an interior facing side and an exterior facing side of the baffle;
a plurality of surface sections on the exterior facing side of the baffle arranged to provide free intermediate space; and
a loudspeaker provided within the loudspeaker receiving region of the baffle; wherein
the free intermediate space forms at least one rear sound propagation path from at least one close position near to the loudspeaker to at least one remote position near to the perimeter of the baffle.

17. The transducer arrangement of claim 16, wherein the loudspeaker is configured to emit frontal sound from a frontal side and rear sound from a second side; and
the baffle extends from the loudspeaker to provide a local barrier between frontal sound and rear sound.

18. The transducer arrangement of claim 17, wherein frontal sound is acoustically inverse to rear sound at least within a first frequency range.

19. The transducer arrangement of claim 16, wherein the baffle comprises loudspeaker attachment means for attaching the loudspeaker to the baffle, the loudspeaker attachment means comprising at least one of:
a clamp holding the loudspeaker;
a sleeve that encompasses at least a part of the loudspeaker;
an adhesive film covering at least one surface section of the baffle;
an edge or rim that encircles at least part of the loudspeaker;
an edge or rim that fits tightly around at least part of the loudspeaker and seals the baffle against the loudspeaker; or
an edge or rim constructed and arranged to support press-fit assembly of the loudspeaker in the baffle.

20. The transducer arrangement of claim 16, wherein the loudspeaker comprises a baffle attachment feature comprising a groove, a notch or a slot; and wherein
the loudspeaker receiving region of the baffle comprises a corresponding loudspeaker attachment feature comprising a tongue, a nose or a key.

21. The transducer arrangement of claim 16, wherein the loudspeaker comprises a baffle attachment feature comprising a tongue, a nose or a key; and wherein
the loudspeaker receiving region of the baffle comprises a corresponding loudspeaker attachment feature comprising a groove, a notch or a slot.

22. The transducer arrangement of claim 16, wherein the loudspeaker comprises a sound generating element with an effective radiating area Sd; and wherein
an area within the boundaries of the perimeter of the baffle is at least 25% larger, at least 50% larger or at least 100% larger than the effective radiating area Sd of the loudspeaker.

23. The transducer arrangement of claim 16, wherein the loudspeaker comprises a sound generating element with an effective radiating area Sd; and wherein
a minimum total cross-section area of the free intermediate space within a region of the baffle at an equal distance from a center of the loudspeaker is at least one of:
at least 10 mm², at least 15 mm² or at least 25 mm²; or
at least 1%, at least 2.5% or at least 5% of the effective radiating area Sd of the sound generating element.

24. The transducer arrangement of claim 16, wherein the plurality of surface sections on the exterior facing side of the baffle comprises a multitude of hook-shaped or loop-shaped elements.

25. The transducer arrangement of claim 16, wherein the plurality of surface sections on the exterior facing side of the baffle forms at least one sound guide in the surface of the exterior facing side of the baffle, the at least one sound guide located between the loudspeaker and the perimeter of the baffle.

26. The transducer arrangement of claim 21, wherein the plurality of surface sections on the exterior facing side of the baffle forms separators to provide a multitude of at least partially separate sound guides in the surface of the exterior facing side of the baffle.

27. The transducer arrangement of claim 16, wherein at least one of a resonance frequency and a resonance quality factor of the loudspeaker is lower when the loudspeaker is mounted within a helmet with the baffle than without the baffle.

28. The transducer arrangement of claim 16, further comprising a microphone arranged on an interior facing side of the loudspeaker and attached to at least one of the baffle or the loudspeaker.

29. The transducer arrangement of claim 16, further comprising a sensor on at least one of the baffle and the loudspeaker, the sensor providing information related to an assembly status of the baffle on the loudspeaker.

30. The transducer arrangement of claim 16, further comprising information storage means, the information storage means comprising at least one of:
a memory device;
an electronic component; or
a machine-readable code; wherein
at least one parameter that may be retrieved from the information storage means relates to information about the loudspeaker, information about the baffle, information about a helmet or information about any combination thereof.
